(19) United States
(12) Patent Application Publication
(10) Pub. No.: US 2024/0120506 A1
(43) Pub. Date: Apr. 11, 2024

(54) FLASH RECYCLING OF BATTERIES

(71) Applicant: William Marsh Rice University, Houston, TX (US)

(72) Inventors: James Mitchell TOUR, Houston, TX (US); Weiyin CHEN, Houston, TX (US); Duy X. LUONG, Houston, TX (US); Carter KITTRELL, Houston, TX (US)

(73) Assignee: WILLIAM MARSH RICE UNIVERSITY, Houston, TX (US)

(21) Appl. No.: 18/264,646

(22) PCT Filed: Feb. 8, 2022
(86) PCT No.: PCT/US22/15616

§ 371 Date: Aug. 8, 2023

Related U.S. Application Data
(60) Provisional application No. 63/285,952, filed on Dec. 3, 2021.
(60) Provisional application No. 63/147,069, filed on Feb. 8, 2021.

(51) Int. Cl. H01M 6/52; C25C 1/08

(52) U.S. Cl. CPC H01M 6/52; C25C 1/08

(57) ABSTRACT

Method and system for flash recycling of batteries, including lithium-ion batteries, other metal (sodium, potassium, zinc, magnesium, and aluminum)-ion batteries, metal batteries, batteries having all metal oxide cathodes, and batteries having graphite-containing anodes. The method and system include a solvent-free and water-free flash Joule heating (FJH) method performed upon a mixture that includes materials from the batteries done in millisecond for recycling the materials. In some embodiments, the FJH method is combined with magnetic separation to recover lithium, cobalt, nickel, and manganese with high yields up to 98%. In some embodiments, the FJH method is followed by rinsing with dilute acid, such a 0.01 M HCl. In other embodiments, the FJH method is utilized to purify the graphite in the battery, such as for use in the anode of the battery.

### CROSS-REFERENCE TO RELATED PATENT APPLICATIONS

This application claims priority to (a) U.S. Patent Appl. Ser. No. 63/147,069, filed Feb. 8, 2021, entitled “Recycling Of Spent Batteries By Flash Joule Heating,” to James M. Tour, et al., and (b) U.S. Patent Appl. Ser. No. 63/285,952, filed Dec. 3, 2021, entitled “Flash Recycling Of Batteries,” to James M. Tour, et al. Each of these patent applications is commonly owned by the owner of the present invention. These patent applications are incorporated herein in their entirety.

### STATEMENT REGARDING FEDERALLY SPONSORED RESEARCH

This invention was made with government support under Grant No. FA9550-19-1-0296 awarded by the United States Air Force Office of Scientific Research, and Grant No. DE-FE0031794 awarded by the United States Department of Energy, National Energy Technology Laboratory. The government has certain rights in the invention.

### TECHNICAL FIELD

The present invention relates to the flash recycling of batteries, including lithium-ion batteries, other metal (sodium, potassium, zinc, magnesium, and aluminum)-ion batteries, metal batteries (such as solid lithium batteries), batteries having all metal oxide cathodes, and batteries having all graphite-containing anodes. The flash recycling features solvent-free and water-free flash Joule heating (FJH) methods, sometimes performed in combination with magnetic separation to recover lithium, cobalt, nickel, manganese, etc., such as in the cathode, and FJH methods for purifying graphite in the batteries, such as the graphite in the anode.

### BACKGROUND

The continuous accumulation of spent Li-ion batteries (LIBs) and the growing scarcity of their valuable metal sources have resulted in an urgent call for an effective recycling strategy. [Tran 2019; Lv 2018; Xu 2020]. The current recycling methods can achieve high recovery yields for the valuable metals, but they require high-temperature furnaces or harsh wet extraction methods, and they destroy the entire 3-dimensional (3D) morphology of the cathode, rendering them economically and environmentally unattractive. [Lv 2018; Natarajan 2018]. Hence, less than 5% of LIBs are recycled which results in a constant need to mine metals from their ores. [Recycle 2019; Velázquez 2019; Li 2017].

The ever-increasing demand for portable electronic devices and electric vehicles has accelerated the production of commercial secondary batteries, especially LIBs. [Recycle 2019; Andre 2015]. The market for rechargeable LIBs reached —$50 billion in 2020 and it is projected to be —$70 billion in 2022. [Zou 2013]. Since the expected life of most LIBs is less than 10 years, and often only 2 years [Salvatierra 2021; Chen 2020], the foreseeable staggering accumulation of spent LIBs is disconcerting. [Recycle 2019; Velázquez 2019; Li 2017]. Furthermore, at the projected pace of Li and Co mining, the world's reserves of these elements are predicted to deplete by 2050 and 2030, respectively. [Natarajan 2018; Jacoby 2020]. The spent cathode consists of Li and transition metals, accounting for ˜35% of the total weight and ˜45% of the cost of LIBs. [Salvatierra 2021]. An effective recycling of the spent cathodes will lessen the need for remote mining of these metals, diminish the environmental consequences of LIB disposal, and provide an economic incentive to recycle. [He 2016]. The anode, although graphite and less expensive than the cathode, uses a form of graphite that is battery-grade, and thus costs $10,000 per ton for the natural sources of battery-grade graphite and as much as $20,000 per ton for the preferred synthetic battery-grade graphite. Additionally, the spent anode has several percent by weight lithium and the leached cathodic metals remaining in it, which is higher in metal content than even the mined ores. Hence, from an environmental standpoint it cannot be merely landfilled, and from an economic standpoint it is attractive to recycle that component as well.

### SUMMARY OF THE INVENTION

The present invention relates to a method and system for a solvent-free and water-free flash Joule heating (FJH) method performed upon a mixture that includes materials from lithium-ion batteries, other metal-ion batteries, metal batteries, batteries having all metal oxide cathodes, and batteries having all graphite-containing anodes done in milliseconds. In some embodiments, the FJH method is combined with magnetic separation to recover lithium, cobalt, nickel, manganese, etc., with high yields up to 98%. The process is called “flash recycling.” LIBs possessing different chemistries, namely lithium cobalt oxide (LCO), lithium nickel-manganese-cobalt oxide (NMC) and spent LIBs with both LCO and NMC mixed together, can be effectively flash recycled. Characterization of the flash recycling products reveal intact 3D layered core structures with hierarchical features, so their reconstitution into new cathodes is greatly simplified. It has further been shown that the flash process produces a lithium-ion permeable conductive carbon coating on the flash cathode material, thereby affording it with improved electrochemical stability. Life-cycle analysis against current recycling processes highlight that flash recycling can significantly reduce the total energy and greenhouse gas (GHG) emissions while turning it into an economically advantageous process.

In other embodiments, the FJH methods is used for purifying graphite in the metal-ion batteries, such as the graphite in the anode.

In general, in one embodiment, the invention features a method of recovering metal. The method includes forming a mixture including a cathode material. The cathode material is prepared from one or more batteries. The method further includes applying a voltage across the mixture to obtain metals and cathode waste from the cathode material. The voltage is applied in one or more voltage pulses. Duration of each of the one or more voltage pulses is for a duration period. The method further includes magnetically separating the metal and the cathode waste.

Implementations of the invention can include one or more of the following features:

The metal can include cathode metal selected from the group consisting of lithium, cobalt, nickel, manganese, iron, and combinations thereof.

The metal can include cathode metal selected from the group consisting of be metal oxides, metal salts, metal carbonates, metal phosphates, and combinations thereof.

The cathode metal can include metal oxide.

The metal oxide can include cobalt oxide.

The cathode metal can include metal carbonate.

The metal carbonate can include lithium carbonate.

The cathode metal can include metal phosphate.

The metal phosphate can include iron phosphate.

The one or more batteries can include batteries selected from the group consisting of lithium-ion batteries, sodium-ion batteries, potassium-ion batteries, zinc-ion batteries, magnesium-ion batteries, aluminum-ion batteries, metal-ion batteries, metal batteries, anode-free batteries, metal oxygen batteries, metal air batteries, and combinations thereof.

The one or more batteries can include one or more lithium-ion batteries.

The one or more lithium-ion batteries can include lithium-ion batteries each having a lithium cobalt oxide (LCO) cathode or a lithium nickel-manganese-cobalt oxide (NMC) cathode.

Each of the one or more lithium-ion batteries can each include an LCO cathode.

Each the one or more lithium-ion batteries can each include an NMC cathode.

The metal obtained by applying the voltage can include a cathode metal including metal phosphate.

The metal phosphate can include iron phosphate.

Each of some of the one or more lithium-ion batteries can include an LCO cathode and each of some of the one or more lithium-ion batteries can include an NMC cathode.

The one or more lithium-ion batteries can include lithium-ion batteries having a cathode including a mixture of lithium cobalt oxide (LCO) and lithium nickel-manganese-cobalt oxide (NMC).

The mixture can further include a conductive additive.

The conductive additive can be a carbon source.

The conductive additive can be selected from the group consisting of graphite, anodic graphite, battery-grade graphite, elemental carbon, carbon black, graphene, flash graphene, turbostratic graphene, coal, anthracite, coke, metallurgical coke, calcined coke, activated charcoal, biochar, natural gas carbon that had been stripped of its hydrogen atoms, activated charcoal, shungite, plastic waste, plastic waste-derived carbon char, food waste, food waste-derived carbon char, biomass, biomass-derived carbon char, hydrocarbon gas-derived carbon char, and mixtures therefrom.

The conductive additive can be carbon black.

The conductive additive can be predominately elemental carbon.

The conductive additive can be selected from the group consisting of metals, metal salts, metal oxides, metalloids, metal complexes, conductive phosphorus, and non-metal conductive materials.

The conductive additive can be selected from the group consisting of metals, metal salts, metal oxides, metalloids, and metal complexes.

The conductive additive can be a metalloid.

The metalloid can be selected from the group consisting of B, Si, As, Te, and At.

The conductive additive can be prepared from the anode material of the one or more batteries.

The conductive additive can be not prepared from the one or more batteries.

The cathode material and the conductive additive can be mixed at a weight ratio in a range of 1:2 and 25:1.

The voltage applied can be in a range of 15 V and 300 V.

The mass of the mixture to which the voltage is applied can be more than 1 kg. The voltage applied can be between 100 V and 100,000 V.

The mass of the mixture to which the voltage is applied can be more than 100 kg.

The mass of the mixture to which the voltage is applied can be more than 1 kg. The current applied can be between 1,000 amps and 30,000 amps.

The mass of the mixture to which the voltage is applied can be more than 100 kg.

The mixture can have a resistance in the range of 0.1 ohms and 25 ohms when the voltage is applied.

The duration period for the duration of each of the one or more voltage pulses can be between 1 microsecond and 25 seconds.

The duration period for the duration of each of the one or more voltage pulses can be between 1 microsecond and 10 seconds.

The duration period for the duration of each of the one or more voltage pulses can be between 1 microsecond and 1 second.

The duration of each of the one or voltage pulses can be between 100 microseconds and 500 microseconds.

The one or more voltage pulses can be between 2 voltage pulses and 100 voltage pulses.

The voltage pulse can be performed using direct current (DC).

The method can be performed utilizing a pulsed direct current (PDC) Joule heating process.

The voltage pulse can be performed using alternating current (AC).

The voltage pulse can be performed by using both direct current (DC) and alternating current.

The method can switch back and forth between the use of direct current (DC) and alternating current (AC).

The method can concurrently use direct current (DC) and alternating current (AC).

The one or more voltage pulses can increase the temperature of the mixture to at least 3000 K.

The metals obtained by applying a voltage across the mixture can include metal particles that have a carbon coating.

The carbon coating can be conductive.

The carbon coating can be ion permeable.

The carbon coating can be conductive and ion permeable.

The carbon coating can be ion permeable for a metal ion.

The metal ion can be selected from the group consisting of lithium-ions, sodium-ions, potassium-ions, magnesium-ions, zinc-ions, and aluminum-ions.

The carbon coating can be amorphous.

The carbon coating can include graphene.

The method can preserve the 3D layer structure of the cathodes in the cathode material.

The method can preserve the 3D morphology of the cathodes in the cathode material.

The method can destroy the 3D morphology of the cathodes in the cathode material.

The method can further include a cooling step. The cooling step can cool the metals and the cathode waste before the step of magnetically separating the metals and the cathode waste.

The metals and cathode waste can be at a weight ratio between 20:1 and 5:1.

The metals and cathode waste can be at a weight ratio between 10:1 and 8:1.

The method can further include, after the step of mechanical separating, applying a second voltage across the cathode waste. The second voltage can be applied in one or more second voltage pulses. Duration of each of the one or more second voltage pulses can be for a second duration period.

The second voltage can be the same as the voltage applied across the cathode material. The second duration period can be the same as the duration period for the voltage applied across the cathode material.

The applying of the second voltage across the cathode waste can obtain further metals and a reduced portion of the cathode waste. The method can further include magnetically separating the additional metals and the reduced portion of the cathode waste.

The further metals and reduced portion of the cathode waste can be at a weight ratio of at least 1:1.

The further metals and reduced portion of the cathode waste can be at a weight ratio of at least 1.5:1.

The method can further include recovering the metals by collecting the metals after separation from the cathode waste.

The cathode material can include a first mass of cathode metals selected from the group consisting of lithium, cobalt, nickel, magnesium, and combination thereof. The collected metals can include at least 70 wt % of the first mass of cathode metals.

The collected metals can include at least 70 wt % of the lithium in the first mass of cathode metals.

The collected metals can include at least 70 wt % of the cobalt in the first mass of cathode metals.

The collected metals can include at least 70 wt % of the nickel in the first mass of cathode metals.

The collected metals can include at least 70 wt % of the magnesium in the first mass of cathode metals.

The collected metals can include at least 70 wt % of each of the lithium, cobalt, nickel, and magnesium in the first mass of cathode metals.

The collected metals can include at least 90 wt % of the lithium in the first mass of cathode metals.

The collected metals can include at least 90 wt % of the cobalt in the first mass of cathode metals.

The collected metals can include at least 90 wt % of the nickel in the first mass of cathode metals.

The collected metals can include at least 90 wt % of the magnesium in the first mass of cathode metals.

The collected metals can include at least 90 wt % of each of the lithium, cobalt, nickel, and magnesium in the first mass of cathode metals.

The method can be performed in a continuous process or automated process.

The metals can be recycled in new metal-ion or metal batteries.

The metals can be recycled as cathode materials in the new metal-ion or metal batteries.

In general, in another embodiment, the invention features a method of recovering metal. The method includes forming a mixture including a cathode material. The cathode material is prepared from one or more batteries. The method further includes applying a voltage across the mixture to obtain metals and cathode waste from the cathode material. The voltage is applied in one or more voltage pulses. Duration of each of the one or more voltage pulses is for a duration period. The method further includes magnetically separating the metal and the cathode waste.

Implementations of the invention can include one or more of the following features: The one or more batteries can be one or more non-lithium metal-ion batteries.

The one or more batteries can include one or more batteries selected from the group consisting of lithium-ion batteries, sodium-ion batteries, potassium-ion batteries, zinc-ion batteries, magnesium-ion batteries, aluminum-ion batteries, metal-ion batteries, metal batteries, anode-free batteries, metal oxygen batteries, metal air batteries, and combinations thereof.

In general, in another embodiment, the invention features a system for performing the method of recovering metal utilizing at least one of the above-described methods for recovering metals. The system includes a source of the mixture including the cathode material. The system further includes a cell operably connected to the source such that the mixture can be flowed into the cell and held under compression. The system further includes electrodes operatively connected to the cell. The system further includes a flash power supply for applying a voltage across the mixture to obtain metals and cathode waste from the cathode material. The system further includes a magnet in operable contact with the metals and cathode waste. The magnet is operable for magnetically separating the metals and the cathode waste.

Implementations of the invention can include one or more of the following features:

In general, in another embodiment, the invention features a . . .

Implementations of the invention can include one or more of the following features:

The mixture can further include a conductive additive.

The system can be operable to perform a continuous process or automated process.

In general, in another embodiment, the invention features a method of recovering metal. The method includes forming a mixture including a battery material. The battery material is prepared from one or more batteries. The method further includes applying a voltage across the mixture to obtain metals and battery waste from the battery material. The voltage is applied in one or more voltage pulses. Duration of each of the one or more voltage pulses is for a duration period. The method further includes magnetically separating the metals and the battery waste.

Implementations of the invention can include one or more of the following features:

The one or more batteries can include one or more lithium-ion batteries.

The one or more batteries can include one or more non-lithium metal-ion batteries selected from the group consisting of lithium-ion batteries, sodium-ion batteries, potassium-ion batteries, zinc-ion batteries, magnesium-ion batteries, aluminum-ion batteries, metal-ion batteries, metal batteries, anode-free batteries, metal oxygen batteries, metal air batteries, and combinations thereof.

The mixture can further include a conductive additive.

In general, in another embodiment, the invention features a system for performing the method of recovering metal utilizing the above-described method for recovering metal. The system includes a source of the mixture including the battery material. The system further includes a cell operably connected to the source such that the mixture can be flowed into the cell and held under compression. The system further includes electrodes operatively connected to the cell. The system further includes a flash power supply for applying a voltage across the mixture to obtain metals and battery waste from the battery material. The system further includes a magnet in operable contact with the metals and battery waste. The magnet is operable for magnetically separating the metals and the battery waste.

Implementations of the invention can include one or more of the following features:

The battery material can include lithium-ion battery material.

The battery material can be non-lithium metal-ion battery material selected from the group consisting of sodium-ion battery material, potassium-ion battery material, zinc-ion battery material, magnesium-ion battery material, aluminum-ion battery material, and combinations thereof.

The mixture can further include a conductive additive.

The system can be operable to perform a continuous process or automated process.

In general, in another embodiment, the invention features a method of recovering metal. The method includes forming a mixture including a cathode material. The cathode material is prepared from one or more batteries including cathodes. The method further includes applying a voltage across the mixture to obtain metals and cathode waste from the cathode material. The voltage is applied in one or more voltage pulses. Duration of each of the one or more voltage pulses is for a duration period. The method destroys 3D morphology of the cathodes in the cathode material. The method further includes extracting the metal from the cathode waste using an aqueous solution.

Implementations of the invention can include one or more of the following features:

The metals can be selected from the group consisting of lithium, cobalt, nickel, manganese, copper, and iron.

The metals can be in the form of one or more metal salts.

The one or more metal salts can be in the form one or more oxides.

The aqueous solution can include an acid.

The acid can be HCl in the range of between 0.01 M and 12 M.

The acid can be HCl in the range of between 0.01 M and 0.1 M.

The acid can be in the range of between 0.01 M and 15 M.

The acid can be the range of between 0.01 M and 0.1 M.

The voltage can be applied in between one voltage pulse and 100 voltage pulses.

The one or more batteries including cathodes can include cathodes selected from the group consisting of LCO cathodes and NMC cathodes.

In general, in another embodiment, the invention features a system for performing the method of recovering metal utilizing at least one of the above-described methods. The system includes a source of the mixture including the cathode material. The system further includes a cell operably connected to the source such that the mixture can be flowed into the cell and held under compression. The system further includes electrodes operatively connected to the cell. The system further includes a flash power supply for applying a voltage across the mixture to obtain metals and cathode waste from the cathode material. The system further includes a source of am aqueous solution. The aqueous solution is operable for extracting the metal from the cathode waste.

Implementations of the invention can include one or more of the following features:

The mixture can further include a conductive additive.

The system can be operable to perform a continuous process or automated process.

In general, in another embodiment, the invention features a method of recycling anode material. The method includes obtaining a mixture including anode material from one or more batteries. The anode material includes graphite. The method further includes applying a voltage across the mixture to purify the graphite in the mixture. The voltage is applied in one or more voltage pulses. Duration of each of the one or more voltage pulses is for a duration period. The method further includes utilizing the graphite purified by the step of applying the voltage in one or more new batteries.

Implementations of the invention can include one or more of the following features:

The one or more batteries can include one or more lithium-ion batteries.

The one or more batteries can include one or more batteries selected from the group consisting of lithium-ion batteries, sodium-ion batteries, potassium-ion batteries, zinc-ion batteries, magnesium-ion batteries, aluminum-ion batteries, metal-ion batteries, and combinations thereof.

The one or more new batteries can include one or more new lithium-ion batteries.

The one or more new batteries can include one or more new lithium-ion batteries.

The one or more batteries can include one or more batteries selected from the group consisting of lithium-ion batteries, sodium-ion batteries, potassium-ion batteries, zinc-ion batteries, magnesium-ion batteries, aluminum-ion batteries, metal-ion batteries, metal batteries, anode-free batteries, metal oxygen batteries, metal air batteries, and combinations thereof.

The mixture can consist of anode material.

The mixture further can include cathode materials from the one or more batteries.

The mixture can include the anode material mixed with a conductive additive that is not the anode material.

The conductive additive can be a carbon source.

The conductive additive can be selected from the group consisting of graphite, anodic graphite, battery-grade graphite, elemental carbon, carbon black, graphene, flash graphene, turbostratic graphene, coal, anthracite, coke, metallurgical coke, calcined coke, activated charcoal, biochar, natural gas carbon that had been stripped of its hydrogen atoms, activated charcoal, shungite, plastic waste, plastic waste-derived carbon char, food waste, food waste-derived carbon char, biomass, biomass-derived carbon char, hydrocarbon gas-derived carbon, and mixtures therefrom.

The conductive additive can be carbon black.

The conductive additive can be predominately elemental carbon.

In general, in another embodiment, the invention features a system for performing the method of recycling anode material utilizing at least one of the above-described methods of recycling anode material. The system includes a source of the mixture including the anode material including graphite. The system further includes a cell operably connected to the source such that the mixture can be flowed into the cell and held under compression. The system further includes electrodes operatively connected to the cell. The system further includes a flash power supply for applying a voltage across the mixture to purify the graphite in the anode material.

Implementations of the invention can include one or more of the following features:

The anode material can include lithium-ion battery anode material.

The anode material can include non-lithium metal-ion battery anode material selected from the group consisting of lithium-ion battery anode material, sodium-ion battery anode material, potassium-ion battery anode material, zinc-ion battery anode material, magnesium-ion battery anode material, aluminum-ion battery anode material, and combinations thereof.

The mixture can include the anode material mixed with a conductive additive that is not the anode material.

The system can be operable to perform a continuous process or automated process.

In general, in another embodiment, the invention features a method that includes selecting a graphite anode material from a battery. The method further includes applying flash Joule heating to the graphite anode material to form flashed graphite anode material. The application of flash Joule heating purifies the graphite anode material.

Implementations of the invention can include one or more of the following features:

The battery can be a lithium-ion battery.

The battery can be a battery selected from the group consisting of lithium-ion batteries, sodium-ion batteries, potassium-ion batteries, zinc-ion batteries, magnesium-ion batteries, aluminum-ion batteries, and combinations thereof.

The flash Joule heating can include applying a voltage across the graphite anode material. The voltage can be applied in one or more voltage pulses. Duration of each of the one or more voltage pulses can be for a duration period.

The method can further include using the flashed graphite anode material in a second battery.

The second battery can be a second lithium-ion battery.

The battery can be a lithium-ion battery.

The second battery can be a second non-lithium metal-ion battery selected from the group consisting of sodium-ion batteries, potassium-ion batteries, zinc-ion batteries, magnesium-ion batteries, aluminum-ion batteries, and combinations thereof.

The battery can be a non-lithium metal-ion battery selected from the group consisting of sodium-ion batteries, potassium-ion batteries, zinc-ion batteries, magnesium-ion batteries, aluminum-ion batteries, and combinations thereof.

The method can further include washing the flashed graphite anode material to obtain inorganic metals and salts separate from the graphite in the flashed graphite anode material.

The method can further include using the flashed graphite anode material after washing in a second battery.

The second battery can be a second lithium-ion battery.

The battery can be a lithium-ion battery.

The second battery can be a battery selected from the group consisting of lithium-ion batteries, sodium-ion batteries, potassium-ion batteries, zinc-ion batteries, magnesium-ion batteries, aluminum-ion batteries, and combinations thereof.

The battery can be a battery selected from the group consisting of lithium-ion batteries, sodium-ion batteries, potassium-ion batteries, zinc-ion batteries, magnesium-ion batteries, aluminum-ion batteries, and combinations thereof.

In general, in another embodiment, the invention features a method of resynthesizing cathode material. The method includes performing a flash Joule heating process on cathode material to form a ferromagnetic flash product. The method further includes performing a hydrothermal and calcination process on the ferromagnetic flash product to form the resynthesized cathode material.

### BRIEF DESCRIPTION OF THE DRAWINGS

FIGS. 1A-1F are schematics and graphs for flash recycling of cathode waste. FIG. 1A is a schematics of a flash recycling of cathode waste method. FIGS. 1B-1C are, respectively, schematics of traditional hydrometallurgical and pyrometallurgical methods. FIG. 1D is a graph showing real-time temperature measurement by fitting the blackbody radiation from the sample during the flash recycling process, listing the rapid cooling, all complete in less than 0.5 seconds. FIG. 1E is a graph showing temperature-vapor pressure relationships for various metals involved in cathode waste. FIG. 1F is a graph showing the magnetic response of unflashed cathode waste, flash recycled cathode waste ferromagnetic portion (which is ˜90% of the product), and the flash recycled cathode waste non-ferromagnetic portion (which is ˜10% of the product).

FIGS. 2A-2B show the scheme of a FJH system. FIG. 2A is an electrical schematic of the FJH system. FIG. 2B is a photograph of a FJH reaction box.

FIGS. 3A-3C show current-time curves during the flash reaction. FIG. 3A is a graph of new lithium cobalt oxide (LiCoO₂) (LCO) cathode material. FIG. 3B is a graph of new lithium nickel-manganese-cobalt oxide (LiNiₓMn_{y}Co_{z}O₂, normally referred as NMCxyz, such as NMC811) (NMC) cathode material. FIG. 3C is a graph of cathode waste obtained from spent LIB. The vertical lines during the current sweep reflect the 1000 Hz cycling of the electrical input.

FIG. 4 shows the spectra recorded by a spectrometer with 16-channel optical fibers. The wavelengths of these channels range from 1000 nm to 640 nm with equal interval of 24 nm. Black body radiation (BBR) fitting was subsequently used to obtain the temperature at each time point as shown in FIG. 1D.

FIGS. 5A-5B show magnetic response of cathode materials. FIG. 5A is a graph of a magnified hysteresis loop for CW, the non-ferromagnetic portion of the flash recycled CW (fCW nonmag) and the ferromagnetic portion of the flash recycled CW (fCW mag). FIG. 5B is a graph showing behavior of the hysteresis loop around the origin for the fCW mag.

FIGS. 6A-6D show magnetic response of cathode waste and flash product. FIGS. 6A-6B are photographs showing that the cathode waste was not attracted by a bar magnet. FIGS. 6C-6D show that the flash recycled CW is predominantly ferromagnetic.

FIG. 7 shows magnetic response of re-flashed cathode materials. The magnetic response is of the re-flash recycled cathode waste ferromagnetic portion, which is ˜60 wt % of the product, and the re-flash recycled cathode waste non-ferromagnetic portion, which is ˜40 wt % of the product. Similar magnetization behavior of re-flash recycled cathode waste ferromagnetic portions ensures the effective separation of them by the same magnet with magnetic field strength ˜5000 Oe.

FIG. 8A-8E shows structures and chemical components of re-flash recycled products. FIG. 8A is the FTIR spectra of nonferromagnetic portion of the flash recycled CW (LCO plus NMC), ferromagnetic portion of the re-flash recycled CW, and nonferromagnetic portion of the re-flash recycled CW. FIG. 8B is the XRD spectra of ferromagnetic portion of the re-flash recycled CW. FIG. 8C is an SEM image of ferromagnetic portion of the re-flash recycled CW.

FIG. 8D is the energy dispersive analysis element mapping. FIG. 8E is the corresponding spectrum of the ferromagnetic portion of the re-flash recycled CW.

FIGS. 9A-9D shows magnetic response of various cathode materials. FIG. 9A shows room temperature (300 K) hysteresis loops for NMC and the ferromagnetic portion of flash recycled NMC (fNMC mag). FIG. 9B shows behavior of the hysteresis loop around the origin for NMC and fNMC. FIG. 9C shows room temperature (300 K) hysteresis loops for LCO and the ferromagnetic portion of flash recycled LCO (fLCO mag). FIG. 9D shows behavior of the hysteresis loop around the origin for LCO and fLCO.

FIGS. 10A-10B are optical images of the ferromagnetic portions of LCO from, respectively, a ˜200 mg scale and a ˜800 mg scale.

FIGS. 10C-10D are optical images of the ferromagnetic portions of NMC811 from, respectively, a ˜200 mg scale and a ˜800 mg scale.

FIGS. 11A-11G show recovery efficiencies of various cathode materials. FIG. 11A is a graph showing recovery yields (1.0=100%) of Li and Co in the ferromagnetic portion of flash recycled LCO products after a single flash. The number of samples N=5 and the bars show the standard deviations between runs. FIG. 11B is a graph showing comparison of recovery yields of Li and Co by different recycling methods, with references noted. FIG. 11C is a graph showing recovery yields of Li, Co, Ni and Mn in the ferromagnetic portion of flashed NMC811. N=5. FIG. 11D is a graph showing recovery yields of Li, Co, Ni and Mn in the ferromagnetic portion of flashed commercial cathode waste (fCW) from a spent LIB. N=5. For FIGS. 11C-11D, the yields can occasionally exceed 1.0 because they are compared against the recovered metal content through aqueous acid digestion. FIGS. 11E-11G are radar plots reporting the recovery yields of various metals from cathode waste using, respectively, the flash recycling method and traditional hydrometallurgical and pyrometallurgical methods. For FIG. 11E, the darker shade is the recovery after a single flash and the lighter shade is the recovery after a second flash.

FIGS. 12A-12C are radar plots reporting the comparison of recovery yields of various metals from LCO using, respectively, the flash recycling method and traditional hydrometallurgical and pyrometallurgical methods. The structure retention factor R value is 7.77/3.03=2.57 for LCO.

FIGS. 12D-12F are radar plots reporting the comparison of recovery yields of various metals from NMC using, respectively, the flash recycling method and traditional hydrometallurgical and pyrometallurgical methods. The structure retention factor R value is 0.29/0.57=0.51 for NMC.

FIGS. 13A-13J show structures and chemical components of flash recycled products. FIG. 13A is high resolution XPS spectra of Co 2p at the surface and subsurface area of the ferromagnetic portion of the flash recycled CW (fCW). FIG. 13B is a graph that shows the elemental ratios at different depths of the ferromagnetic portion of the fCW (LCO+NMC). Spectra were acquired at different depths after surface etching. Electrolyte-derived fluoride was deposited during CEI formation in the spent LIB. FIG. 13C is a schematic of the ferromagnetic portion of the fCW particle with hierarchical structure. FIG. 13D is an HAADF image and corresponding energy dispersive analysis element mapping of the ferromagnetic portion of the fLCO. FIG. 13E shows atomistic structure of partially de-lithiated LiₓCoO₂ before flash recycling and high-quality LiCoO₂, Co₃O₄ and CoO obtained after flash recycling. The right panel demonstrated the magnetization of Co₃O₄ by plotting the difference between spin density distribution for a spin up and spin down configurations at 0.02 e⁻/Å³, maximum magnetic moment of ˜70 emu/g. FIG. 13F is an HR-TEM image of R-LCO reporting the existence of the layered structure at the surface. The inset of FIG. 13F is the corresponding FFT pattern. FIG. 13G is an atomic-resolution HAADF-STEM image of R-LCO. FIG. 13H is an HAADF image and corresponding energy dispersive analysis element mapping of R-CW. FIG. 13I is an image of Li-ion permeable partially graphitized amorphous carbon structure at the end of 9 ns annealing at 2500 K, with the line indicated possible Li-ion trajectory. FIG. 13J is a graph showing electrochemical performances of spent CW, resynthesized cathode materials and new LCO in prepared half cells. The rate is 0.2 C for testing.

FIGS. 14A-14E show chemical components of ferromagnetic flash recycled CW (fCW) derived from a mix of LCO and NMC as contained in spent commercial laptop computer batteries. FIG. 14A is the full scan XPS result of the ferromagnetic fCW. FIGS. 14B-14E show, respectively, high resolution XPS spectra of C 1s, O 1s, F 1s, and Li 1s, at the surface and subsurface area of ferromagnetic fCW. Spectra were acquired at different depths after surface etching.

FIG. 15A-15G show chemical components of CW derived from a mix of LCO and NMC as obtained from spent commercial laptop computer batteries. FIG. 15A shows the full scan XPS result of the CW. FIGS. 15B-15F show, respectively, high resolution XPS spectra of C 1s, Co 2p, F 1s, Li 1s, and O 1s at the surface and subsurface area of CW. Spectra were acquired at different depths after surface etching. FIG. 15G shows the elemental ratios at different depths of CW.

FIGS. 16A-16F show chemical components of the ferromagnetic portion of flash recycled LCO (fLCO) from 0 nm to 500 nm. FIG. 16A shows the full scan XPS result of the ferromagnetic fLCO. FIGS. 16B-16E show, respectively, high resolution XPS spectra of C 1s, Co 2p, Li 1s, and O 1s at the surface and subsurface area of fLCO. Spectra were acquired at different depths after surface etching. FIG. 16F shows the elemental ratios at different depths of ferromagnetic fLCO.

FIGS. 17A-17F show chemical components of the ferromagnetic portion of flash recycled LCO (fLCO) from 0 nm to 100 nm. FIG. 17A shows the full scan XPS result of the ferromagnetic fLCO. FIGS. 17B-17E show, respectively, high resolution XPS spectra of C 1s, Co 2p, Li 1s, and O 1s at the surface and subsurface area of flash LCO. Spectra were acquired at different depths after surface etching. FIG. 17F shows the elemental ratios at different depths of ferromagnetic fLCO.

FIGS. 18A-1811 show chemical components of the ferromagnetic portion from flash recycled NMC (fNMC) from 0 nm to 500 nm. FIG. 18A shows the full scan XPS result of the ferromagnetic fNMC. FIGS. 18B-18G show, respectively, high resolution XPS spectra of C 1s, Co 2p, Li 1s, O 1s, Ni 2p and Mn 2p at the surface and subsurface area of fNMC. Spectra were acquired at different depths after surface etching. FIG. 18H shows the elemental ratios at different depths of ferromagnetic fNMC.

FIGS. 19A-1911 show chemical components of the ferromagnetic portion from flash recycled NMC (fNMC) from 0 nm to 100 nm. FIG. 19A shows the full scan XPS result of the ferromagnetic fNMC. FIGS. 19B-19G show, respectively, high resolution XPS spectra of C 1s, Co 2p, Li 1s, O 1s, Ni 2p and Mn 2p at the surface and subsurface area of fNMC. Spectra were acquired at different depths after surface etching. FIG. 19H shows the elemental ratios at different depths of ferromagnetic fNMC.

FIG. 20A shows the X-ray diffraction spectra of CW, ferromagnetic fCW, and non-ferromagnetic fCW.

FIG. 20B shows the magnified X-ray diffraction spectra in the low angle range as shown by the dashed rectangle in FIG. 20A.

FIG. 21A shows the X-ray diffraction spectra of new lithium cobalt oxide (LCO), ferromagnetic fLCO, and non-ferromagnetic fLCO.

FIG. 21B shows the magnified X-ray diffraction spectra in the low angle range as shown by the dashed rectangle in FIG. 21A.

FIG. 22A shows the X-ray diffraction spectra of new lithium nickel-manganese-cobalt oxide, and ferromagnetic fNMC.

FIG. 22B shows the magnified X-ray diffraction spectra in the low angle range as shown by the dashed rectangle in FIG. 22A shows.

FIG. 23A shows the FTIR spectra of CW and ferromagnetic portion of the fCW.

FIG. 23B shows the size distribution of starting CW particles and ferromagnetic portion of fCW particles for the materials shown in FIG. 23A. The number of particles N=100.

FIGS. 23C-23D show SEM images of, respectively, ferromagnetic portion of the fCW and starting CW particles for the materials shown in FIG. 23A.

FIGS. 24A-24D are images obtained from a mix of LCO and NMC. FIG. 24A is a SEM image of the CW derived from the mix of LCO and NMC before flash recycling. FIG. 24B is a higher resolution SEM image of the CW before flash recycling. FIG. 24C is an SEM image of the ferromagnetic portion of fCW. FIG. 24D is a higher resolution SEM images of the ferromagnetic portion of fCW.

FIGS. 25A-25F are images obtained from LCO. FIG. 25A shows an SEM image of the LCO before flash recycling. FIG. 25B shows a higher resolution SEM image of the LCO before flash recycling. FIG. 25C shows an SEM image of the ferromagnetic portion of fLCO.

FIG. 25D shows the higher resolution SEM images of the ferromagnetic portion of fLCO.

FIG. 25E shows the size distribution of new LCO and ferromagnetic portion of fLCO particles. The number of samples N=100 FIG. 25F shows the FTIR spectra of the LCO and ferromagnetic fLCO.

FIGS. 26A-26F are images obtained from NMC. FIG. 26A shows an SEM image of the NMC before flash recycling. FIG. 26B shows a higher resolution SEM image of the NMC before flash recycling. FIG. 26C shows an SEM image of the ferromagnetic portion of fNMC.

FIG. 26D shows the higher resolution SEM images of the ferromagnetic portion of flash NMC.

FIG. 26E shows the size distribution of NMC and ferromagnetic portion of fNMC particles. The number of samples N=100 FIG. 26F shows the FTIR spectra of the NMC and ferromagnetic fNMC.

FIGS. 27A-27E show FIB-SEM images of the carbon coated structure. FIG. 27A is the top-view SEM image showing the ferromagnetic fCW particles after the FIB cutting. FIGS. 27B-27C are cross-section SEM images showing the boundary between the surface carbon coating and the underlying ferromagnetic fCW particles. The dash line is used to underscore the boundary. FIG. 27D is the cross-section SEM image of ferromagnetic fCW particles after FIB cutting and the corresponding elemental distributions for 0, C, and Co. FIG. 27E is the top-view SEM image of ferromagnetic fCW particles after FIB cutting and corresponding elemental distributions for O, C, and Co.

FIGS. 28A-28B are schemes of, respectively, fLCO mag and LCO showing the hierarchical structure of the flash cathode particles.

FIGS. 29A-2911 are TEM images of the ferromagnetic portion of fLCO particles. FIGS. 29A-29B are HR-TEM images of the ferromagnetic fLCO particles. FIGS. 29C-29D are Fast Fourier transform results of the ferromagnetic fLCO particles. FIGS. 29E-29F are HR-TEM images of the new LCO particles. FIGS. 29F-29G are SAED patterns of the new LCO particles.

FIG. 30 is a graph showing energy preference towards phase segregation of partially delithiated CW material.

FIG. 31A is the X-ray diffraction spectra of commercial cathode materials at the charge state and discharge state.

FIGS. 31B-31C are the magnified X-ray diffraction spectra in different angle ranges as shown by, respectively the left and right dashed rectangles in FIG. 31A.

FIG. 32 shows the characterization of Li sources, with the curves for LiOH·H₂O reactant and recovered Li materials, respectively. The heating rate was set to 10° C. min⁻¹, and the N2 flow was maintained at 80 mL min⁻¹ throughout the run.

FIGS. 33A-33E show characterization for resynthesis conditions. FIG. 33A shows the Ellingham diagram of relevant reactions. FIG. 33B is the XRD results of cathode materials resynthesized with a calcination temperature 400° C. (R-CW-400) and 500° C. (R-CW-500).

FIGS. 33C-33E are the thermogravimetric curve and corresponding differential scanning calorimetry analysis of LCO and the ferromagnetic portion of the fLCO. The heating rate was set to 10° C. min⁻¹, and the air flow was maintained at 80 mL min⁻¹ throughout the run. To test the thermal stability at 500° C., the temperature was held at 500° C. for 30 min In FIG. 33E.

FIGS. 34A-34I show the morphology of resynthesized cathodes. FIGS. 34A-34C are SEM images of R-CW reporting the homogeneous carbon coating and layered structure. FIGS. 34D-34E are HR-TEM images of the R-LCO particles reporting recovered cathode layered structure. FIG. 34F is an HAADF-STEM image of the R-LCO particles. FIGS. 34G-34I are the corresponding energy dispersive analysis element mapping of the R-LCO particles.

FIGS. 35A-35E show characterization of resynthesized cathodes. FIG. 35A shows the FTIR spectra of cathode waste and re-synthesized cathode materials (R-CW). FIG. 35B shows the FTIR spectra of LCO and re-synthesized cathode materials (R-LCO). FIG. 35C is the room temperature (300 K) hysteresis loops for the ferromagnetic portion of flash recycled NMC (fCW mag), flash CW after hydrothermal reaction (after hydro) and re-synthesized cathode materials (R-CW). FIG. 35D is the behavior of the hysteresis loop around the origin for these three samples. FIG. 35E shows electrochemical performances of new NMC (NMC) in prepared half cells. The rate was 0.2 C for testing.

FIGS. 36A-36C shows the morphology of carbon coating structure. FIG. 36A is a TEM image of R-CW particle. FIG. 36B-36C are HR-TEM images of R-CW particle reporting the amorphous feature of the carbon coating at the surface.

FIGS. 37A-37J show elemental distribution of resynthesized cathode materials. FIG. 37A is the energy-dispersive X-ray spectrum of an R-CW particle. FIG. 37B is an HAADF-STEM image of the R-CW particle. FIG. 37C is a BF-STEM image of the R-CW particle. FIG. 37D-37J are corresponding elemental mapping of the R-CW particle.

FIGS. 38A-38D show crystal structure of resynthesized cathode materials. FIG. 38A is an HR-TEM image of R-LCO reporting the existence of the layered structure at the surface of cathode particle. FIG. S38B is the corresponding FFT pattern of R-LCO as shown in FIG. 38A. FIGS. 38C-38D are atomic-resolution HAADF-STEM images of R-LCO reporting the existence of the layered structure at the surface of cathode particle.

FIGS. 39A-39E show carbon crust configuration after annealing at various temperatures (700 K, 1000 K, 1500 K, 2000 K, and 2500 K, respectively) for 9 ns.

FIGS. 40A-40D shows diffusion barrier for Li⁺ on various features within amorphous carbon shell. FIG. 40A shows the unpassivated single-layer graphene edge. FIG. 40B shows the unpassivated double-layer graphene edge. FIG. 40C shows over the reconstructed di-vacancy forming 5-8-5 defect (largest barrier corresponds to diffusion through the 8-ring defect to the other side of the plane, steps 7-10. FIG. 40D shows diffusion over the reconstructed edge of double-layer graphene shows barrier almost identical to that for diffusion on the plane graphene ˜0.34 eV.

FIGS. 41A-41F show economic and environmental analysis of pyrometallurgical (pyro), hydrometallurgical (hydro), and flash recycling processes. FIG. 41A is a scheme of a life cycle analysis of Li-ion batteries showing that flashing is a more direct route to recycling.

FIG. 41B is the recycle revenue and recycle cost per kilogram of cathode resynthesized by the various methods. FIG. 41C shows net profit per kilogram of cathode resynthesized by the various methods. FIG. 41D shows total energy consumption of resynthesizing 1 kg of cathode materials with pyrometallurgical, hydrometallurgical, and flash recycling methods. The energy cost from mining the virgin ores is given as a comparison. FIG. 41E shows GHG emissions in resynthesizing 1 kg of cathode materials with pyrometallurgical, hydrometallurgical, and flash recycling methods. The GHG emissions using virgin ores is given as a comparison. FIG. 41F shows net profit per kilogram of various cathodes resynthesized by the pyrometallurgical, hydrometallurgical, and flash recycling methods.

FIG. 42A is a scheme of life cycle analysis of lithium-ion batteries.

FIG. 42B is a simplified flow chart of the pyrometallurgical method.

FIG. 42C is a simplified flow chart of the hydrometallurgical method.

FIG. 42D is a simplified flow chart of the flash recycling method.

FIGS. 43A-43B show the scheme of a FJH system. FIG. 43A is an electrical schematic of the FJH system. FIG. 43B is a photograph of the large FJH reaction box.

FIGS. 44A-44C show flash recycling of graphite anodes. FIG. 44A-44B are, respectively, schematics of flash recycling of anode waste and resistance-dependent Joule heating effects in multiple phase systems. FIG. 44C is the corresponding current-time curve during the flash recycling process.

FIGS. 45A-45B show, respectively, general procedures for conventional high temperature calcination method and real-time temperature curve from the sample during the flash recycling process.

FIGS. 46A-46D show thermal stability results of various anode materials. FIGS. 46A-46B are, respectively, TGA and DSC results of anode waste (AW), calcinated anode waste (cAW), flash anode waste (fAW), and graphite. FIGS. 46C-46D are, respectively, TGA and DSC results of AW, fAW 100 V, fAW 120 V, and fAW 120 V×2. TGA and DSC data was collected from 25 to 1000° C. under air. The heating rate was set to 10° C./min and the air flow was maintained at 80 mL/min throughout the run.

FIG. 47 shows thermal stability tests results by TGA. The remained mass ratio of various treated graphite anode materials at T=773 K.

FIGS. 48A-48D are, respectively, the optical images of anode waste, calcinated anode waste, flash anode waste (200 mg per batch), and flash anode waste (1 g per batch).

FIGS. 48E-48F are, respectively, TGA and DSC results of AW and fAW gram-scale. TGA and DSC data was collected from 25 to 1000° C. under air. The heating rate was set to 10° C./min and the air flow was maintained at 80 mL/min throughout the run.

FIG. 49 shows thermal stability tests by TGA. The remained mass ratio of various treated graphite anode materials at T=1273 K.

FIG. 50 shows crystal structures of cAW, fAW, and AW.

FIGS. 51A-51B are high resolution XRD spectra of various anode materials (AW, cAW, and fAW).

FIGS. 52A-52C are high resolution XRD spectra of fAW (gram-scale).

FIG. 53 shows surface compositions of fAW and AW.

FIG. 54 shows surface compositions of cAW.

FIGS. 55A, 55C, and 55E show chemical components of anode materials from 0 nm (surface) to 450 nm depth for AW, fAW, and cAW, respectively. Spectra were acquired at different depths after surface etching.

FIGS. 55B, 55D, and 55F show the elemental distributions of, respectively, AW, fAW, and cAW microparticles at the subsurface area from 0 to 500 nm.

FIG. 56 is UV-vis spectra of the aqueous leaching solution of fAW and AW. The optical images show the yellowish solution and transparent solution derived from AW and fAW, respectively.

FIGS. 57A-57I are SEM images of various anode materials. FIGS. 57A-57C are AW, FIGS. 57D-57F are fAW, and FIGS. 57G-57I are cAW.

FIGS. 57J-57K are statistical survey showing, respectively, the AW sizes, the fAW sizes, and the cAW sizes. For each, the number of samples N=50. The size distribution results indicate that AW, fAW and cAW have similar average particle sizes.

FIGS. 58A-58D are images of anode waste. FIGS. 58A-58B are TEM images; and FIGS. 58C-58D are HR-TEM images. The average thickness of the SEI around the graphite particles is ˜145 nm. Under the SEI region, the lattice of the graphite can be seen as shown in FIG. 16c. And there are many small crystals embedded within the SEI, which matches with the mosaic model of the SEI structure.

FIGS. 59A-59D are images of flash anode waste. FIGS. 59A-59B are TEM images; and FIGS. 59C-59D are HR-TEM images. The decomposition of the SEI and the formation of the graphene shell and nanoparticles, such as LiF and Co₃O₄, can be seen, which matches with the results of elemental distributions and XRD spectra. Also, the average thickness of the layer shrinks from ˜145 nm to ˜65 nm. This SEI-derived layer is composed of graphene layer and embedded nanoparticles, which indicates that flash method can be an effective method to decompose the SEI and convert it into protective graphene layer afterwards.

FIG. 60 are STEM images and the corresponding elemental distributions of anode waste. The scale bars are the same for all the images. The metal elements such as Co (˜0.2 at %), are distributed homogeneously within the anode SEI for pristine AW, which can result from transition metals dissolution and transporting from the cathode side and get trapped within SEI at the anode side.

FIG. 61 are STEM images and respective element mapping results of fAW microparticles.

FIGS. 62A-62E show metal-ion leaching tests. FIG. 62A shows recovery efficiency and excess yield Y/Y₀ of total metal ions for flash anode waste by HCl with different concentrations. The number of samples N=3 and the bars show the standard derivations between runs, the same below. FIG. 62B shows recovery efficiency and excess yield Y/Y₀ of various metal ions for flash anode waste by 0.1 M HCl. FIG. 62C shows recovery efficiency and excess yield Y/Y₀ of total metal ions for calcinated anode waste by HCl with different concentrations. FIG. 62D shows recovery efficiency and excess yield Y/Y₀ of total metal ions for flash anode waste after TGA treatment by HCl with different concentrations. FIG. 62E shows total amounts of metal ions and excess yields Y/Y₀ of various treated anode waste by concentrated HCl.

FIGS. 63A-63B are, respectively, TGA and DSC results of AW, fAW-W, and AW-W. TGA and DSC data was collected from 25 to 1000° C. under air. The heating rate was set to 10° C./min and the air flow was maintained at 80 mL/min throughout the run. fAW-W represents fAW after rinsing with 0.1 M HCl to recollect the valuable metal ions. The same for other anode materials.

FIGS. 64A-64C are images of fAW-W. FIG. 64A is a TEM image of fAW-W, and FIGS. 64B-64C are HR-TEM images of fAW-W.

FIG. 64D is corresponding FFT patterns along the zone axis for fAW-W shown in FIGS. 64A-64C. The absence of embedded nanoparticles indicates diluted acid post-treatment can be used to effectively collect the valuable metals. Besides, there is only one set of 6-fold diffraction patterns, which reflects the well-graphitized structure of the anode microparticles.

FIG. 65 shows the first cycle voltage profiles of AW, cAW, fAW, and graphite at 0.05 C. The areal capacity is ˜3.0 mAh cm⁻².

FIGS. 66A-66C show the voltage profiles of graphite and fAW (in FIG. 66A), cAW (in FIG. 66B) and AW (in FIG. 66C) at different rates. The areal capacity is ˜2.0 mAh cm⁻².

FIG. 67 shows rate performances of AW, cAW, fAW, and graphite.

FIGS. 68A-68C show, respectively, preparation of synthetic graphite, flash recycling method, and high temperature calcination method.

FIGS. 69A-69C show, respectively, GHG emissions, water consumption, and total energy consumption in producing 1 kg anode materials with flash recycling method (flash), high temperature calcination method (HTC) and 1 kg synthetic graphite.

FIGS. 69D-69E show the cost and the net profit about preparing 1 kg of synthetic graphite, 1 kg anode materials with flash recycling method (flash) and high temperature calcination method (HTC).

FIG. 70 shows weight percent of Li, Co, Ni and Mn that can be collected from a cell including quartz tube, graphite spacers and copper wool electrodes but without any loaded sample (i.e., a blank group).

FIG. 71 shows the total amount of Li and Co in 1.00 g of sample.

FIGS. 72A-72B show, respectively, recovery efficiency of (a) Li and (b) Co from LCO and flash LCO in HCl solutions with different concentrations.

FIG. 73 shows distribution of Li and Co from LCO and flash LCO after dissolving in 0.1 M HCl solutions and rinsing from the quartz tube, graphite spacers, and copper wool electrodes.

FIG. 74 shows total amount of Li, Co, Ni and Mn in 1.00 g sample. (Left bars) before flashing. (Right bars) after flashing.

FIGS. 75A-75D show, respectively, recovery efficiency of (a) Li, (b) Co, (c) Ni, and (d) Mn from NMC and flash NMC in HCl solutions with different concentrations.

### DETAILED DESCRIPTION

The present invention relates to the flash recycling of batteries, including lithium-ion batteries, other metal (sodium, potassium, zinc, magnesium, and aluminum)-ion batteries, metal batteries, batteries having all metal oxide cathodes, and batteries having all graphite-containing anodes, including solvent-free and water-free flash Joule heating (FJH) methods performed in combined with magnetic separation to recover lithium, cobalt, nickel, and manganese. The solvent and water-free FJH method combined with magnetic separation can be utilized to recycle spent batteries, i.e., spent lithium-ion batteries (LIBs), other spent metal-ion batteries, and spent metal batteries. The FJH methods disclosed and discussed herein will be focused upon lithium-ion batteries (LIBs). Similar methods can be applied to other metal-ion batteries (and their cathodes and anodes), such as sodium-, potassium-, zinc-, magnesium-, and aluminum-ion batteries, and metal battery anodes and cathodes, which include anode-free batteries (which means there is no excess anodic metal) and metal oxygen and metal air batteries.

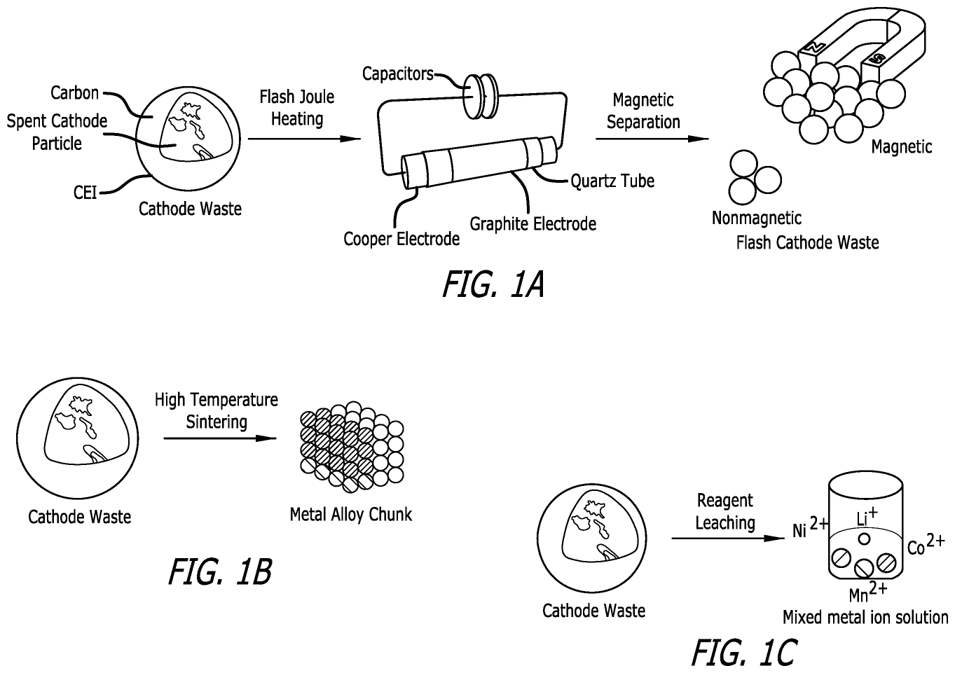

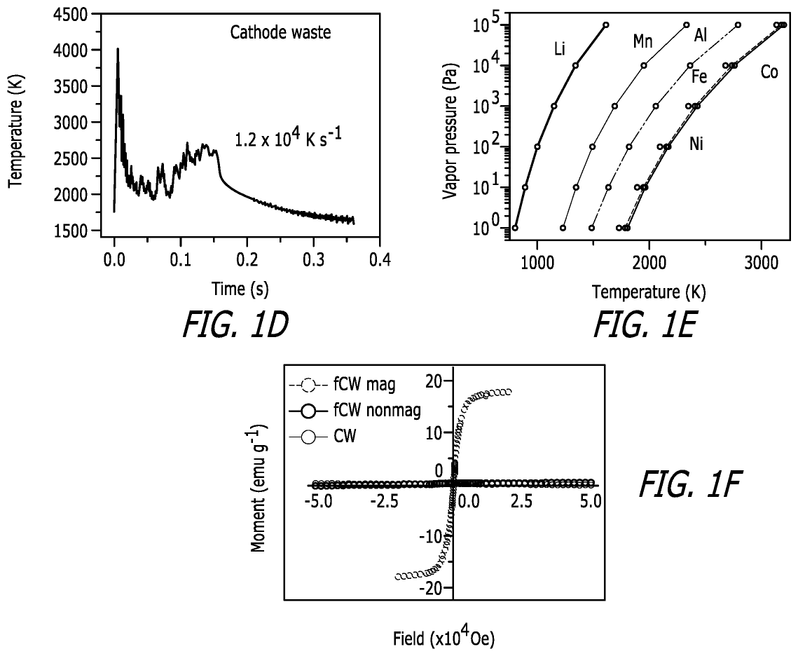

This method is ultra-fast and retains the particle morphology (FIG. 1A). Prior recycling strategies to collect the valuable metals contained in spent cathode waste (CW) include pyrometallurgy and hydrometallurgy [Tran 2018], requiring harsh conditions such as extreme furnace temperatures greater than 1400° C. [Lv 2018; Li 2016] or caustic reagents including hydrochloric, nitric, and sulfuric acids (FIGS. 1B-1C). [Chagnes 2013]. In addition, these methods demand high energy, generate much greenhouse gas (GHG) and secondary wastes, and lead to the destruction of the material down to its elements or ionic solutions during the recycling, thereby increasing the cost of conversion back into the cathode morphologies. [Xu 2020]. In the flash method of the present invention, the hierarchical cathode morphology is preserved, while the other components of the CW, such as cathode electrolyte interphase (CEI), are decomposed (FIG. 1A).

### Flash Recycling Process for Cathode Materials

Flash recycling of LIBs is an environmentally cleaner method to reclaim the metals in secondary batteries. The method preserves the 3D layered structure of the cathode and provides an efficient reuse of the elemental inventory. The fast process also produces a convenient carbon coating on the recycled cathode particles that permits Li-ion transport while stabilizing the overall structure of the cathode, thereby affording superior performance to the recycled batteries over new batteries. Since the FJH process is being industrially scaled to the multi-ton scale per facility [Universal Matter 2021], manufacturability is attainable while minimizing dependence on freshly mined metal ores for the production of LIBs.

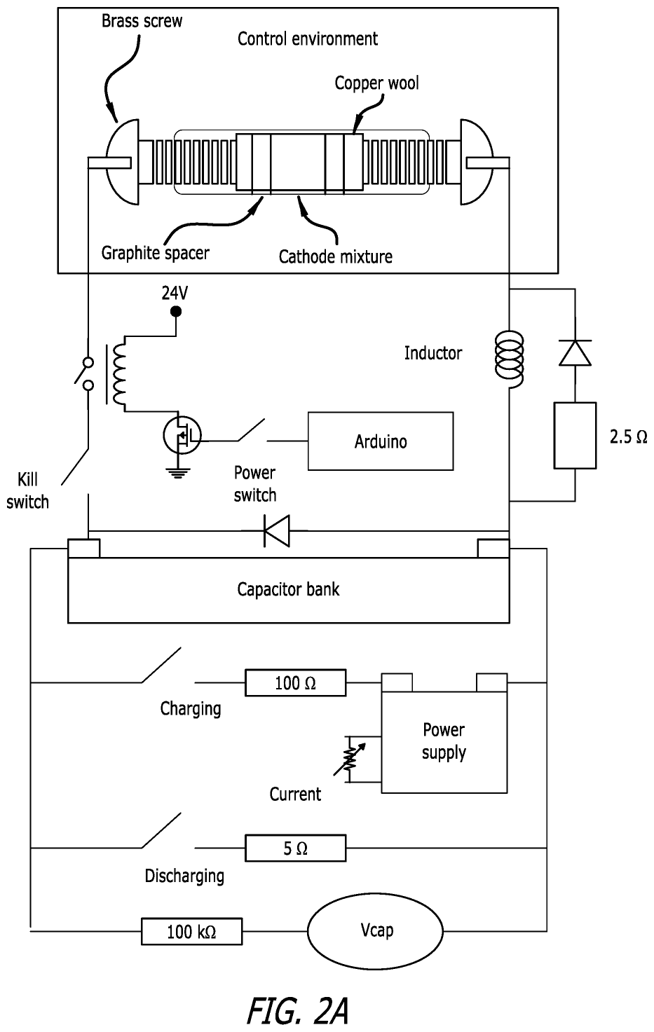

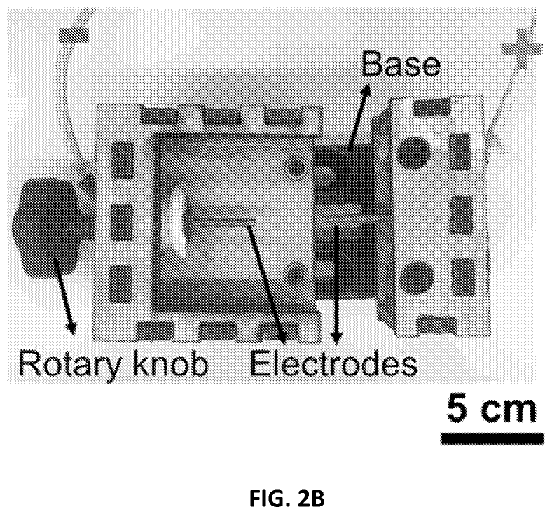

In a flash recycling process, a mixture of cathode material and a conductive additive (such as around 10 wt % and such as carbon black) or graphite from the spent anode (such as around 20 wt %), is slightly compressed inside a quartz tube between two electrodes. [Luong 2020; Chen 2021]. The carbon additives are used to increase the electrical conductivity of the mixture. The capacitor banks in the circuit can be used to provide electrothermal energy to the reactants for ˜300 ms. See FIGS. 2A-2B.

For example, spent Li-ion batteries were discharged on a circuit until the voltage was below 2.5 V and then the electrodes were collected by manually disassembling the spent batteries. The cathode waste was used after directly removing it from the spent electrodes. Unless specified otherwise, the cathode materials and the conductive additive (10 wt % carbon black or 20 wt % spent anode graphite) were mixed evenly by grinding with a mortar and pestle for ˜10 min. The reactants were loaded into a quartz tube with an inner diameter of 4 or 8 mm. The mass loads in 4- and 8-mm tube were 200 mg and 800 mg, respectively. Graphite rods and copper wool were used as electrodes and spacers, respectively. They were used to compress the reactants as shown in FIG. 1A. The graphite rods were in contact with the sample in the quartz tube. The electrical energy was provided by a capacitor bank in the circuit with a total capacitance of 60 mF (4 mm tube) or 132 mF (8 mm tube). The capacitor bank was charged by a DC supply that could reach 400 V. The flash duration was controlled by an Arduino controller relay in the circuit acting as a high-speed switch.

Various cathode materials, LCO and cathodes combination of NMC were also used to demonstrate the versatility of flash recycling method. TABLES I-II show the flash conditions of different cathode materials in a small batch and in a large batch, respectively.

TABLE I
The flash conditions of different cathode materials in a small batch

| | New LCO | New NMC | CW |
|---|---|---|---|
| Reactant component | 90 wt % LCO and 10 | 90 wt % NMC and | 80 wt % NMC and |
| | wt % CB | 10 wt % CB | 20 wt % spent |
| | | | graphite |
| Mass | 200 mg per batch | 200 mg per batch | 150 mg per batch |
| Reaction atmosphere | Ar | Ar | Ar |
| Reactant | 3 | 3 | 3 |
| resistance/ohm | | | |
| Voltage/V | 120 | 120 | 150 |
| Reaction time/ms | 300 | 150 | 300 |
| Capacitance/mF | 60 | 60 | 60 |

TABLE II
The flash conditions of different cathode materials in a large batch

| | New LCO | New NMC | CW |
|---|---|---|---|
| Reactant component | 90 wt % LCO and 10 | 90 wt % NMC and | 80 wt % NMC and |
| | wt % CB | 10 wt % CB | 20 wt % spent |
| | | | graphite |
| Mass | 800 mg per batch | 800 mg per batch | 600 mg per batch |
| Reaction atmosphere | Ar | Ar | Ar |
| Reactant | 3 | 3 | 3 |
| resistance/ohm | | | |
| Voltage/V | 120 | 120 | 150 |
| Reaction time/ms | 300 | 150 | 300 |
| Capacitance/mF | 132 | 132 | 132 |

After the FJH reaction, the reaction was permitted to cool for 3 min whereupon a commercial bar magnet with magnetic field strength 5000 Oe was used to separate the ferromagnetic portion of the flash products. The mass ratio of the ferromagnetic portion was ˜90 wt % and that of the nonmagnetic portion was ˜10 wt %. The remaining ˜10 wt % of flash product which was not captured by the magnet was collected and combined with minor portions from other FJH runs to be re-flashed, and the flash condition was the same as the one used for the primary flash. For the re-flash experiments, the small batch experiments were used as the demonstration. Thereby, ˜60 wt % of re-flashed product can be magnetically recovered.

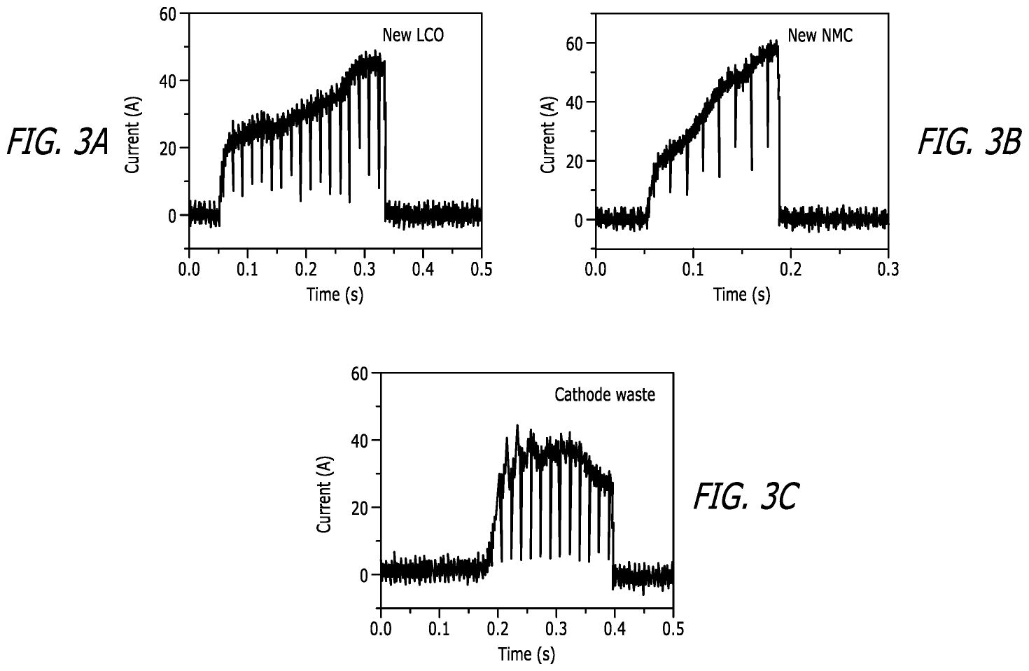

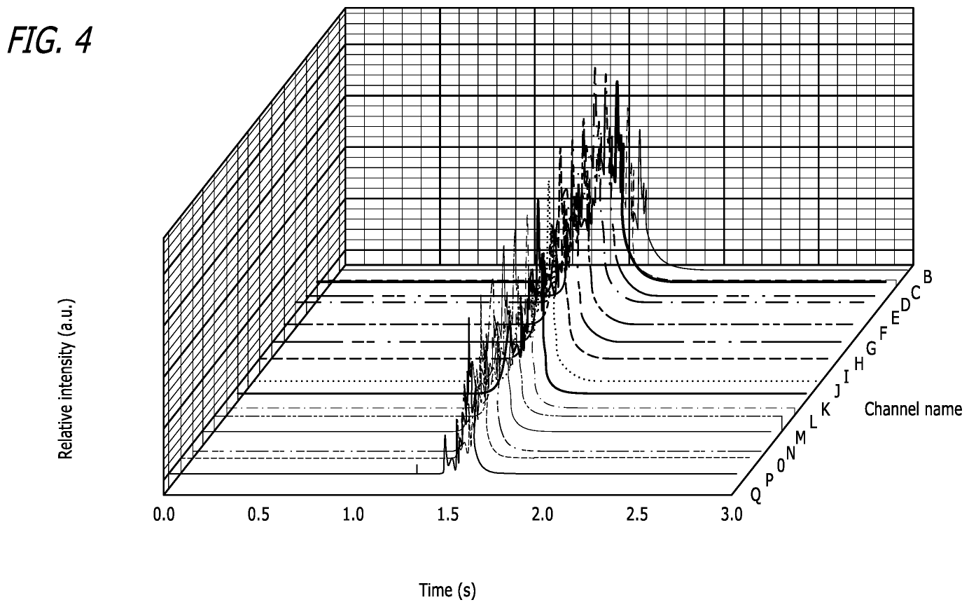

In this flash recycling process, having a voltage of 150 V and a resistance of 3Ω, the current passing through the sample is recorded to reach ˜40 A in ˜300 ms discharge time (FIGS. 3A-3C). The temperature can be measured through a 16-channel optical fiber spectrometer by black-body radiation fitting (FIG. 4). The temperature was estimated to be 2500 K and the ultrafast cooling rate is also recorded at ˜1.2×10⁴ K s⁻¹ (FIG. 1D). While the pyrometallurgical method causes loss of the more volatile Li (FIG. 1B) and irreversible cathode structure collapse [Lv 2018], the momentary high temperature in flash recycling avoids loss of Li and preserves the particle morphology and the cathode 3D layered structure.

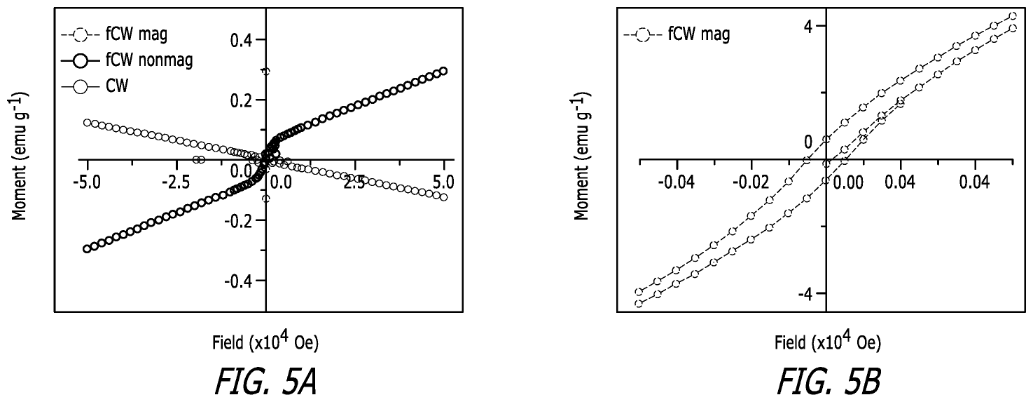

CW from spent LIBs, LCO (LiCoO₂) and NMC (LiNiₓMn_{y}Co_{z}O₂, normally referred as NMCxyz, such as NMC₈₁₁) was tested. The CW was composed of a mixture of LCO and NMC. The flash recycling product included a mixture of the ferromagnetic portion (˜90 wt %) and non-ferromagnetic portion (˜10 wt %) (FIGS. 1A, 1F, and 5A-5B). The ferromagnetic portions of the flash recycled products showed a sharp response to the external magnetic field while the reactants had no ferromagnetic response. This magnetization was strong enough to ensure the effective separation of the ferromagnetic portion by a normal hand-held magnet with magnetic field strength 5000 Oe.

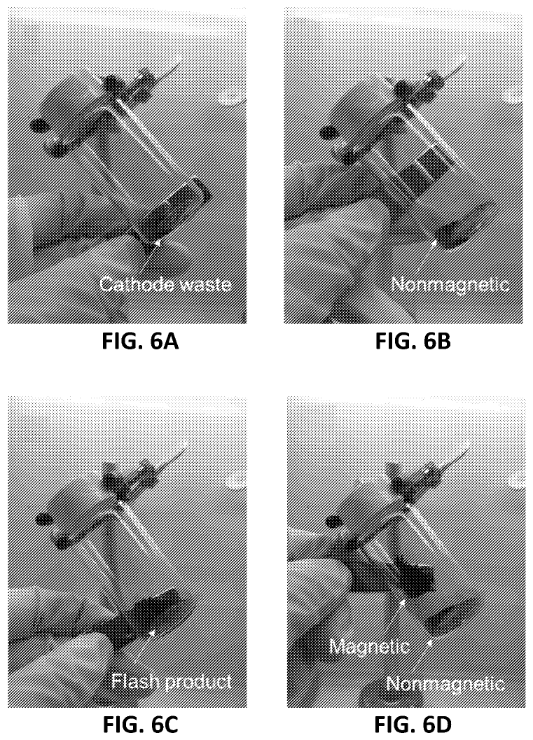

A simple magnet was used to extract the desired ferromagnetic portion (FIGS. 1A and 6A-6D). The extracted ferromagnetic product contained the Li and the transition metals where the Li is intimately associated with the ferromagnetic metals and thereby conveniently extracted with the magnet.

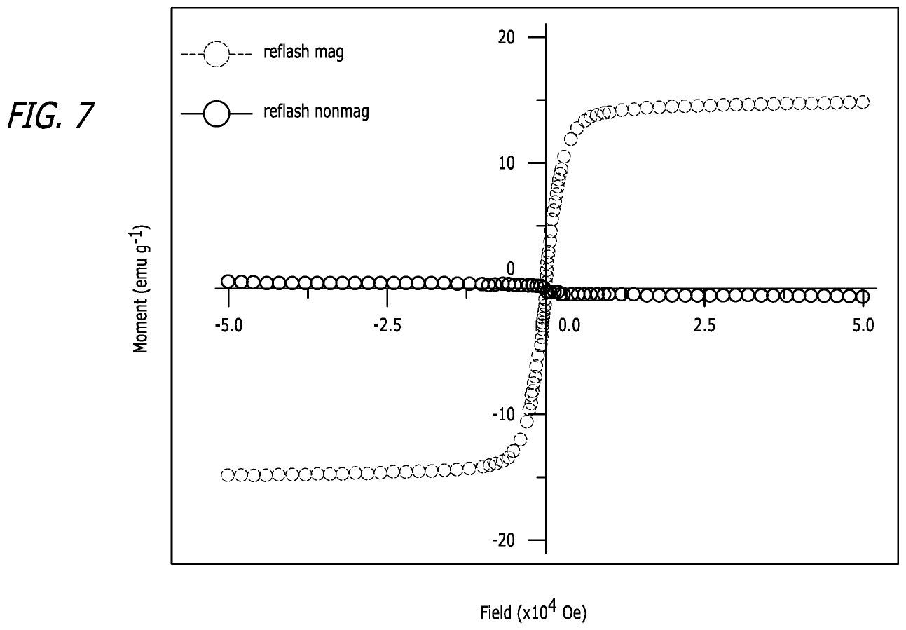

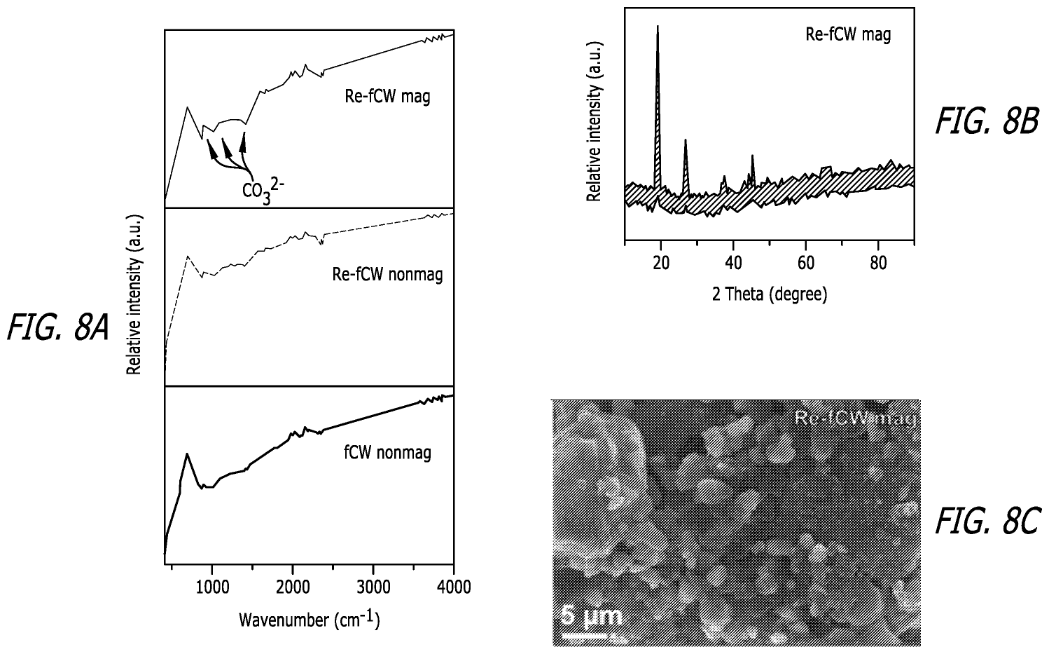

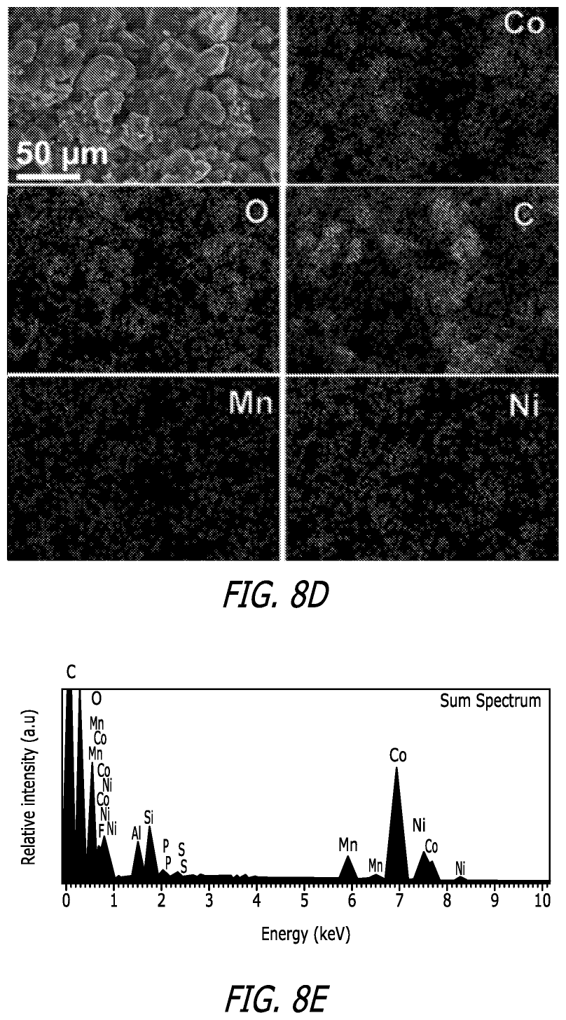

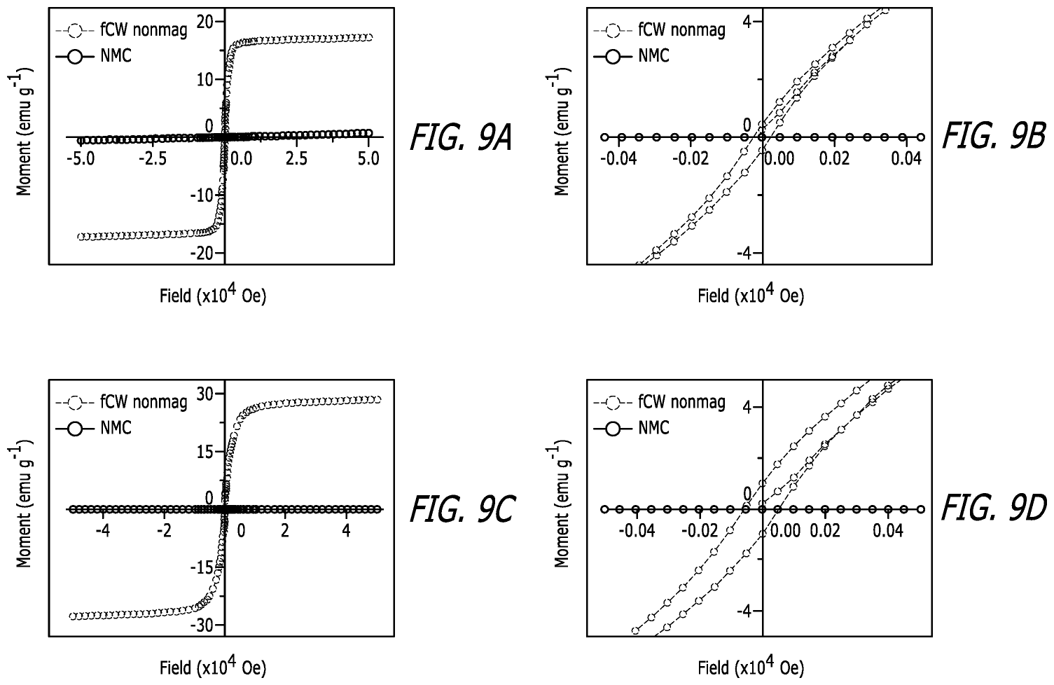

Further, the remaining 10% non-ferromagnetic portion could be re-flashed, as shown in FIGS. 7 and 8A-8E. This process works with LCO, NMC and mixtures thereof (FIGS. 9A-9D), as it is found in commercial CW, recovered from spent LIBs from old laptop computer batteries.

As shown in FIGS. 1F and 5A-5B, the ferromagnetic portion of the flash cathode waste (fCW mag, orange curve) had a sharp response to the external magnetic field (˜10 emu g⁻¹ at 1900 Oe) and the magnetic moment reaches saturation (˜17 emu g⁻¹) at 8000 Oe. This magnetization was strong enough to ensure the effective separation of the ferromagnetic portion by a normal hand-held magnet with magnetic field strength 5000 Oe. The coercivity force, as calculated from FIG. 5B, was small, which indicated that the material's magnetization can easily reverse direction without dissipating significant energy (hysteresis losses). Contrastingly, the fCW nonmag and the intrinsic CW show a weak magnetic response to the external magnetic field, and they are paramagnetic and diamagnetic materials, respectively. Therefore, a normal magnet can be used to capture the ferromagnetic portion of the flash recycled cathode waste to reclaim the metals, Co, Li, Ni, Mn from the spent batteries. Li, though non-magnetic, was captured in the microparticles of the ferromagnetic portion.

With regard to the reflashing of the non-magnetic portion, the remaining ˜10 wt % of flash product which was not captured by the magnet could be combined with minor portions from other FJH runs to be re-flashed, and the flash condition was the same as the one used for flash recycling cathode waste. Thereby, ˜60 wt % of this could be magnetically recovered. And it is similar in behavior to the originally flashed magnetic portion. The ICP-OES results show good recovery yields from the re-flash process, including Li (79%), Co (77%), Ni (73%) and Mn (84%). As a consequence, further use of the remaining 10 wt % of the nonmagnetic portion in the re-flash recycling process can achieve a high recovery yield for all the valuable metals, including Li (92%), Co (93%), Ni (96%) and Mn (98%).

Recovery Efficiency

High recovery yields are essential for an effective recycling strategy. [Xiao I 2017]. Recovery efficiency (α) is defined in Eq. (1).

$$α = \frac{m ( N , flash product )}{m ( N , reactant )} \times 100 \% \qquad ( 1 )$$

The m(N, flash product) and m(N, reactant) represent the weight of studied species N in flash product and reactant, respectively. The amounts are determined by the ICP-OES and calculated by Eq. (2).

$$\frac{m ( N , pro )}{m ( N , reac )} = \frac{C ( N , pro )}{C ( N , rec )} \times \frac{{m}_{1} ( N , pro )}{{m}_{1} ( N , rec )} \times \frac{{m}_{2} ( N , rec )}{{m}_{2} ( N , pro )} \times \frac{{m}_{3} ( N , pro )}{{m}_{3} ( N , rec )} \qquad ( 2 )$$

The C (N, pro) and C(N, rec) represent the mass concentration of M species in the diluted solution of flash product and reactant, respectively. The m₁ (N, pro) and m₁ (N, rec) represent the mass of the diluted solutions for flash product and reactant. The m₂ (N, rec) and m₂ (N, pro) represent the mass of sample used in the ICP-OES experiment. The m₃ (N, rec) and m₃ (N, pro) represent the total mass of sample before the flash reaction and the mass of sample after the magnetic separation, respectively.

The molar ratio (β) is determined in eq. 3.

$$β = \frac{n ( N )}{{n}_{0} ( N )} \times 100 \% \qquad ( 3 )$$

The n(N) and n₀(N) represent the actual amount and theoretical mole of studied species N in cathode materials, respectively. The actual moles are determined by the ICP-OES and calculated by eq. 4.

$$n ( N ) = \frac{c ( N ) \times {m}_{1} ( N ) \times {m}_{3} ( N )}{{m}_{2} ( N ) \times M ( N )} \qquad ( 4 )$$

M(N) represents the molar mass of the species N.

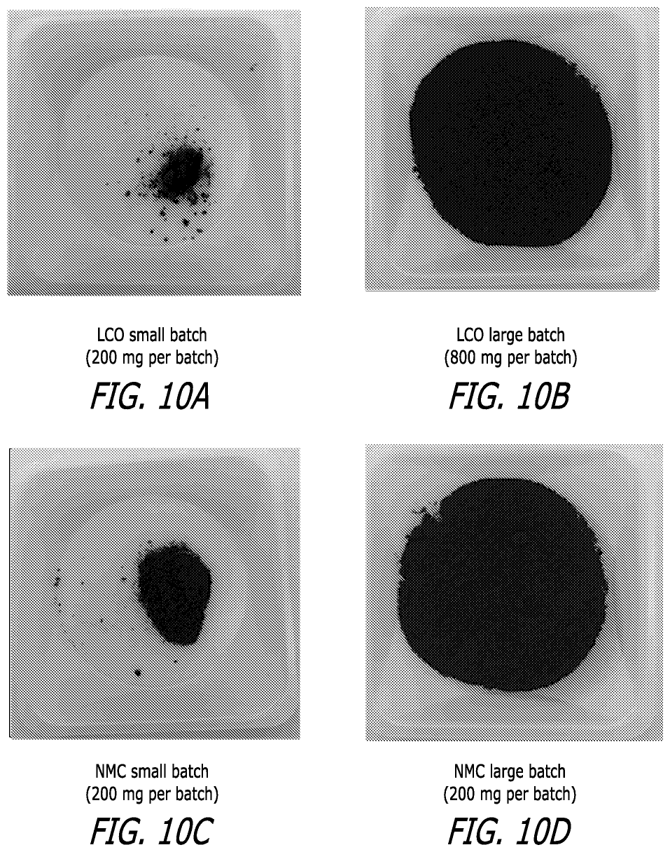

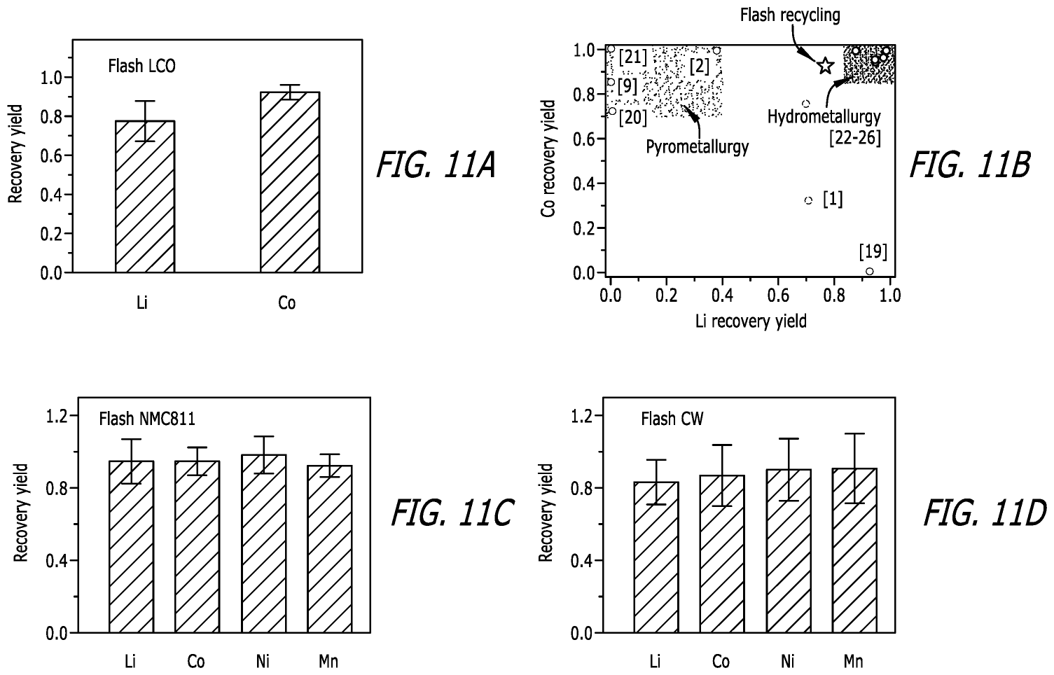

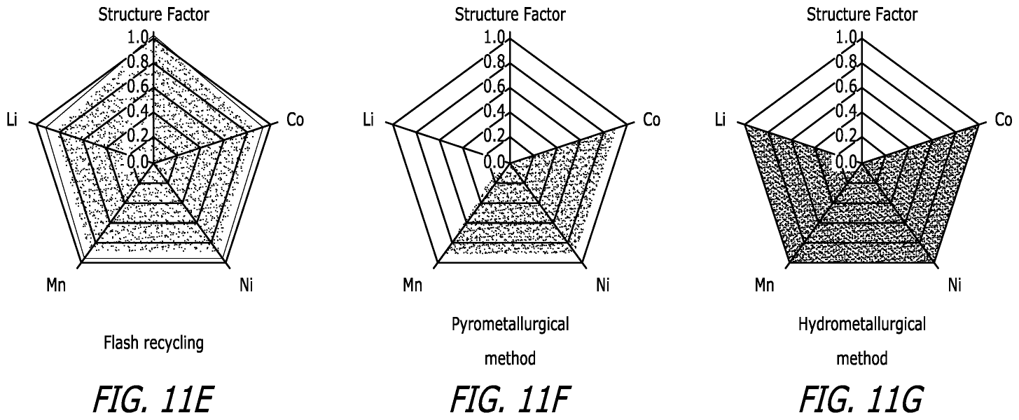

The recovery efficiency from various flash products (FIGS. 10A-10D) are quantified using inductively coupled plasma optical emission spectroscopy (ICP-OES). For flash recycling of LCO, the average yields are 92% for Co and 77% for Li (FIG. 11A) after a single flash. These efficiencies can be improved after re-flashing of the non-ferromagnetic portion, so that the total recovery for Co and Li are 98% and 85%, respectively, after one re-flash. Compared with conventional pyrometallurgical methods, a higher Li recovery yield can be achieved without compromising the yield of Co. [Velázquez 2019; Hu 2021; Xiao II 2017; Wang 2018; Assefi 2020]. These values are also close to the leaching efficiencies of hydrometallurgical methods as shown in the blue region of FIG. 11B and TABLE III, but flash recycling has no generation of the caustic aqueous wastes. [Zhang 1998; Swain 2007; Pinna 2017; Lee 2002; Chen 2015].

TABLE III
The recovery efficiencies of metals by different recycle methods

| | | | Recovery efficiency (%) | | | | |
|---|---|---|---|---|---|---|---|
| Method | Materials | Details | Li | Co | Mn | Ni | Ref |
| Pyro | Spent LIB | 1200~1450° C. (2~6 h) | — | ~85 | | | Velázquez |
| | | | | | | | 2019 |
| | Spent LIB | 1600° C. (3 h) | ~100¹ | ~100 | ~100 | ~100 | Hu 2021 |
| | (NMC | 700° C. (0.5 h), vacuum | ~66 | / | / | / | Xiao 2017 |
| | type) | condition | | | | | |
| | Spent LIB | 700° C. (0.5 h), vacuum | ~83 | / | — | — | Xiao 2017 |
| | (LCO type) | condition | | | | | |
| | | 600° C (0.5 h) | ~1 | ~73 | — | — | Wang |
| | | | | | | | 2018 |
| | | 1200~1450° C. (2~6 h) | 38 | 99 | | | Lv 2018 |
| Hydro | Spent LIB | 4M HCl, 80° C for 1 h | 99 | 99 | — | — | Zhang |
| | (LCO type) | | | | | | 1998 |
| | | 2M H₂SO₄ + 5 Vol % | 95 | 94 | — | — | Swain |
| | | H₂O₂, 75° C for 0.5 h | | | | | 2007 |
| | | 2% H₂SO₄ + 2 Vol % | 88 | 99 | — | — | Pinna |
| | | H₂O₂, 90° C. for 1 h | | | | | 2017 |
| | | 1M HNO₃ + 1.7 Vol % | 95 | 95 | — | — | Lee 2002 |
| | | H₂O₂, 75° C for 1 h | | | | | |
| | | 2M citric acid + 0.6 g | 98 | 96 | — | — | Chen |
| | | H₂O₂/g solid, 70° C for | | | | | 2015 |
| | | ~1.5 h | | | | | |
| | Spent LIB | 1.5M lactic acid, ~0.5 h | 98 | 99 | 98 | 98 | Li 2017 |
| | (NMC | | | | | | |
| | type) | | | | | | |
| Others | New LCO | choline chloride and | / | 94 | — | — | Tran 2019 |
| | | ethylene glycol | | | | | |
| | New NMC | choline chloride and | ~36 | ~71 | / | / | Tran 2019 |
| | | ethylene glycol | | | | | |
| FJH | new LCO | Voltage 120 V (300 ms) | 77² | 92² | — | — | Herein |
| method | | | 85³ | 98³ | | | |
| | new NMC | Voltage 120 V (150 ms) | 94 | 94 | 92 | 98 | Herein |
| | Spent LIB | Voltage 150 V (300 ms) | 83² | 86² | 90² | 89² | Herein |
| | (mix LCO | | 92³ | 93³ | 98³ | 96³ | |
| | and NMC) | | | | | | |

Notes:
¹= The Li source was from the flue dust which was needed to be collected from a cone-shape stainless steel cover placed at the outlet of the furnace.
²= The recovery yields by one flash experiment
³= The total recovery yields, including the yields from the re-flash experiment
/= Not mentioned in the literature reference.
—= ~ 0%

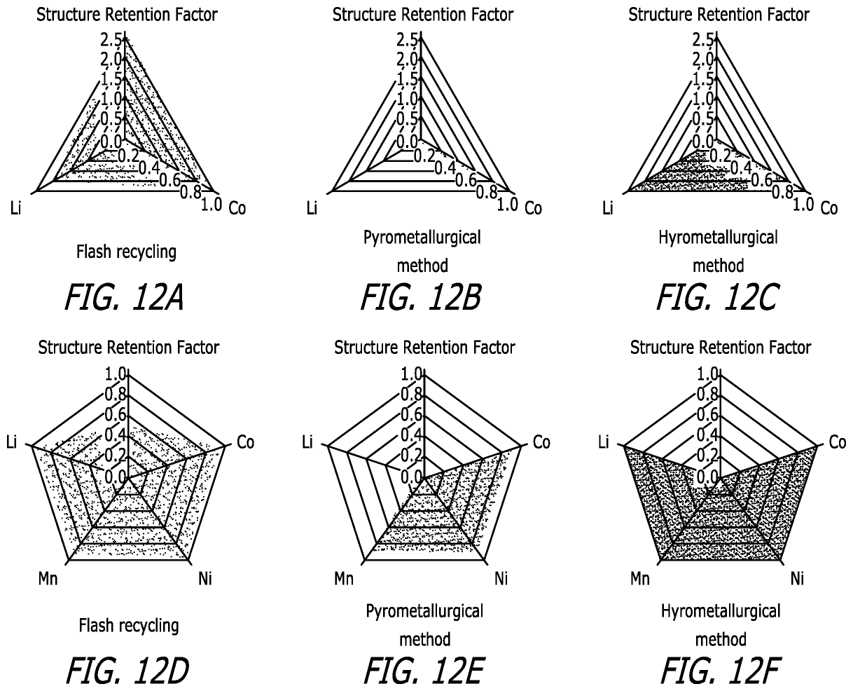

The same tendencies can be found in flash NMC (fNMC) and actual CW with mixed ingredients obtained from spent LIBs. A single flash of NMC affords high average recovery yields for all the valuable metals (FIG. 11C), including Li (94%), Co (94%), Ni (98%) and Mn (92%). High average recovery yields are also achieved in flash CW (fCW, FIG. 11D), including Li (92%), Co (93%), Ni (96%) and Mn (98%). Radar plots (FIGS. 11E-11G and 12A-12F) compare the metal recovery of the flash method with typical efficiencies found in the pyrometallurgical and hydrometallurgical methods.

Structure Retention Factor (R)

The structure retention factor is defined as the existing 3D layered cathode structure after the recycling method. The structure retention factor is only present in the flash recycling. It highlights the retention of the particle morphology and crystalline structure after the flash process, which can be quantified by X-ray diffraction (XRD).

Structure retention factor (R) is defined in Eq. (5).

$$R = \frac{I ( 003 ) / I ( 104 )}{{I}_{0} ( 003 ) / {I}_{0} ( 104 )} \times 100 \% \qquad ( 5 )$$

The 1(003) and 4104) represent the intensity of (003) and (104) peaks in the XRD spectrum. I₀ and I represent the peak intensity of the reactants and products derived from different recycling processes. In the XRD results, (003) peaks indicate the property of layered structure in lithiated metal oxides, and (104) peaks reflect the property of transition metal-oxygen bond basic units which forms the layered compounds. The intensity ratio between (003) and (104) peaks indicate the efficiency of crystallization. The lower value of 1(003)/1(104) reflects the cation mixing between transition metal and lithium and generally a decomposition of the layered character.
(1) R=0, when the layered structure disappears
(2) 0<R<1, when the crystallinity degrades while the layered structure is preserved.
(3) R≥1, when the crystallinity improves, and the layered structure is preserved.

For the hydrometallurgical and pyrometallurgical methods, the layered structure of cathode waste materials no longer exists, and R=0. On the contrary, the flash recycling method can preserve the structure and R=3.29/3.22=1.02. This value reflects the layered structure was preserved while the crystallinity did not degrade during the flash recycling method.

Hierarchical Structure of The Microparticles of Cathode Materials

The efficiency of the flash recycling process on the cathode materials was determined by analyzing the subsurface region and bulk crystal structure of the ferromagnetic portion by elemental depth analysis and XRD, respectively. [Andre 2015]. Distinct elemental ratios and valence states from the surface to the subsurface revealed the hierarchical structure of the cathode microparticles derived from flash recycling process.

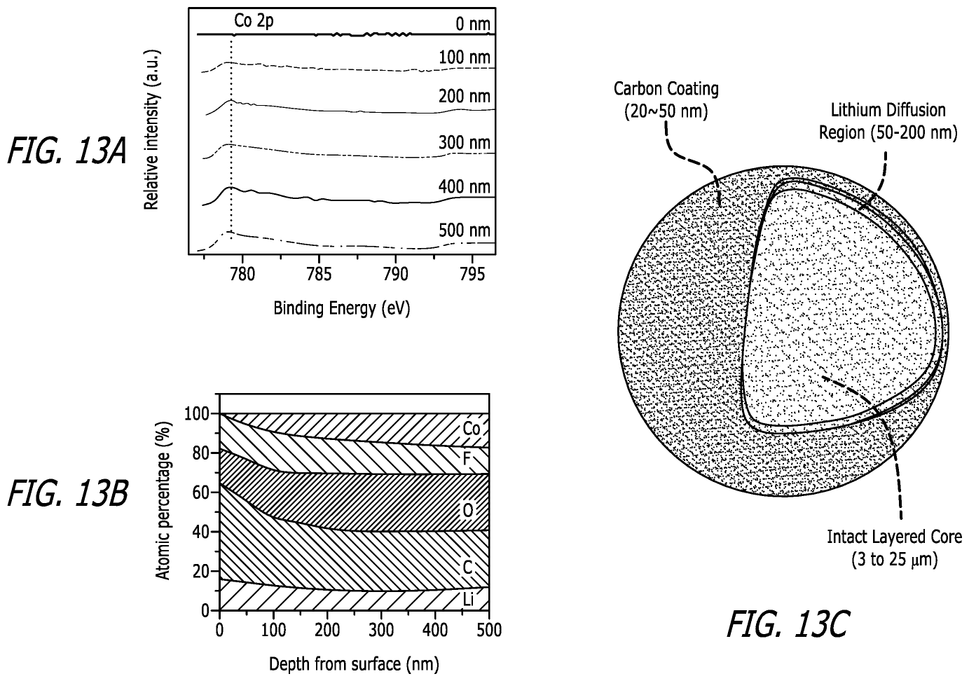

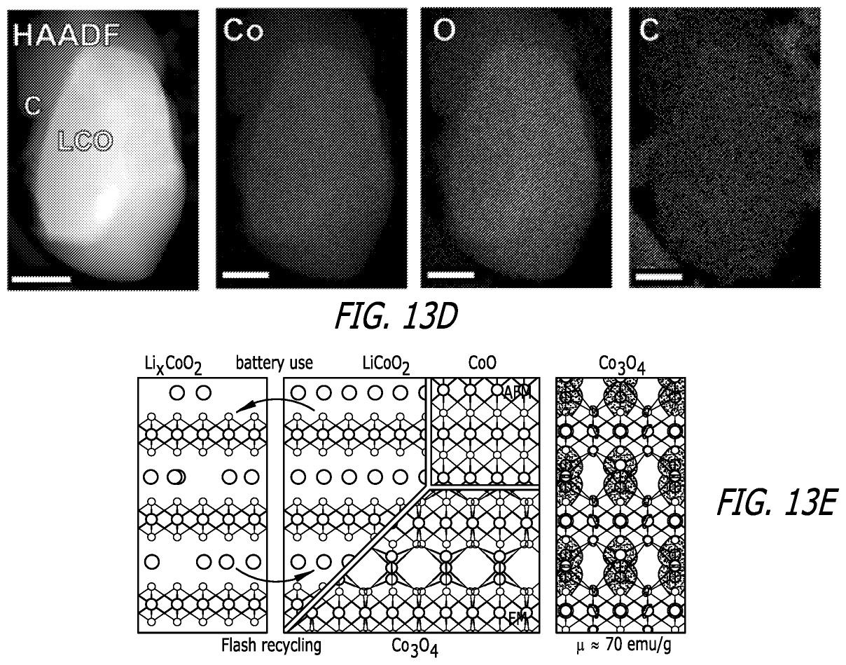

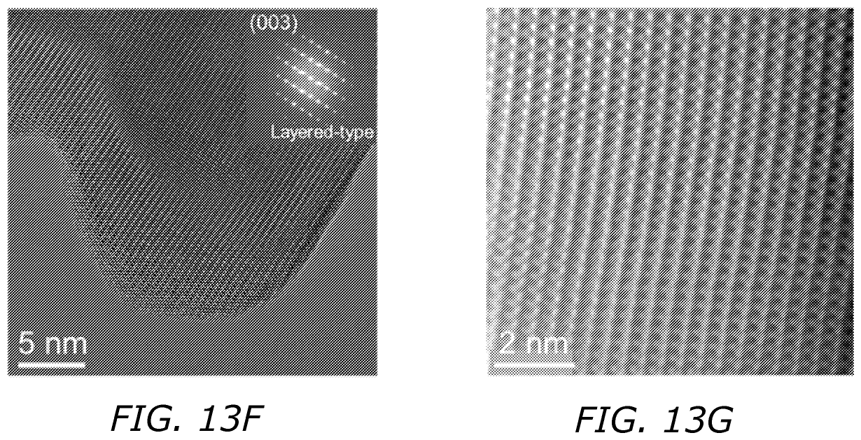

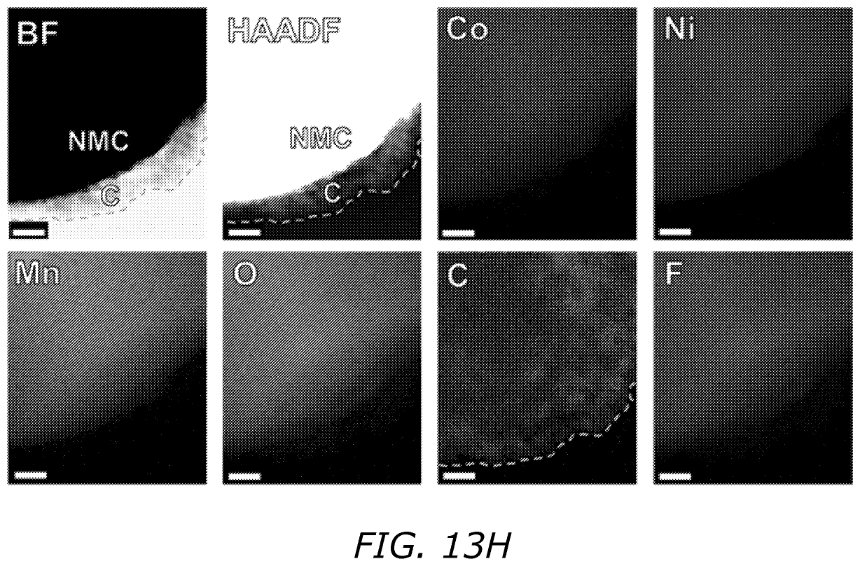

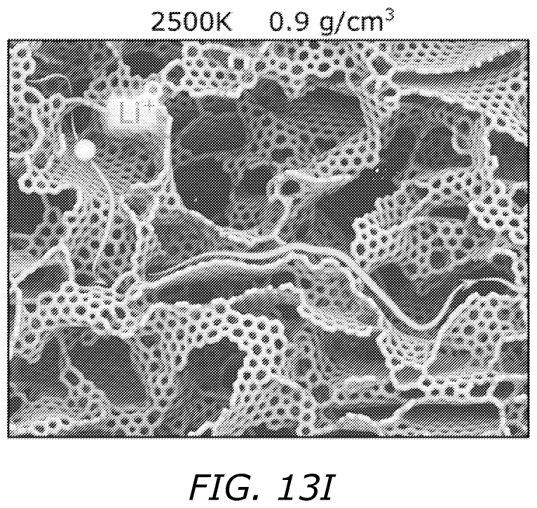

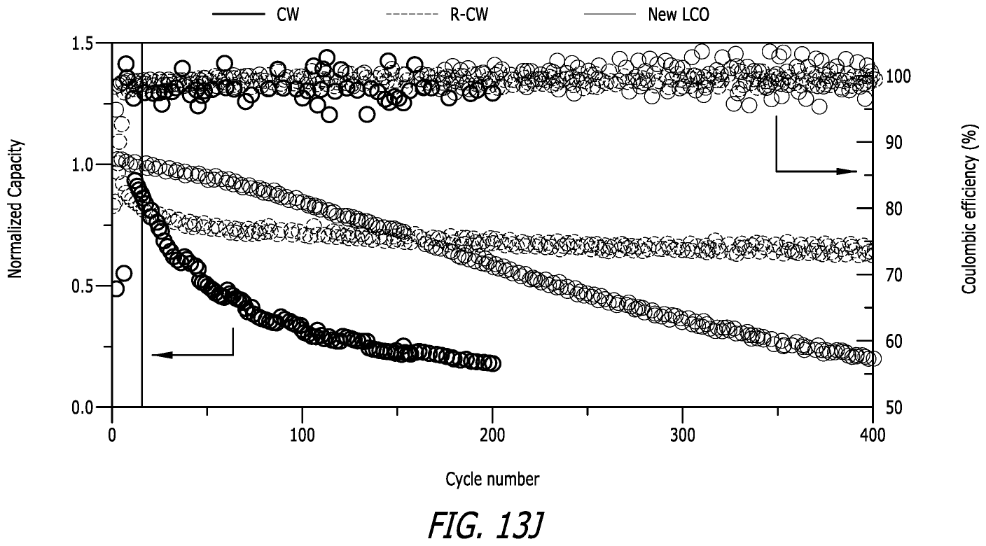

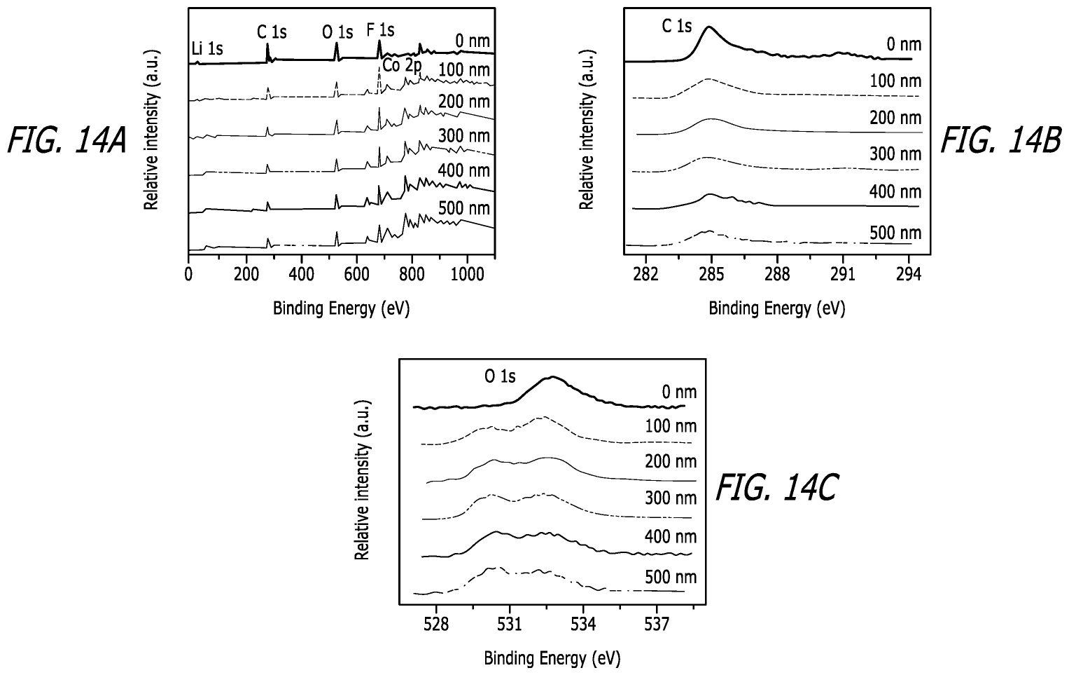

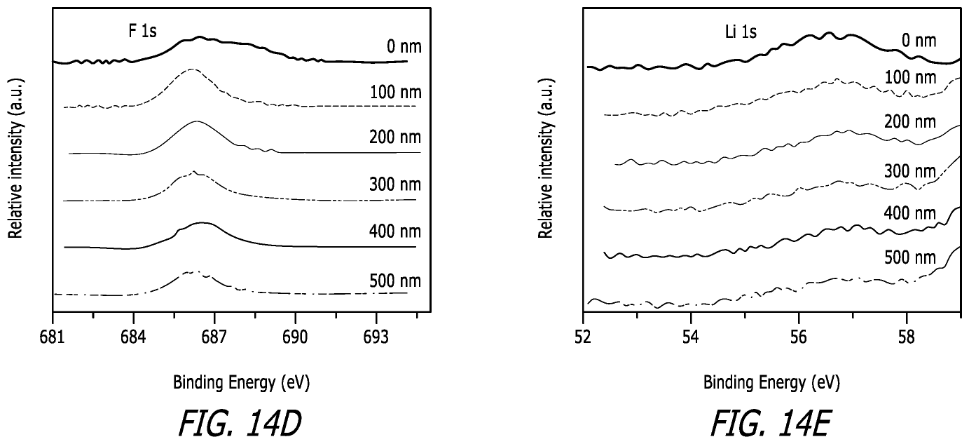

For fCW, the atomic ratio of Co increases dramatically from <1% to ˜20% when processing from the surface to 500 nm depth, and the binding energy downshifts from 782.2 eV at the surface to 779.3 eV (below 200 nm, FIGS. 13A-13B), while the carbon content decreases in the corresponding region (FIG. 13B). The splitting of the O is spectra to O_{α} (532.6 eV) and O_{β} (530.3 eV), show a transition from adsorbed oxygen species to lattice oxygen species (FIGS. 14A-14E). [Chen 2015].

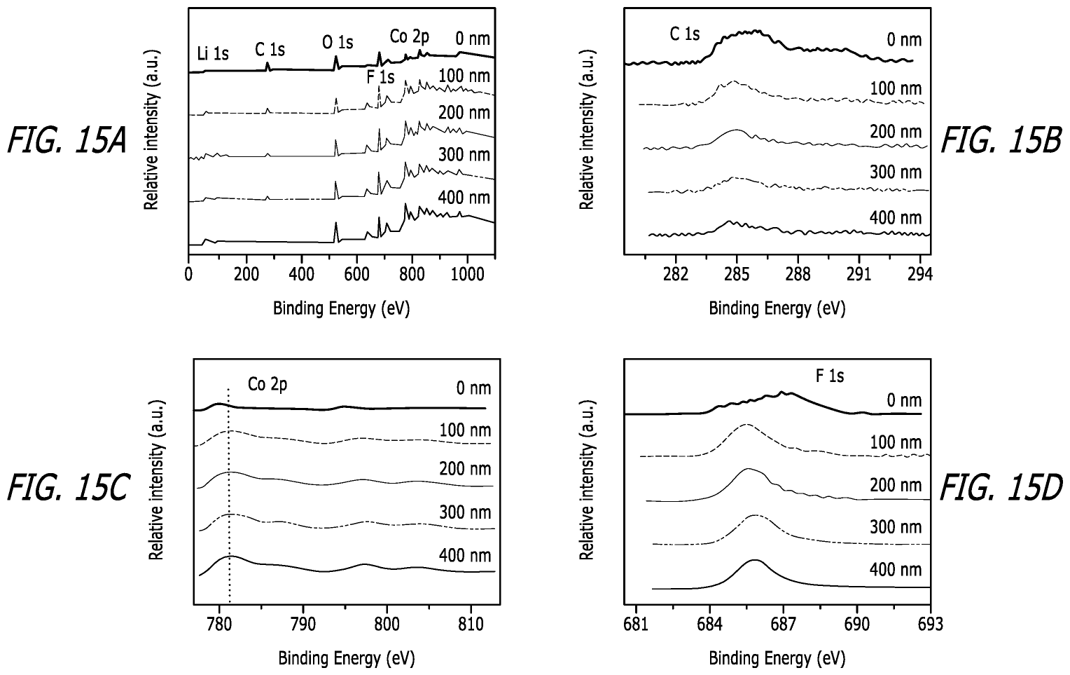

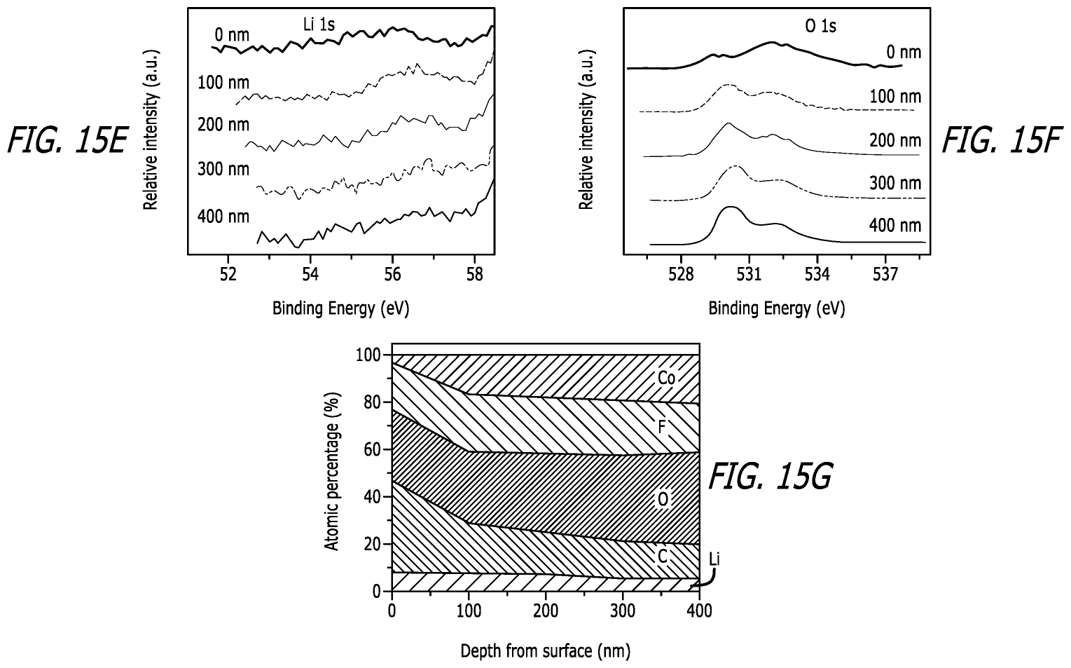

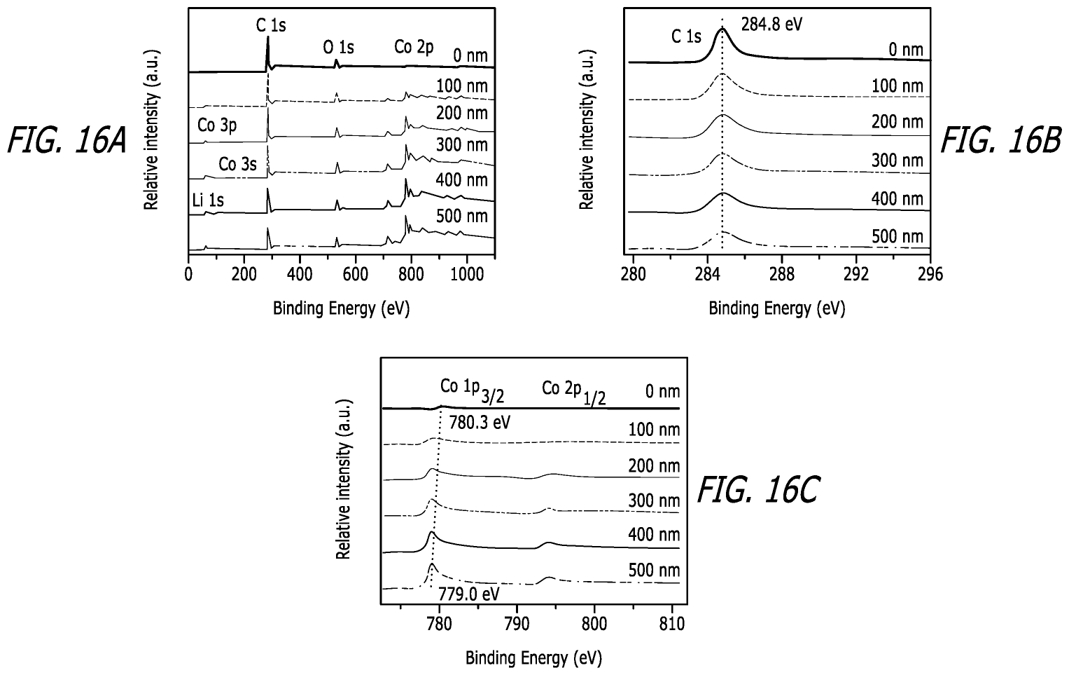

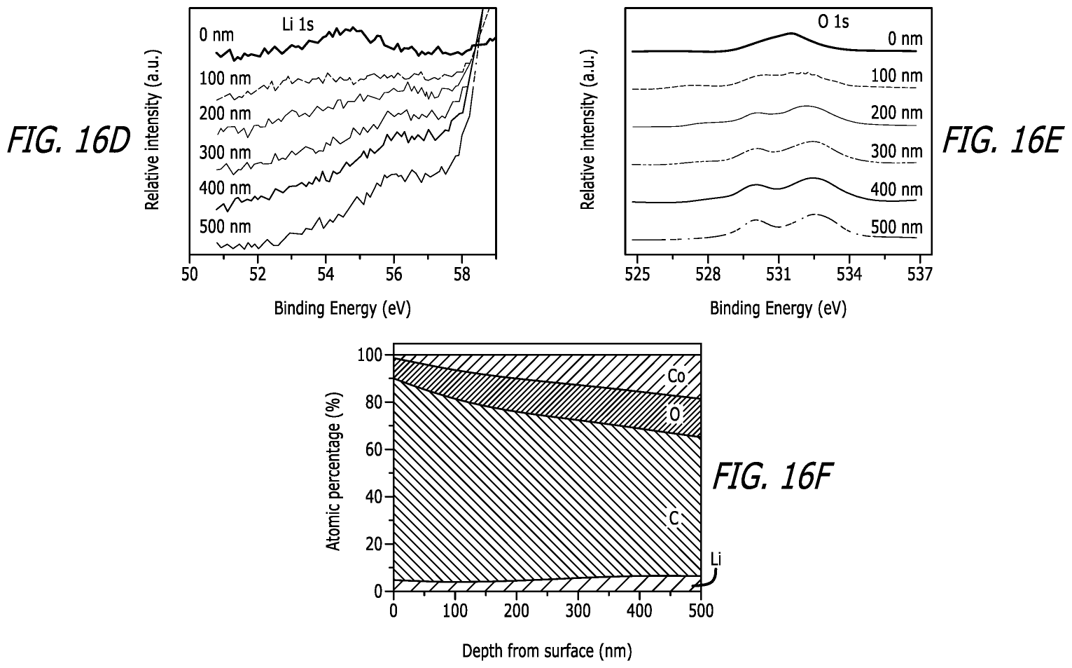

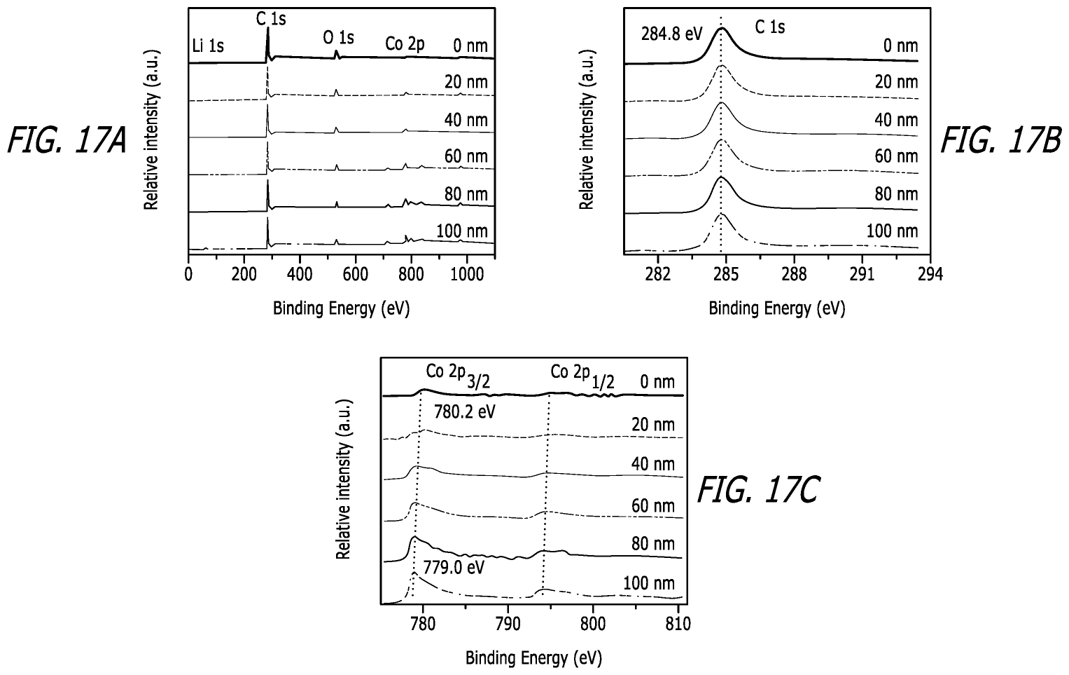

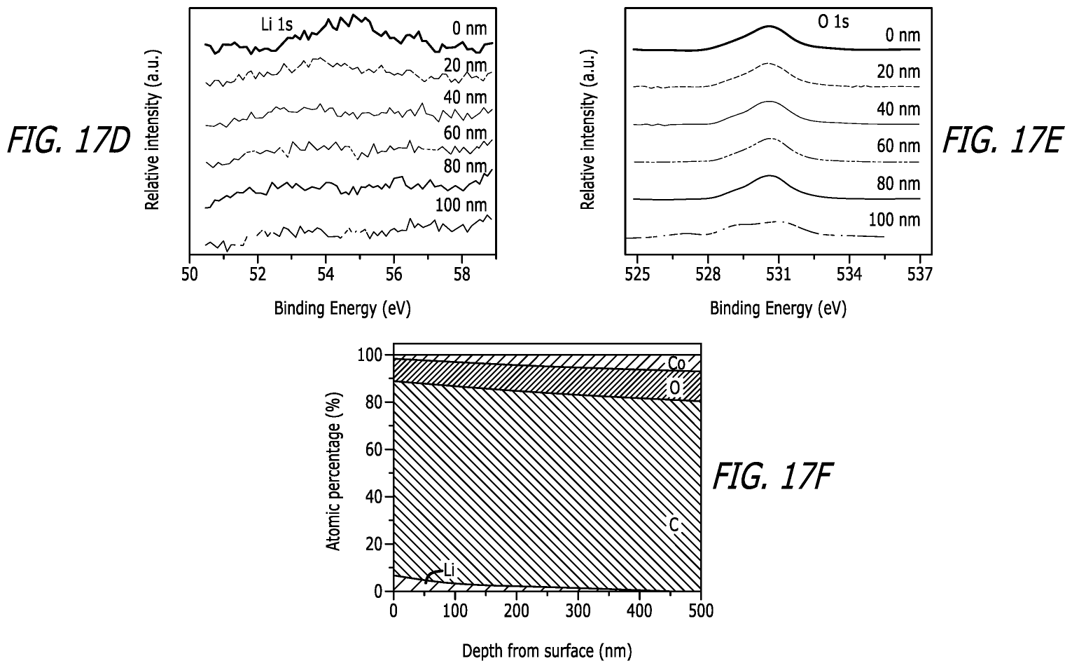

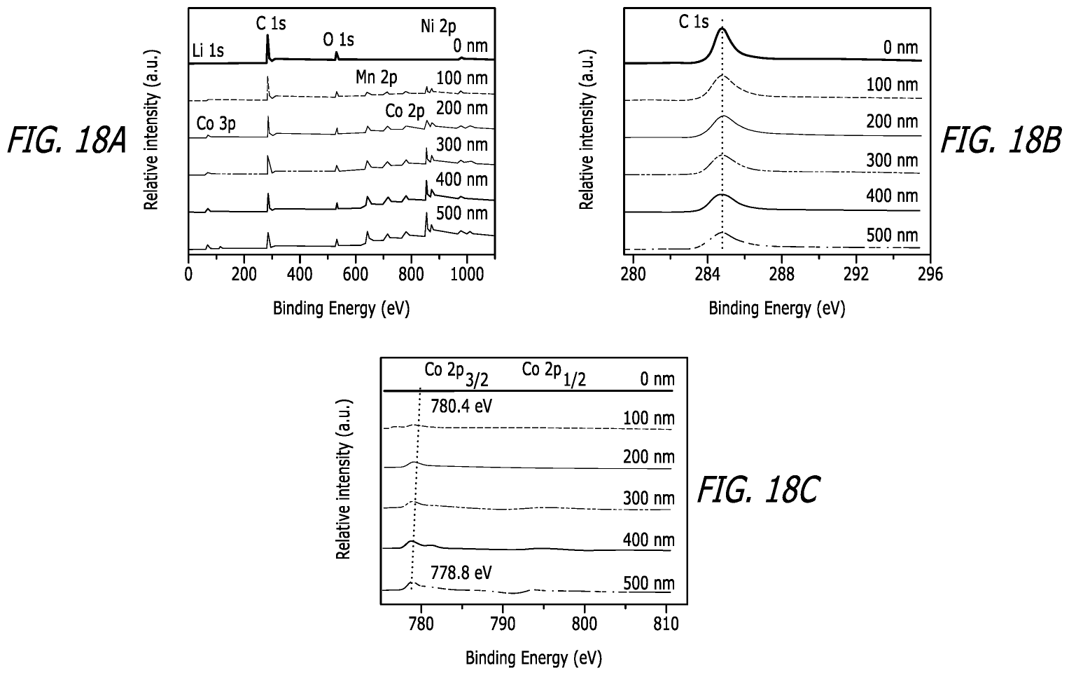

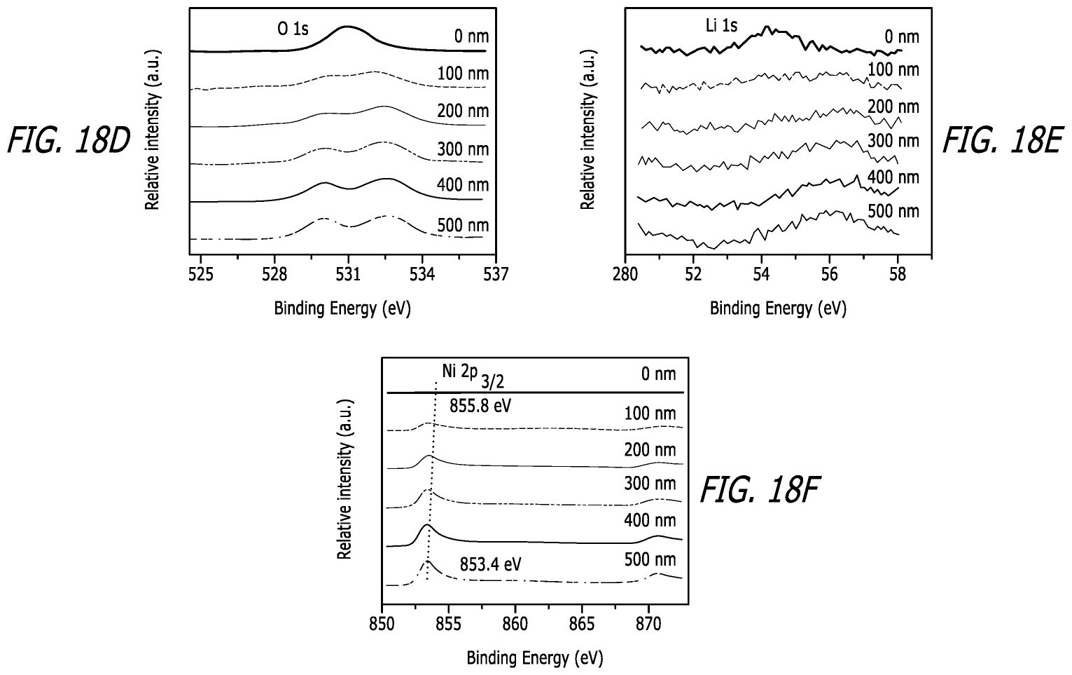

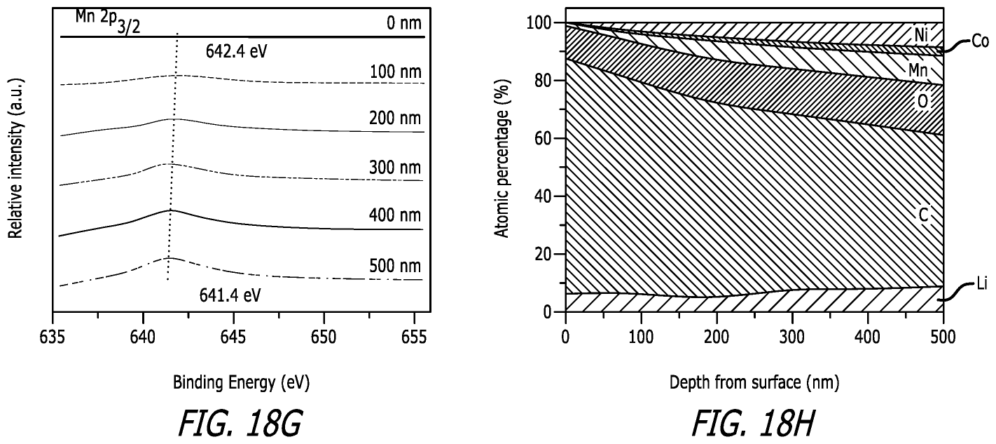

Combined with the unchanged binding energy of Co 2p spectra below 200 nm, this confirmed the existence of intact lithiated metal oxides in this region (FIG. 13C). On the contrary, the unflashed CW had no significant change of binding energies or elemental contents below the solid electrolyte interface that had formed during battery cycling process (FIGS. 15A-15G). This result confirms that there is a hierarchical structure of cathode microparticles formed due to the flash recycling process. The similar topological structures are found in flash recycled LCO and NMC (FIGS. 16A-16F, 17A-17F, 18A-18H, and 19A-19H), which showed the wide applicability of the flash recycling method to treat different cathode materials.

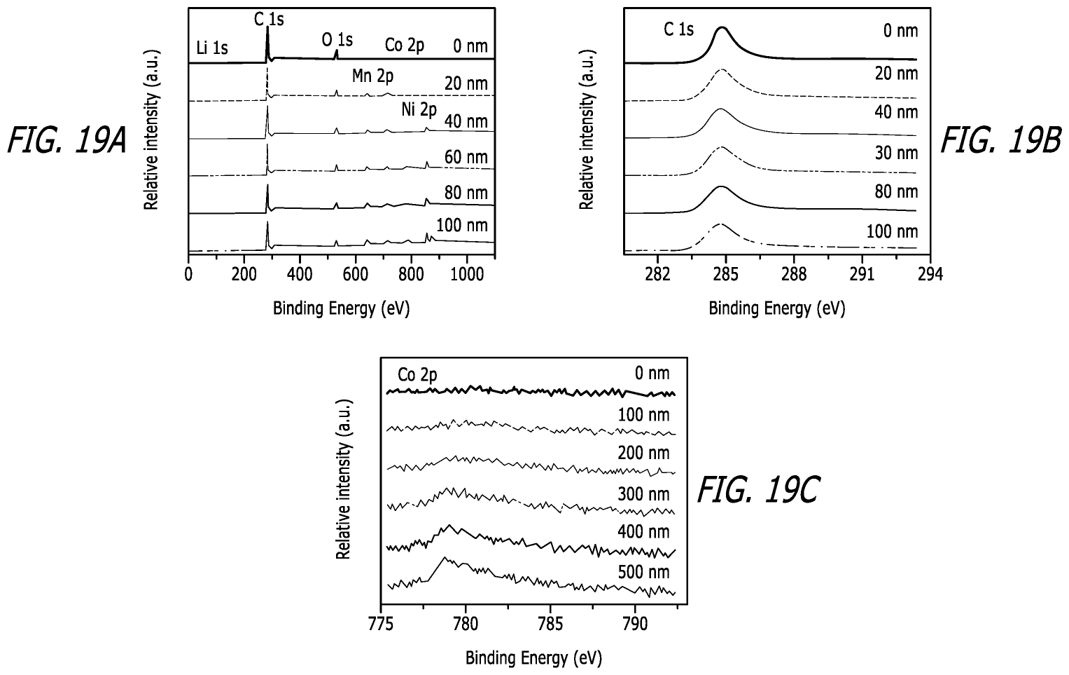

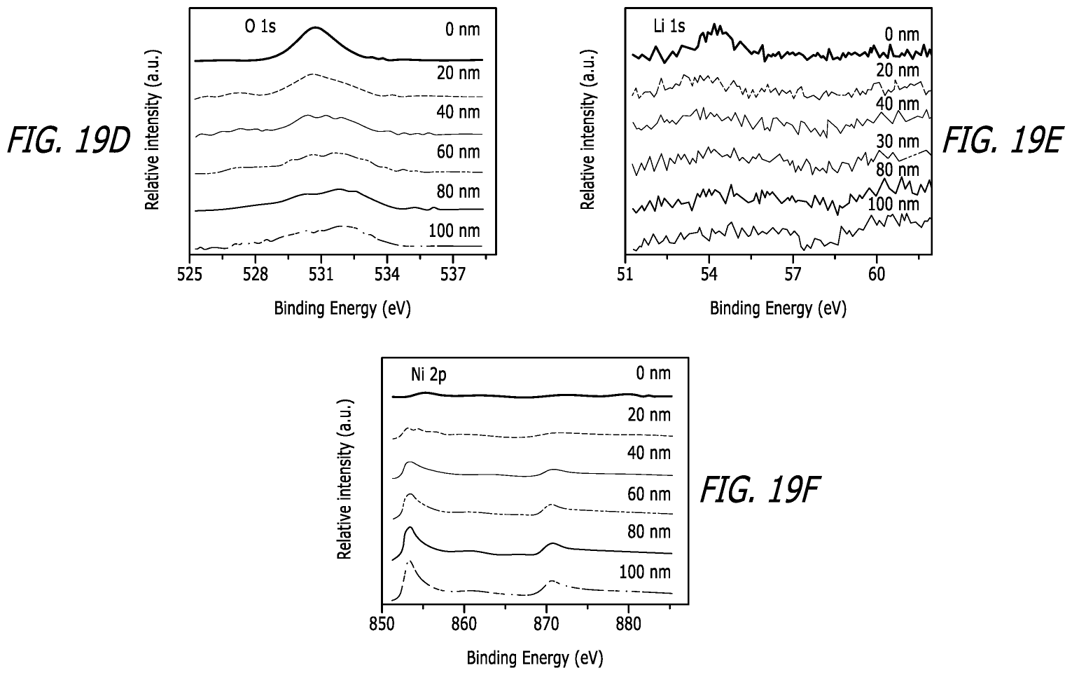

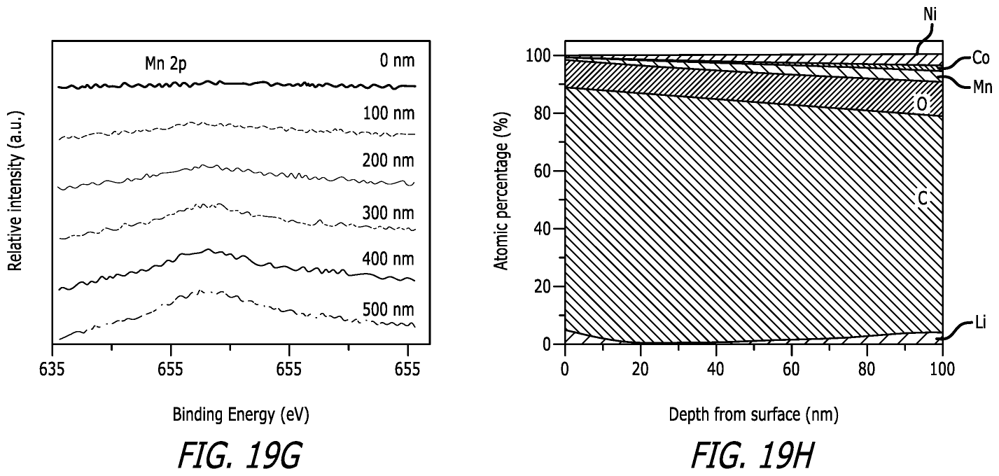

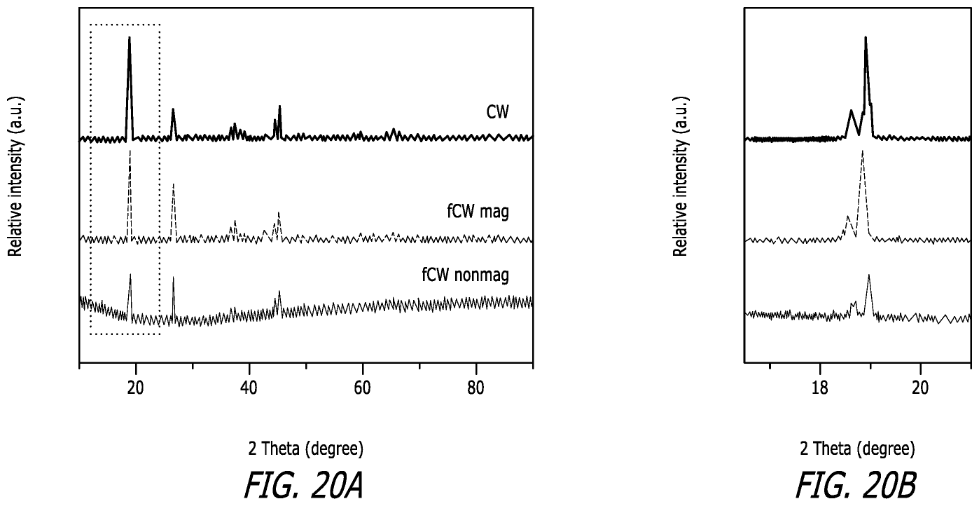

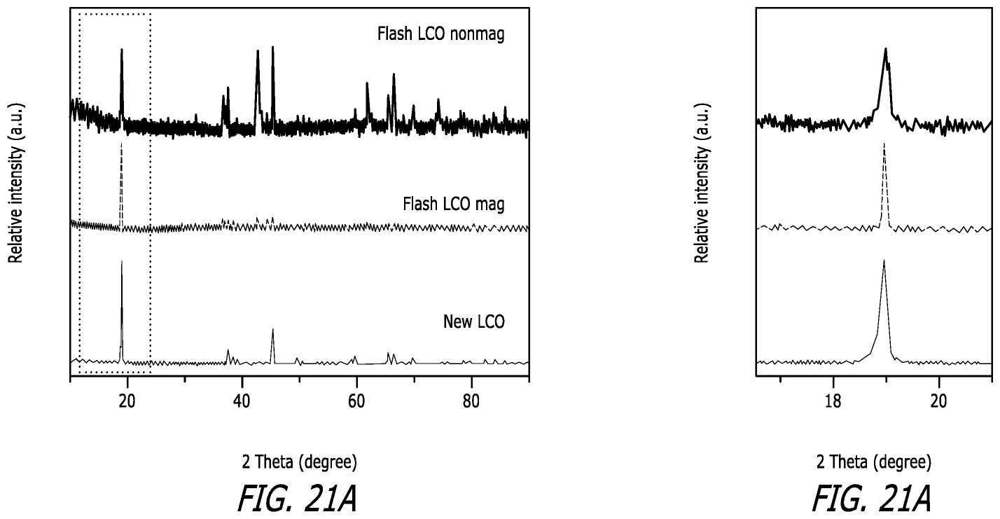

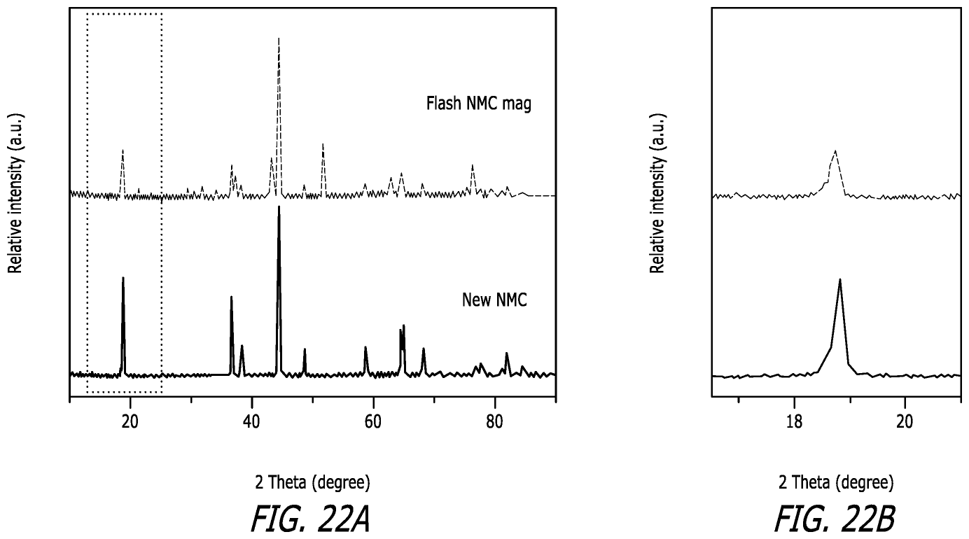

The layered structure of the magnetic portion of flash recycled CW is further corroborated by the (003) diffraction peaks at ˜18.9° [Dai 2019], while the nonmagnetic portion is mainly composed of the graphite conductive additive with some residual metal signals (FIGS. 20A-20B). Similarly, there are intact layered structures in flash LCO (fLCO) and fNMC (FIGS. 21A-21B and 19A-19B). The appearance of magnetic properties in the fCW underscores one pertinent aspect of the flash method. The localized rapid heating and cooling maintain the integrity of the particle, while triggering a thermal decomposition limited to the surface only. This process affects the CEI, cathode surface, carbon coating and the ability to resynthesize the new cathode.

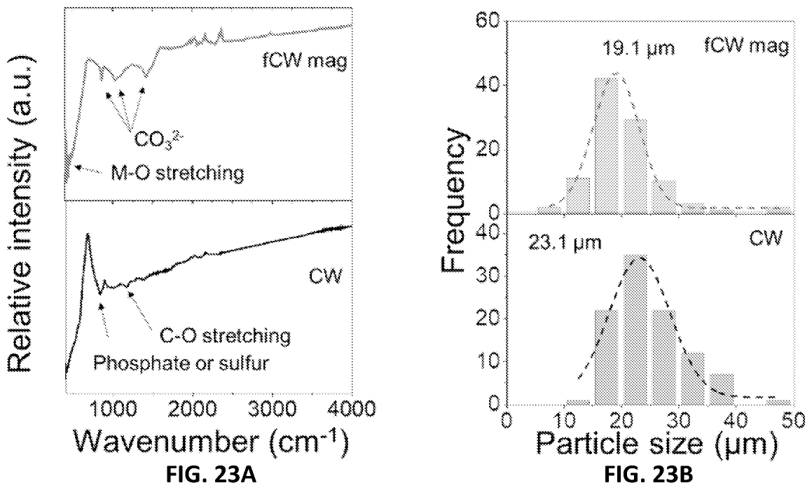

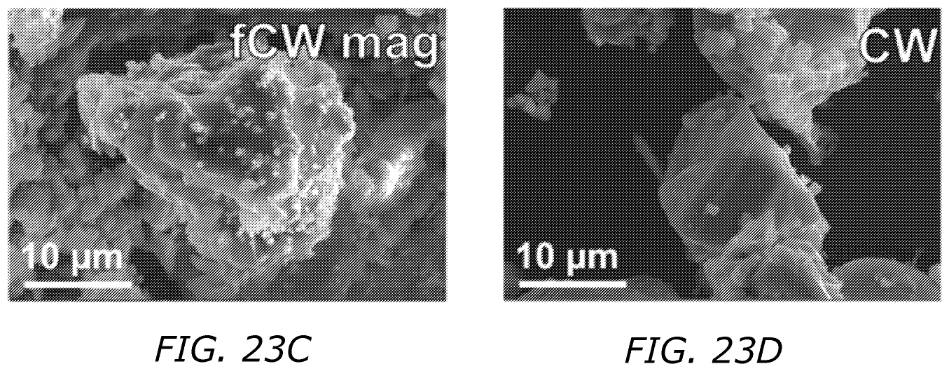

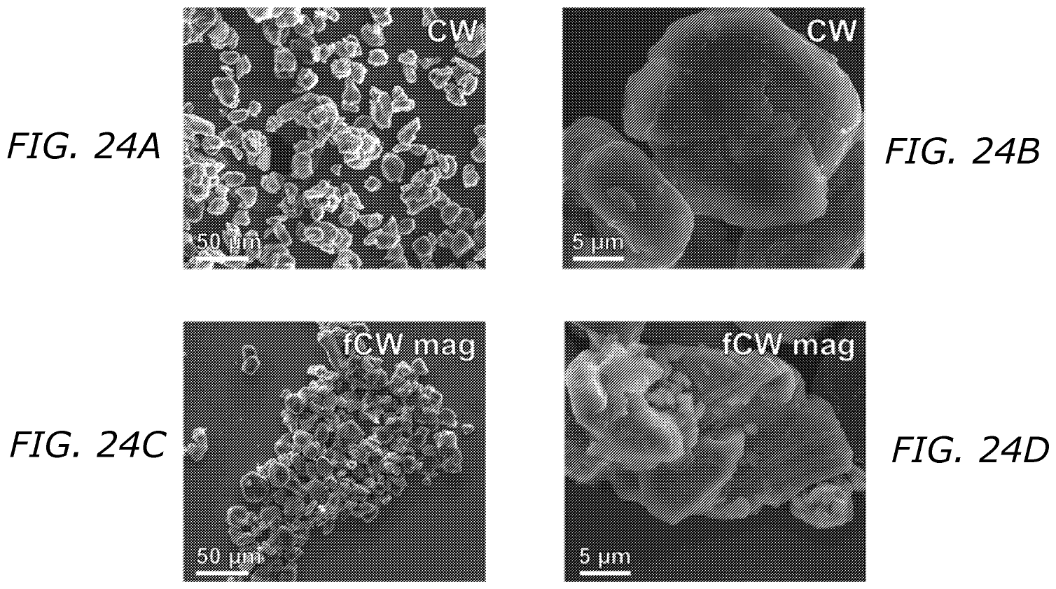

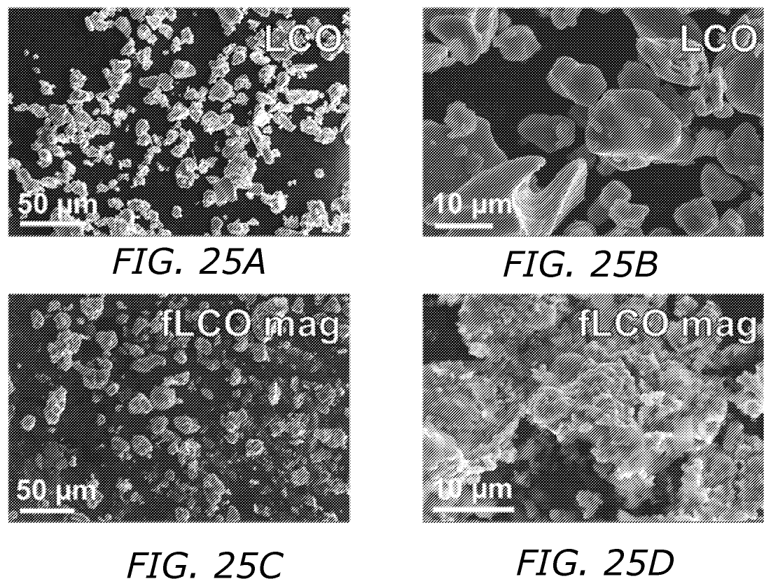

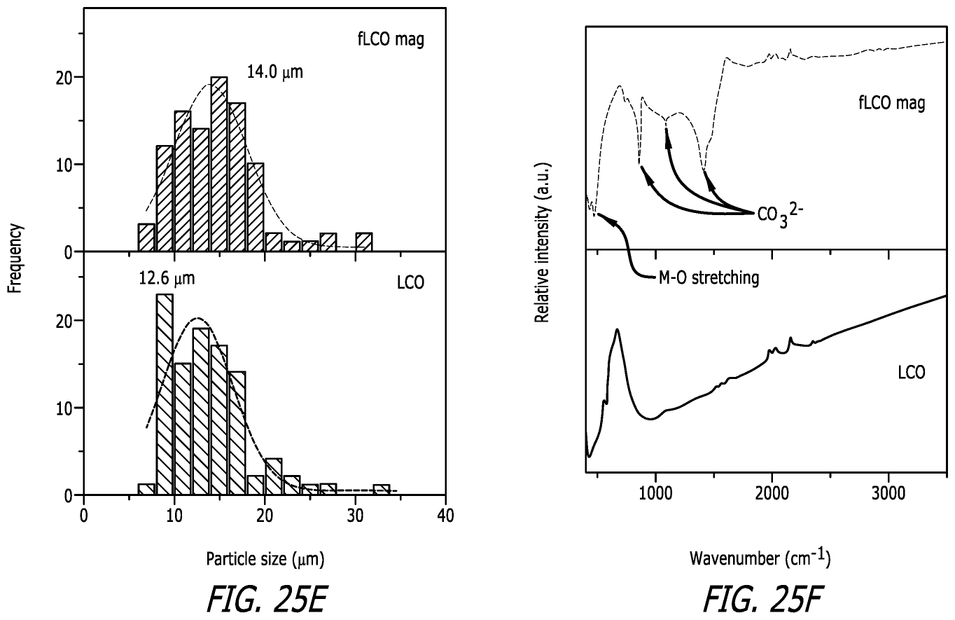

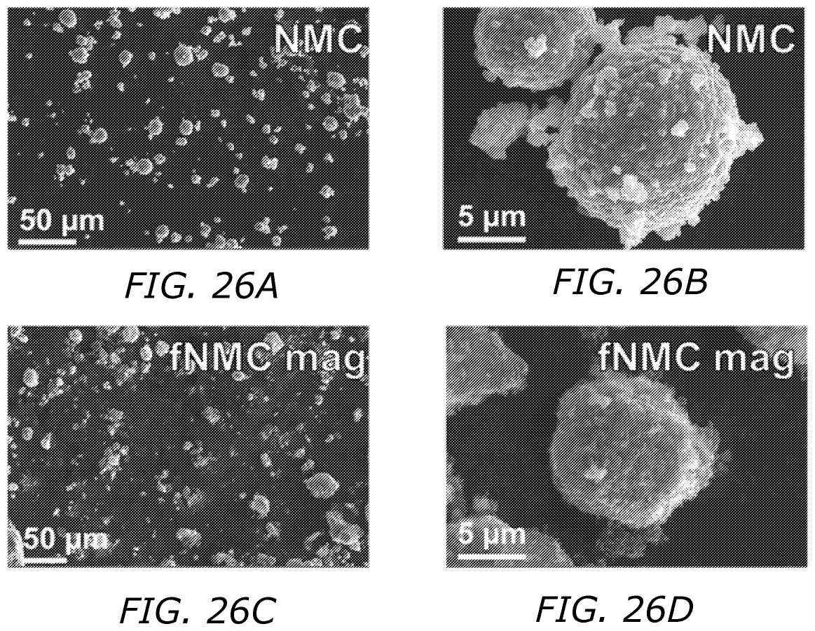

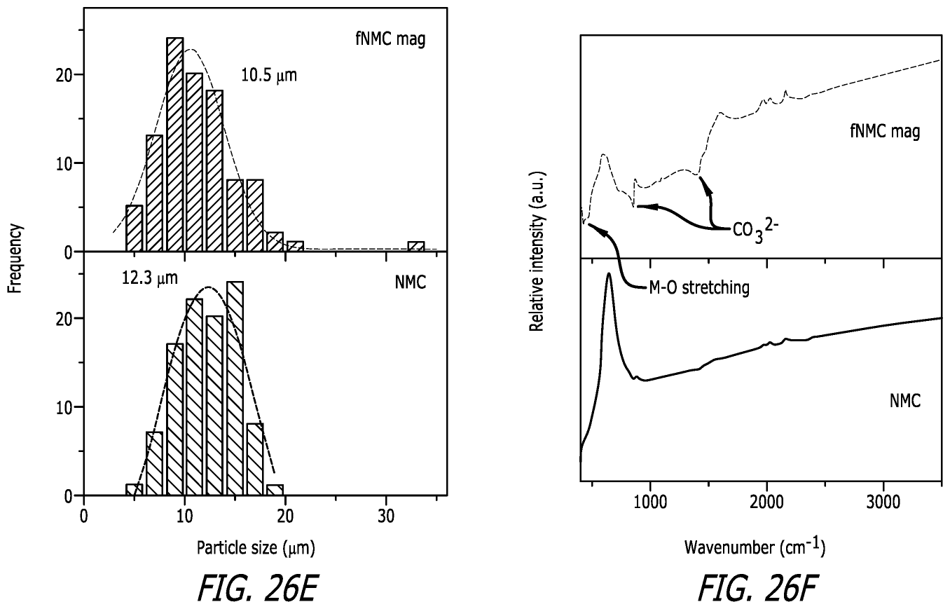

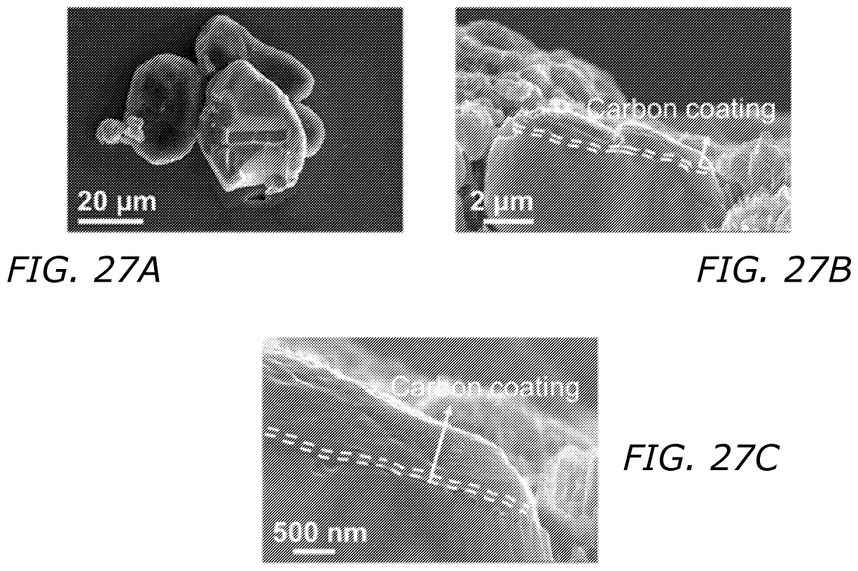

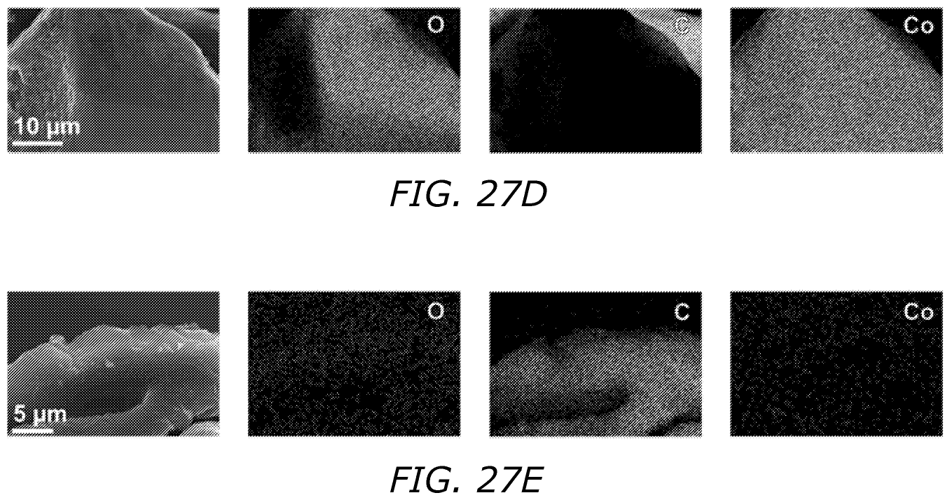

The CEI is decomposed into salts coating the particles. The existence of the carbonate can be confirmed by the stretching mode of CO₃²⁻ in the FTIR spectrum (FIGS. 23A-23D, 24A-24D, 25A-25F, and 26A-26F) and the high binding energy in the XPS C is spectra. [Li 2019]. The carbon existing in the electrode is also re-arranged at high temperature on the surface of the particles as a thin coating, as evidenced by elemental mapping (FIG. 13D). The carbon thickness is 20 to 50 nm, distinguished by focused ion beam milling combined with SEM images (FIGS. 27A-27E) and the elemental depth analysis as shown in XPS results (FIGS. 14A-14E). As shown in FIGS. 27D-27E, the elements Co and O are concentrated at the cross-section without the presence of C, while the top surface shows the existence of the C and the absence of Co and O. This shows that the carbon coating on the surface of ferromagnetic fCW particles and that the thickness is 20˜50 nm estimated from the cross-section SEM images and XPS depth analysis. The carbon coating is derived from the flash reaction between the cathode particles and conductive carbon additives. During the flash reaction, happening in 10 to 30 ms, the hot spots form only at the interfaces between conductive carbon and the insulating cathode materials. These hot spots cause the formation of the thin carbon coating (20˜50 nm) on the cathode particles and the formation of the subsurface metal oxide (˜200 nm) after Li⁺ diffusion towards the interface, without the irreversible layered structure collapse.

The cathode surface reactions can be particularly important. The flash induces the generation of a metal oxide film from two sources, rearrangement and decomposition. The flash process thermally decomposes the particle surface, with release of O₂ and de-lithiation. This surface modification leads to the formation of Co′ containing species at the surface, such as Co₃O₄ and CoO, with enhanced magnetic susceptibility compared to the lithiated species. [Sharifi 2017]. It has been shown that in aged cathodes, this process can happen at temperatures lower than 300° C. [Furushima 2011]. Oxides can also be formed naturally as part of the cycling and can be rearranged by the flash process. As a result of repeated cycles of charge/discharge, the surface of CW particles is composed of areas of crystalline LiCoO₂, partially delithiated LixCoO₂, and small inclusions of the Co₃O₄ and CoO phases. [Kabir 2017].

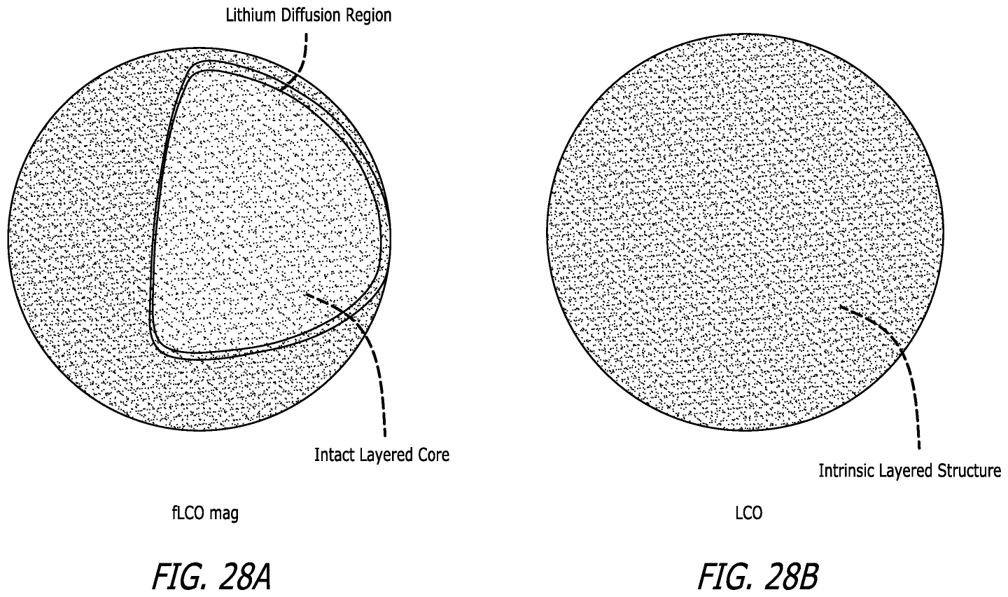

During the FJH process, this heterogeneous material undergoes an annealing process while being encapsulated with a carbon shell that prevent significant mass loss. Driven by structural relaxation, Co₃O₄ and CoO undergo an outward segregation (FIG. 13E), forming a shell over the restored and crystalline LiCoO₂. Part of this surface metal oxide can be distinguished in high resolution transmission electron microscopy (HR-TEM) images (FIGS. 28A-28B and FIGS. 29A-2911).

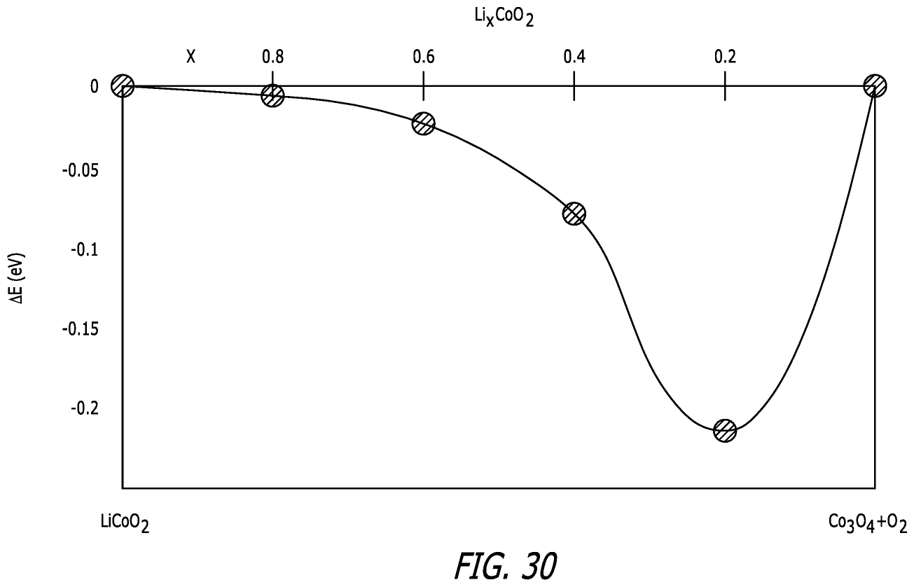

First principle calculations show the energy preference, AE, of such segregation (FIG. 30). First principle calculations allowed for the demonstration of a possible route for annealing process of partially delithiated LixCoO₂ through phase segregation of high quality LiCoO₂, Co₃O₄ and release of O₂ gas [Furushimna 2011]:

LiₓCoO₂→xLiCoO₂+(1−x)/3 Co₃O₄+(1−x)/3 O₂ (6)

Reaction energy ΔE=E_{LiCoO2}+E_{Co3O4}+E_{O2}−E_{LixCoO2} for various values of x is plotted on FIG. 30 and indicates energetic preference towards phase segregation. It is interesting to note that at low-to-moderate delithiation levels energy preference towards segregation is minimal.

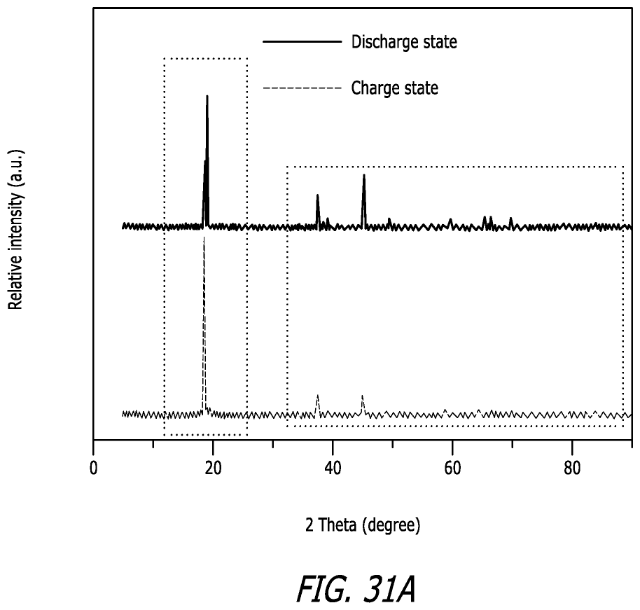

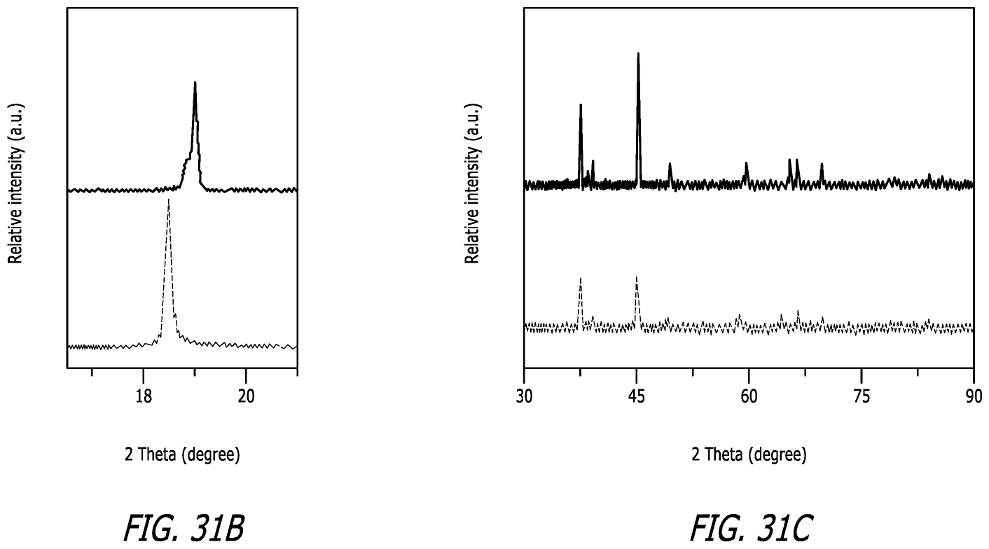

Relatively lower ΔE are observed in fresh cathodes compared to aged ones, showing that the annealing during flash recycling is more effective in aged cathodes because of the more pronounced delithiation. This mechanism is consistent with increased structure retention factor as can be seen in FIGS. 11E, 12A, and 12D. The flash cathode materials retain ˜93% of the original particle size distribution of cathode materials (FIGS. 23A-23D, 24A-24D, 25A-25F, and 26A-26F). The surface decomposition is further evidenced by x-ray diffraction (XRD). The downshift of the diffraction peak (003) (expansion of interlayer spacing), observed in the ferromagnetic portion of fCW (FIGS. 20A-20B), is consistent with a partial de-lithiation process (FIG. 31A-31C).

The magnetic properties of Co₃O₄/CoO film were simulated (FIG. 13E), presenting a magnetic moment of ˜70 emu/g for bulk phase (magnetic moment about one third of 219 emu/g for Fe). The magnetic characteristics of oxide shells are somewhat reduced due to inherent disorder and size-effects displaying characteristics consistent with that of thin Co₃O₄ films. [Apátiga 2006; Moro 2013; Zhang 2015]. The formation of this layer is useful (and can be utilized) for the magnetic separation. The gradual nature of annealing is consistent with the ability to improve recycling yield through the repeated FJH of non-magnetic material observed in the experiment.

Resynthesized Cathode Materials

The cathode materials can be resynthesized from the ferromagnetic flash products and in the context, they are named “resynthesized cathodes” (R-CW). For example, ˜1 g flash product was mixed with 10 mL 4 mol L⁻¹ LiOH aqueous solution, and then the mixture was poured into a hydrothermal vessel. The hydrothermal vessel was made of polytetrafluoroethylene and the volume was 40 mL. Then the vessel was sealed in a well-fitted stainless-steel autoclave and put into the oven under 180° C. for 12 hours. Subsequently, vacuum filtration was used to dry the solid powder. Then, the solid was calcinated at 400° C. for 3 hours in air before it was used to prepare the battery slurry.

In terms of synthesizing new cathodes, the flash process offers a more efficient use of Li. Compared with solid-state reactions to prepare the resynthesized cathode, the hydrothermal methods disclosed and described herein can avoid the direct use the solid Li source, which is hard to remove after the resynthesis process and acts as the impurity to affect the electrochemical performance of the cathode materials. As reported in literature [Zhao 2020; Zhang 2014], the chemical potential can drive the chemical lithiation of the layered flash product Li_{0.84}CoO₂ (the stoichiometric ratio is calculated from ICP-OES) to form the final resynthesized cathode materials. Since there is no fundamental structure change, the optimized condition can be milder compared to the synthesis condition starting from rock-type metal oxide, such as Co₃O₄. LiOH is used as Li source, since it has good solubility in water to form a concentrate solution. Other Li sources, like Li₂CO₃, which has been also reported [Zhao 2020] as a Li source for the synthesis of LCO, can also be considered in an industrialized process. A purpose of the final calcination step is to increase the crystallinity and improve the electrochemical performance of the resynthesized cathode materials, and the reason for choosing 400° C. in embodiments can be explained by the results, because the carbothermal reduction starts if the temperature is greater than 450° C. [Wang 2018].

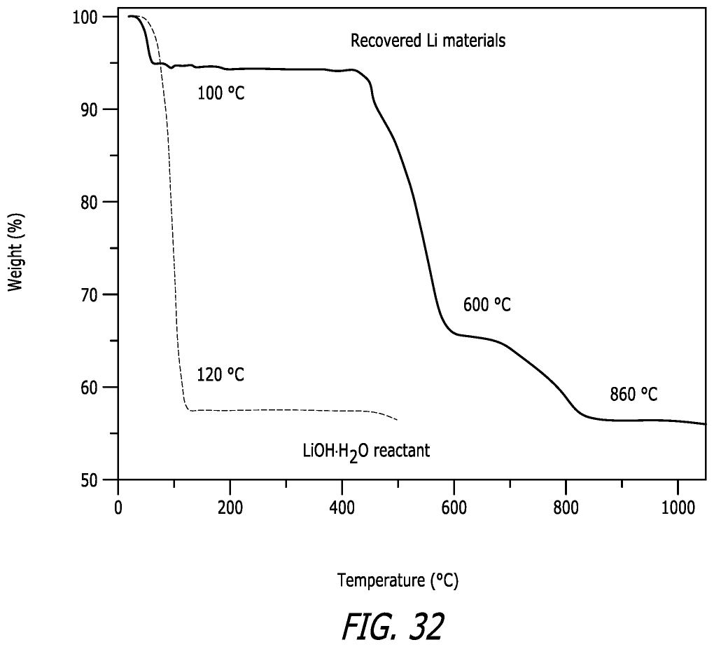

The formation of the lithium carbonate at the surface of the ferromagnetic flashed particles minimizes the need for supplemental Li-ion precursor to reconstitute a newly recycled cathode stoichiometry. See FIG. 32.

To calculate the consumed Li sources in the resynthesized process, the solvent after the hydrothermal reaction is collected. TGA is carried out (FIG. 32) to calculate the impurities in remaining Li sources, such as the crystal water. There is one mass loss stage by TGA in the LiOH·H₂O reactant at ˜120° C., which is related to the loss of the crystal water in the reactant. For the recovered Li materials, there are three stages. (1) At ˜100° C., the loss (˜5.6%) is related to the loss of the crystal water. (2) At ˜600° C., the loss (˜31.0%) is associated with the decomposition of LiOH. (3) At −860° C., the loss (˜8.9%) is associated with the decomposition of Li₂CO₃ and the remained powder is Li₂O. [Beyer 2013]. The mass of the recovered powder is 1.0259 g. Thus, the mass of Li in the recovered powder is 0.2686 g. Since the mass of Li in the reactant powder is 0.2804 g and ˜1.0 g flash powder is used, the ratio of consumed Li is 18.4%.

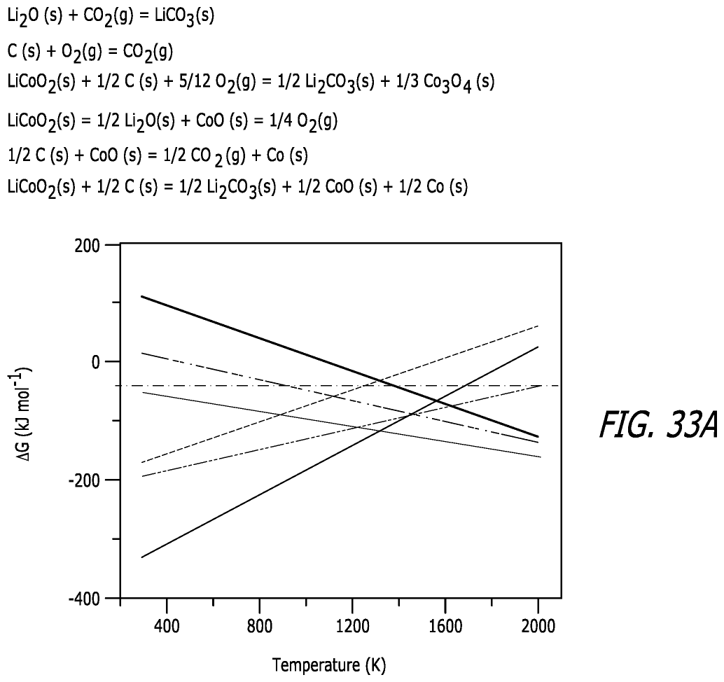

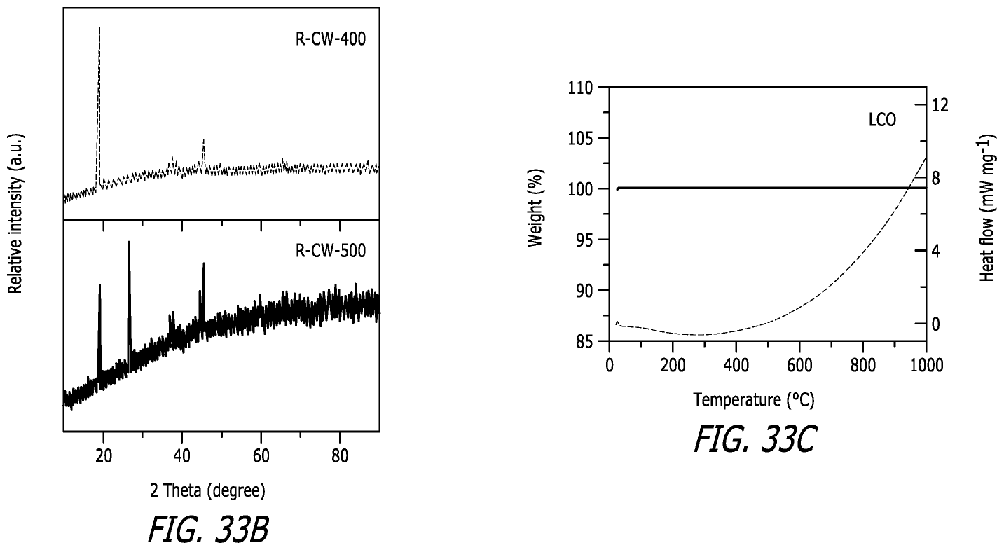

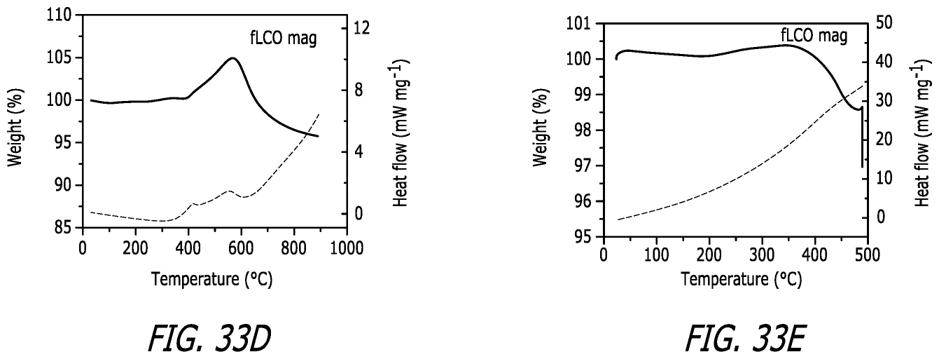

Only 10% to 20% of fresh Li-ion is required to fully lithiate and rebuild the cathode materials (FIGS. 33A-33E, where the corresponding cobalt complexes are presented with their requisite Gibbs free energies), since 80% to 90% is already present in the ferromagnetic flash product as indicated by ICP-OES. Fresh cathode materials can be resynthesized from ferromagnetic fCW by a simple hydrothermal reaction followed by calcination at 400° C. in air.

For certain embodiments, the optimized calcination temperature is 400° C. and a higher temperature, ˜500° C., will result in the carbothermal reduction. Thus, the following characterizations are for R-CW-400 and for simplicity, it is called R-CW. The possible reactions of LCO and the corresponding Gibbs free energy relationship can be calculated as follows:

4LiCoO₂(s)=2Li₂O(s)+4CoO(s)+O₂(g)

ΔᵣG_{T}^{θ}=604.78−0.557×T (7)

C(s)+2CoO(s)=CO₂(g)+2Co(s)

G_{T}^{θ}=78.52−0.17683×T (8)

C(s)+O₂(g)=CO₂(g)

ΔᵣG_{T}^{θ}=−393.98+0.20891×T (9)

Li₂O(s)+CO₂(g)=Li₂CO₃(s)

ΔᵣG_{T}^{θ}=−210.47+0.13483×T (10)

6CoO(s)+O₂(g)=2Co₃O₄(s)

ΔᵣG_{T}^{θ}=−407.39+0.33709×T (11)

2LiCoO₂(s)+C(s)=Li₂CO₃(s)+CoO(s)+Co(s)

ΔᵣG_{T}^{θ}=−65.81−0.12763×T (12)

12LiCoO₂(s)+6C(s)+5O₂(g)=6Li₂CO₃(s)+4Co₃O₄(s)

ΔᵣG_{T}^{θ}=−2627.14+1.06592×T (13)

The Ellingham diagram of the above reactions were plotted, which confirmation the thermodynamic relationship. [Wang 2018]. The carbothermal reduction between the carbon and LCO is thermodynamically favorable under inert atmosphere or in air. Thus, the high temperature calcination can cause the reduction of the Co species and it is not good for cathode material resynthesis. Similarly, direct high temperature treatment in pyrometallurgical method can only get Co₃O₄ metal chunk derived from the above carbothermal reaction. The thermogravimetric curves also demonstrate that LCO itself is stable in air when the temperature exceeds 1000° C., while the ferromagnetic portion of fLCO, which is coated with carbon, shows a greater than 10 wt % weight loss when the temperature increases from 600° C. to 800° C. This can also be explained by the above carbothermal reaction. If holding the temperature at 500° C. for 30 min, the obvious mass loss can still be observed as shown in FIG. 33E. This is consistent with the XRD in FIG. 33B.

In order to coat the cathode materials with carbon, a low calcination temperature should be used at the last step of the resynthesis process. However, the resynthesized cathode derived from pyrometallurgical or hydrometallurgical methods need a high calcination temperature (greater than 750° C.) to build the ordered layer structure of the cathode. [Zhao 2020; Zhang 2014; Nie 2015]. This feature renders it more difficult to directly achieve the surface carbon coating in those classical resynthesis processes, and more complex post-treatment should be necessary if the carbon coating is needed after a pyrometallurgical or hydrometallurgical recycle protocol.

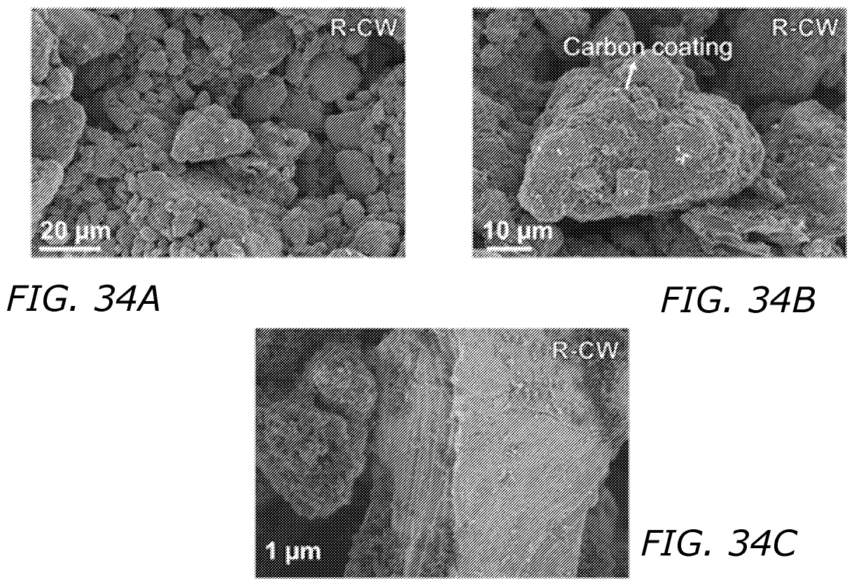

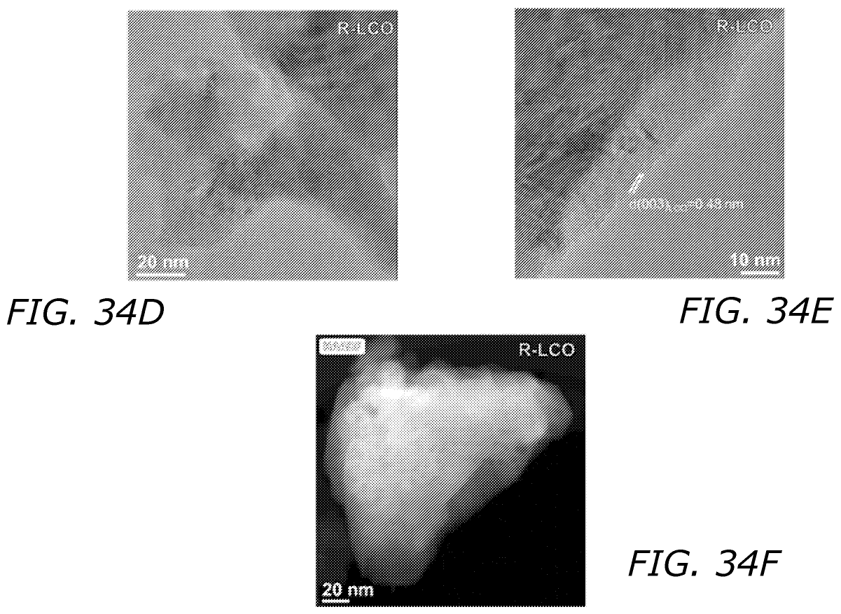

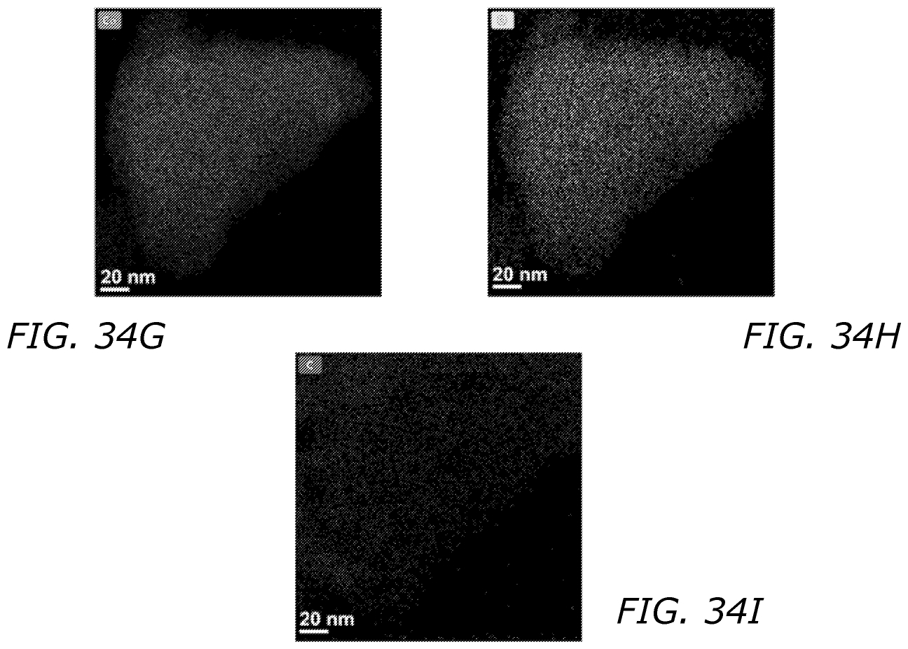

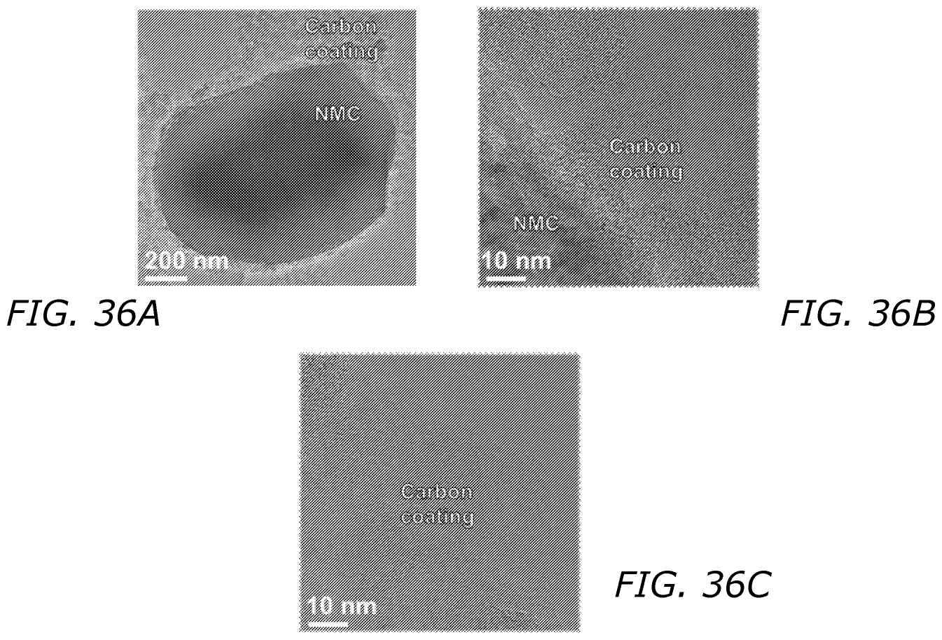

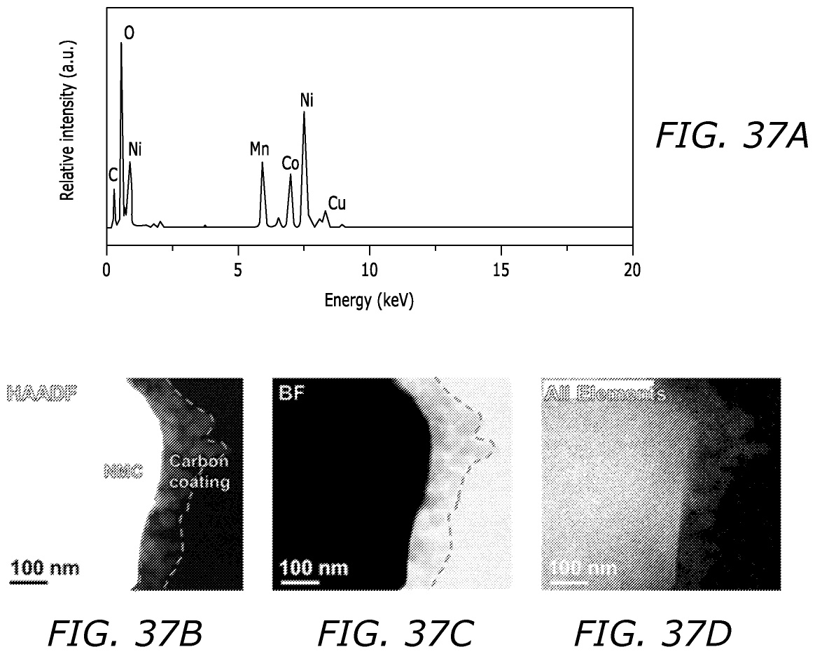

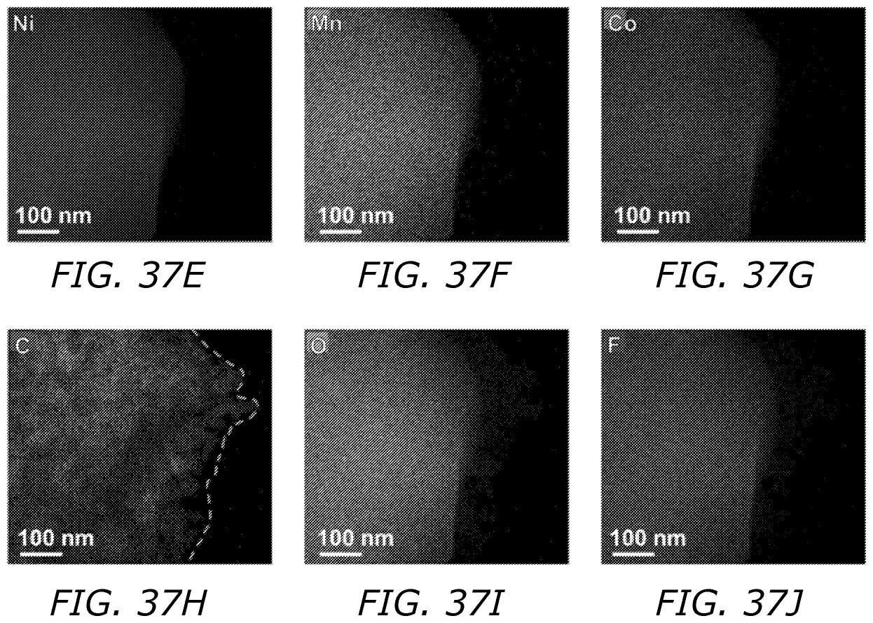

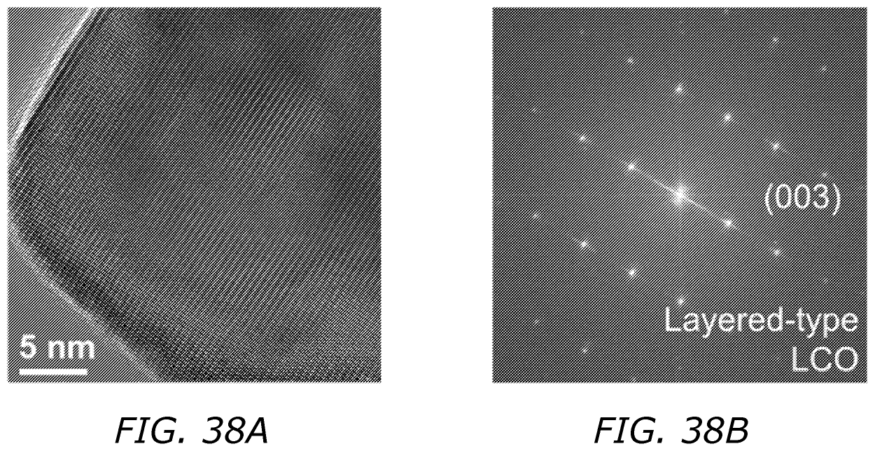

The resynthesized cathode materials (R-CW) lose the ferromagnetism and show a 3D layered structure with high crystallinity. FIGS. 34A-34I, 35A-35E, 36A-36C, and 37A-37J. For FIGS. 36A-36C, the amorphous carbon coating can prevent the direct exposure of NMC cathode particle in the corrosive carbonate electrolyte and reduce the parasitic reaction between NMC and electrolyte under high voltage condition. It has also been confirmed that, unlike well-graphitized carbon coating, the amorphous carbon coating is Li-ion permeable. Thus, the flash Joule heating method can be used to coat cathode materials. For FIGS. 37A-37J, it can be seen there is a thin carbon coating at the surface of the R-CW particle.

The high-resolution TEM image of FIG. 13F and corresponding fast Fourier transform (FFT) patterns indicate the existence of the layered structure at the surface of cathode particle.

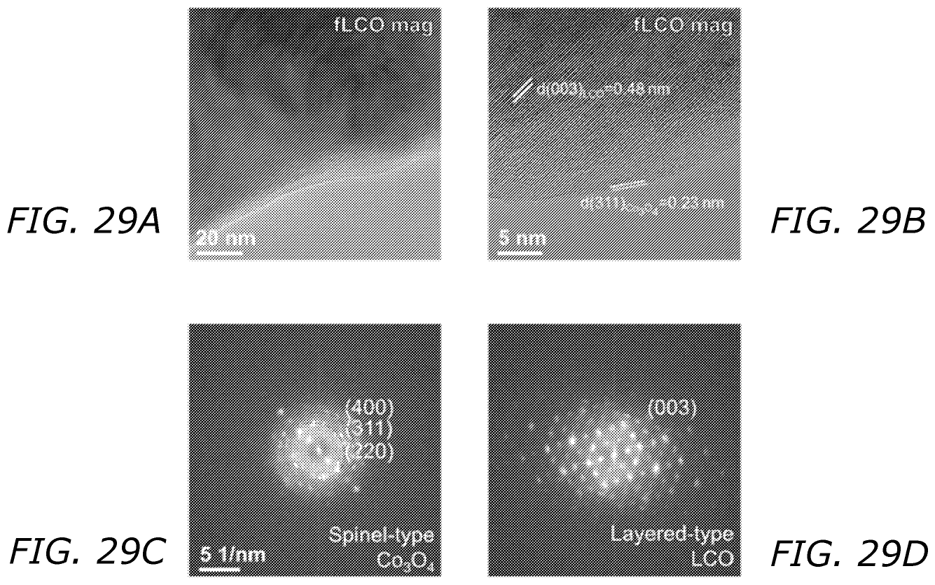

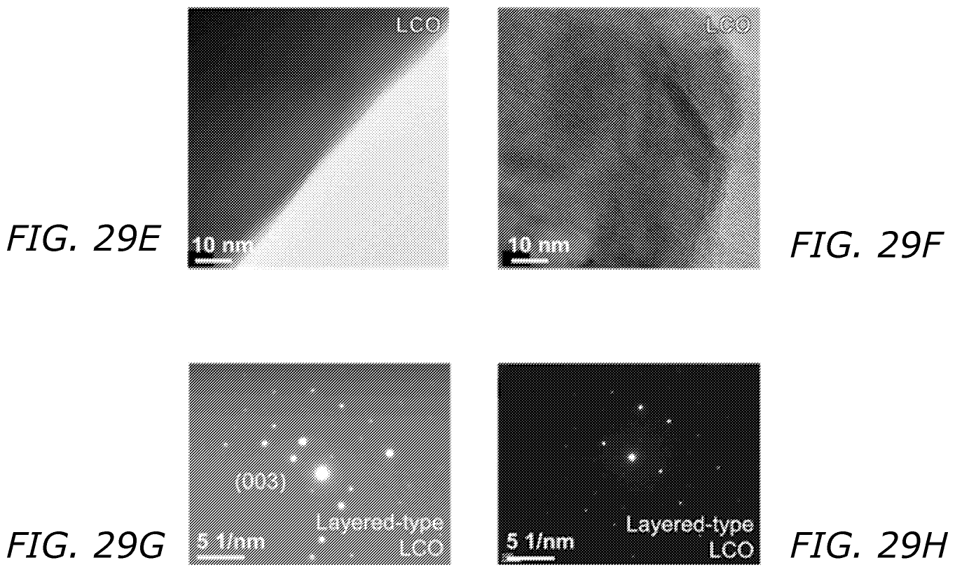

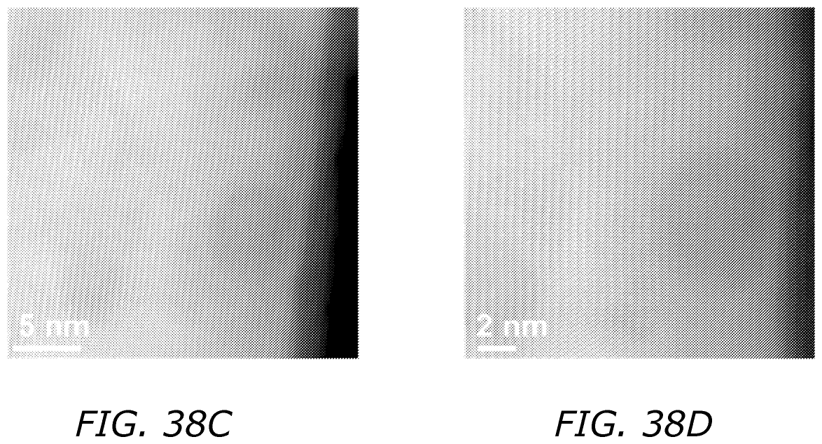

Atomic resolution high-angle annular dark-field scanning transmission electron microscopy (HAADF-STEM) imaging (FIGS. 13G and 38A-38D) shows the existence of trigonal lattice with the space group R3̅m. (Compared with fLCO with spinel structure as shown in FIGS. 29A-29H, FIGS. 38A-38D show there is a recovered layered structure in the resynthesized cathode materials).

These results reflect the recovered layered structure in the resynthesized cathode materials. The amorphous carbon coating on the R-CW particles is also retained after the resynthesis process as shown by SEM (FIGS. 34A-34I), HR-TEM (FIGS. 36A-36C), STEM and corresponding elemental mapping (FIGS. 13H and 37A-37J). Similarly, the layered structure appears in R-LCO, and the energy mapping showed the existence of a carbon coating (FIGS. 34A-34I).

Atomistic Simulations

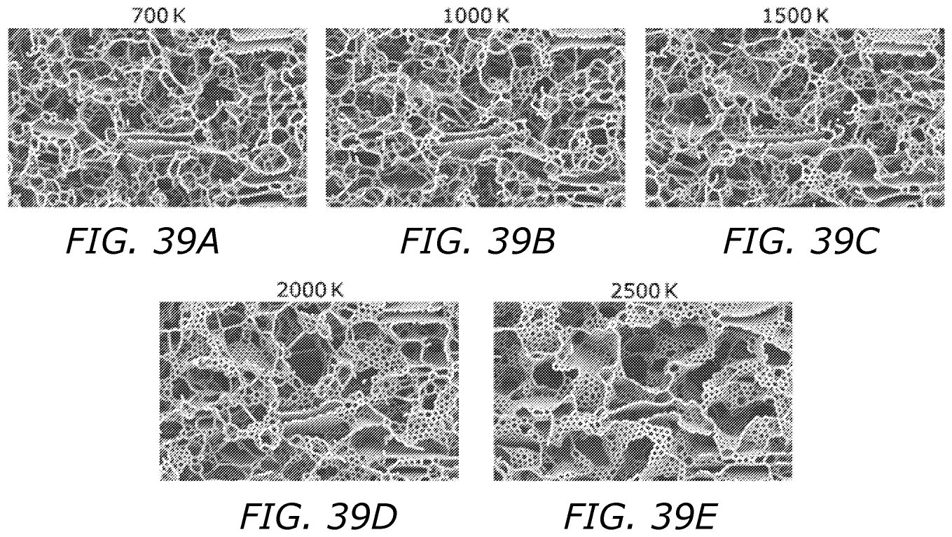

The partially graphitized carbon crust also can be important in the cell performance, as its permeability to Li-ion is a factor for the electrochemical processes. High temperature annealing during flash recycling was simulated for large amorphous carbon structure containing over 30000 atoms using AIREBO interatomic potential. Initial configurations included small graphitic domains of arbitrary shape in the 8 Å-22 Å size range and up to 3 layers thick that were misaligned by up to 50 degrees and randomly positioned within the periodic cell. Remaining 65% of atoms were provided as individual carbon atoms randomly positioned within the unit cell. Resulting configurations were pre-annealed, slowly heated up to the target temperature. For comparison, FIGS. 39A-39E show the results of annealing at 700K, 1000K, 1500K, 2000K and 2500K.

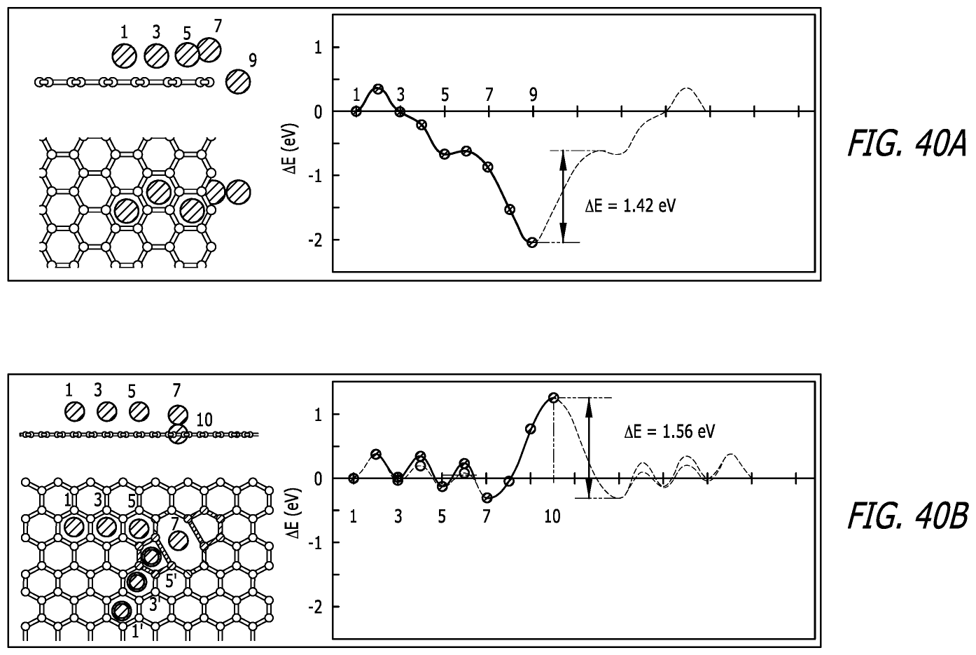

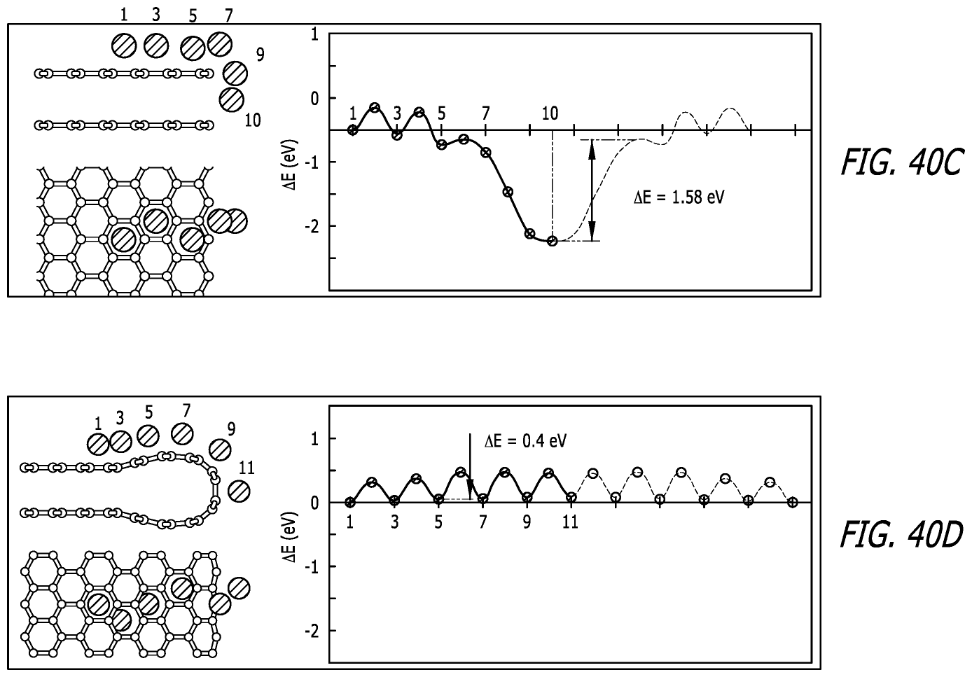

The simulation at high temperature (2500 K) indicate a fully amorphous carbon with the density of 0.9 g cm⁻³ (FIG. 13I). Using first principle calculations, diffusion of Li⁺ ion was compared over various features of carbon structures to identify effect of annealing of Li⁺ permeability of carbon crust. A particular role is played by elimination of unpassivated graphitic edges during annealing. As demonstrated in FIGS. 40A-40D, the diffusion barrier over these structural elements can reach 1.5 eV in comparison with 0.34 eV barrier for perfect graphitic plane. Furthermore, unpassivated edges present potential energy traps that would capture Li-ions negatively affecting battery characteristics.

In plane diffusion over reconstructed di-vacancy is characterized with 0.5 eV barrier similar to that of graphitic plane. Additionally, larger octagonal defects allow for transmission through the surface but large barrier of 1.6 eV must be overcome. Furthermore, fully reconstructed graphitic edges, forming a bulb like shape [Zhang 2012] do not obstruct Li⁺ diffusion acting as a smooth surface continuation with diffusion barrier of 0.4 eV.

First-principle calculations show significant differences in the effect of various structural elements within the amorphous carbon crust on the Li-ion diffusion. FIGS. 39A-39E and FIGS. 40A-40D. The annealing eliminates unpassivated graphitic edges and point defects, thus improving Li-ion permeability of the crust (see FIG. 13I), as observed.

Life Cycle of Flash Recycling Process

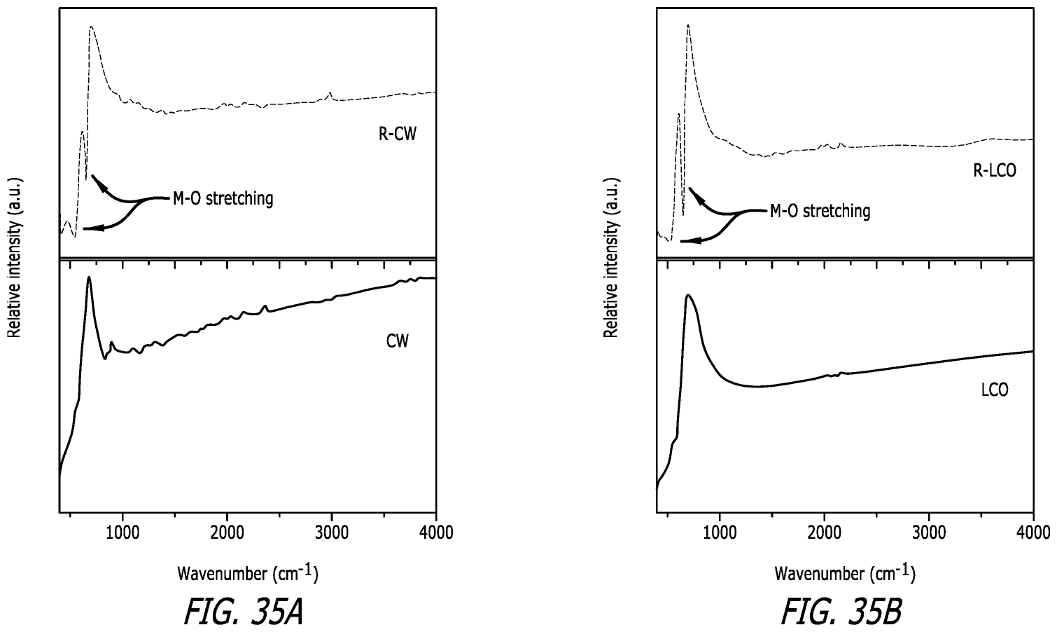

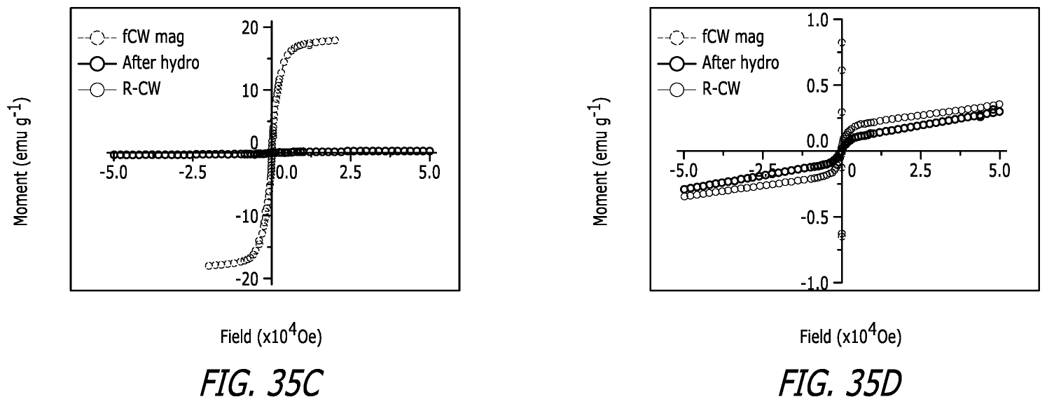

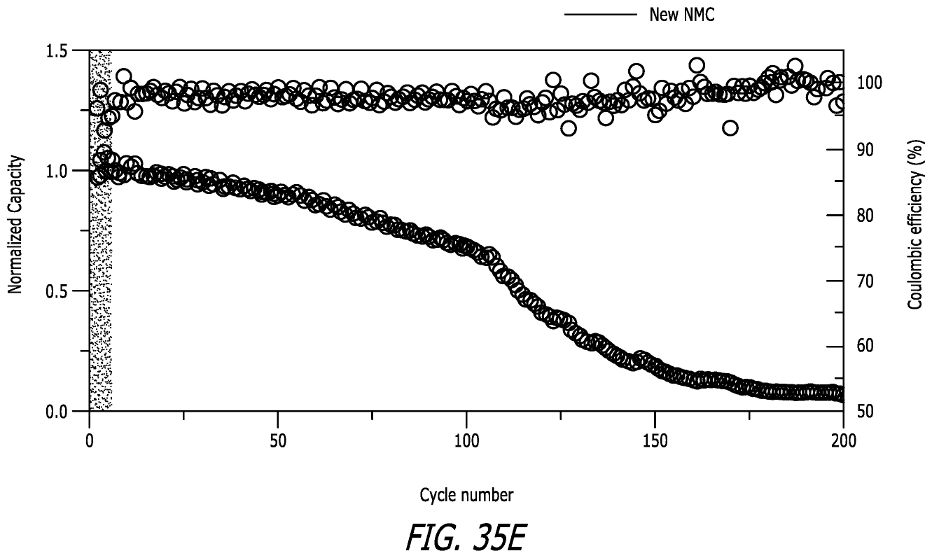

The electrochemical cycling performance of the flash recycled R-CW was studied in a half-cell with initial configuration R-CW/Li. Although the R-CW shows an obvious decay in the first 10 cycles, a slower capacity decay from 25 to 200 cycles is observed, compared to a new LCO and new NMC cathode without the flash-generated carbon coating as assembled under the same laboratory conditions. FIGS. 13J and 35A-35E. The R-CW is far more stable than the origin CW.

This improved cycling performance of the R-CW can be attributed to the carbon coating, which acts as the artificial CEI to avoid the direct exposure of cathode particles, while possessing high oxidative stability in the electrolyte. This lessens the irreversible active materials loss during electrochemical cycling process. Further optimization to minimize the decay in the first 10 cycles would increase the efficiency, but even at this preliminary level of study, the R-CW outperforms new cathode materials in similarly constructed systems. The ability to rapidly, and without solvent or paste, generate such a stabilizing and Li-ion permeable carbon coating can be particularly important in the newer higher capacity but less stable NMC cathodes, and it could result in this flash approach to be used even on new cathodes rather than solely on recycled materials.

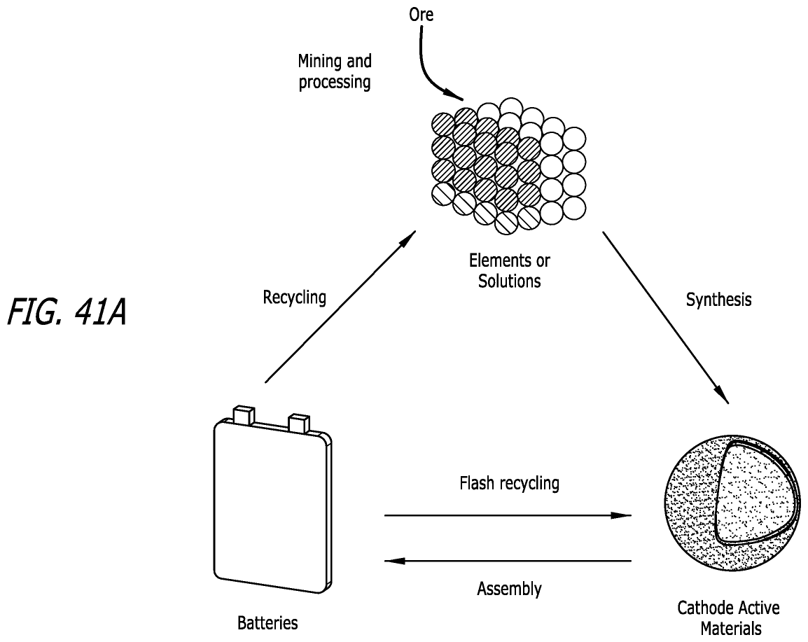

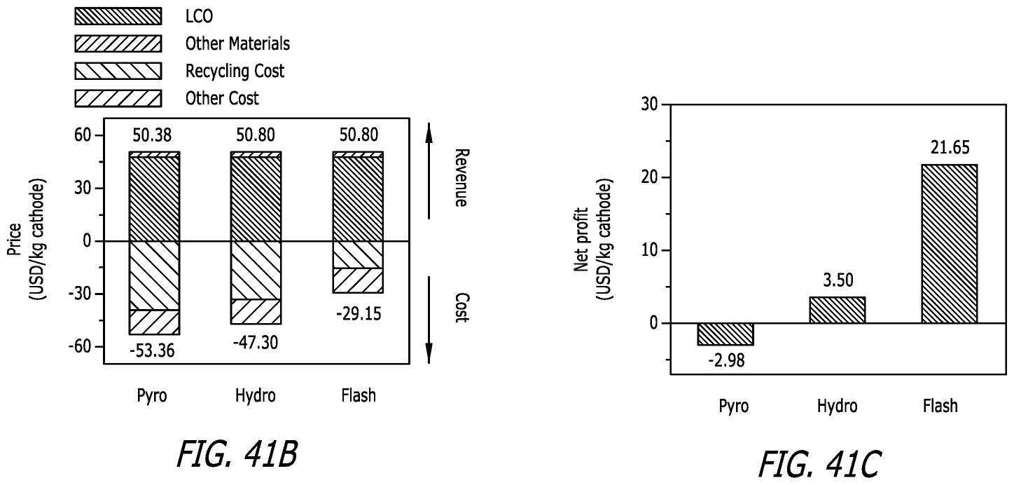

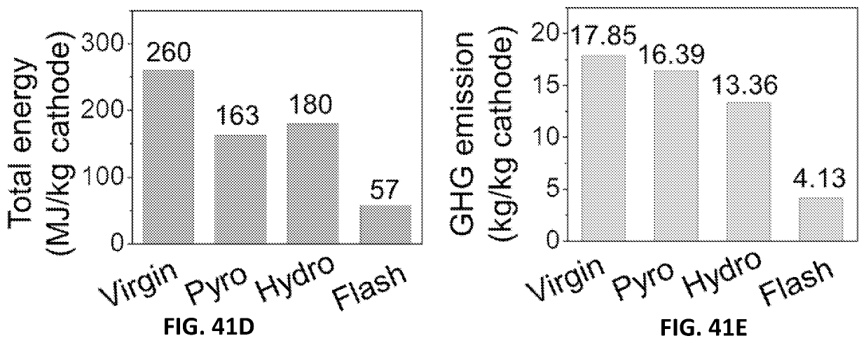

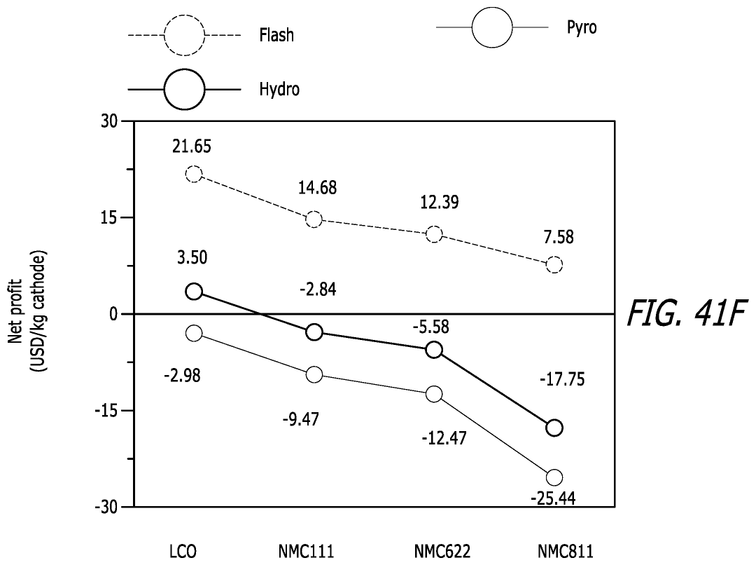

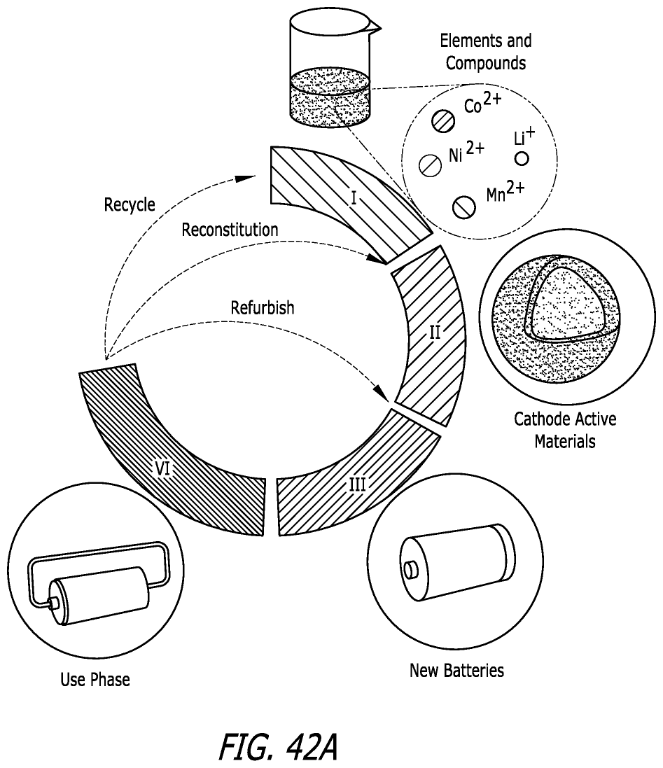

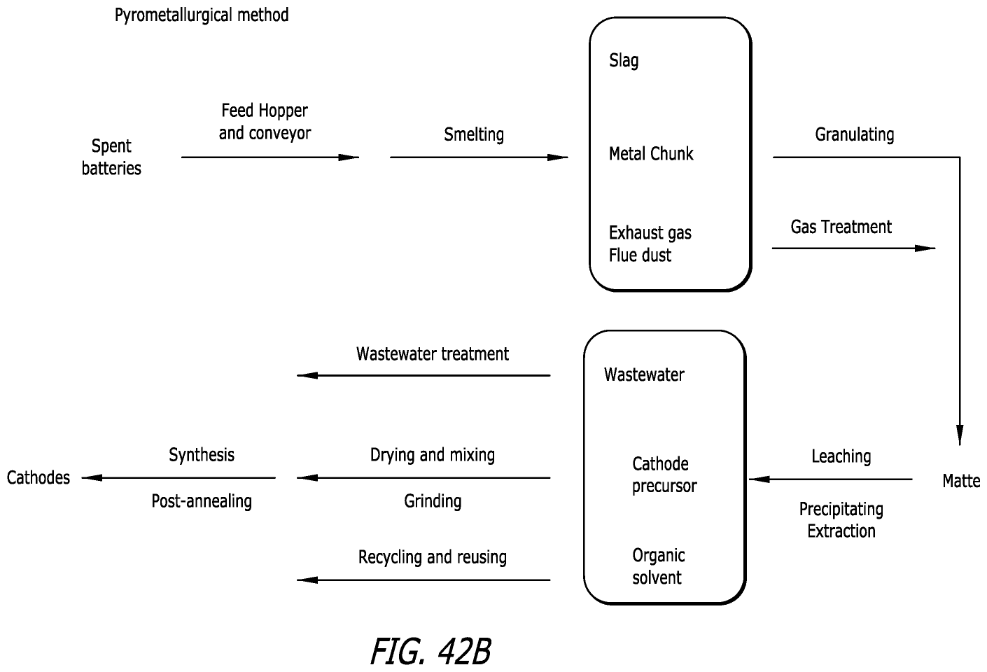

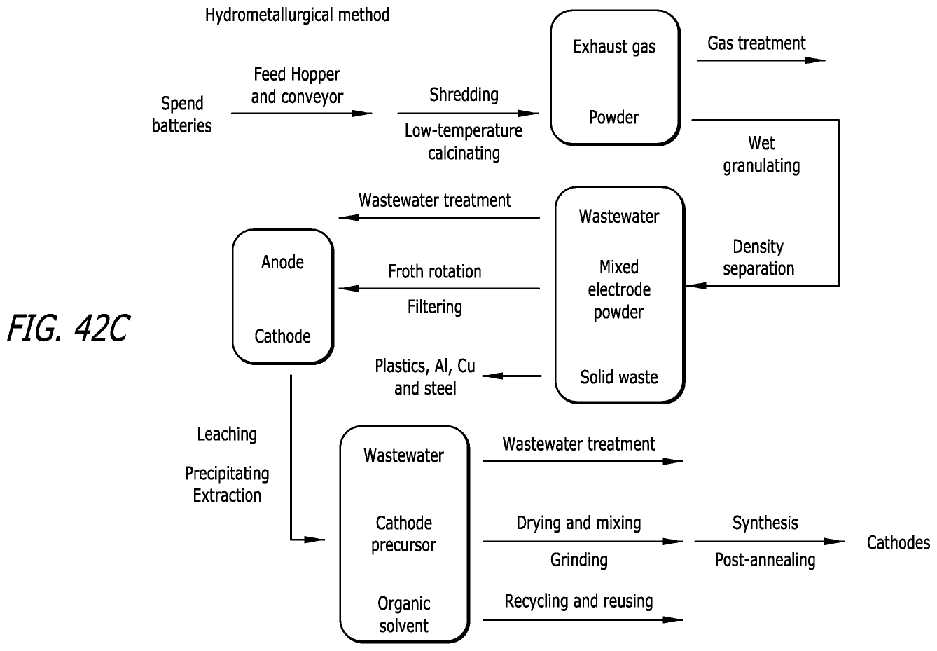

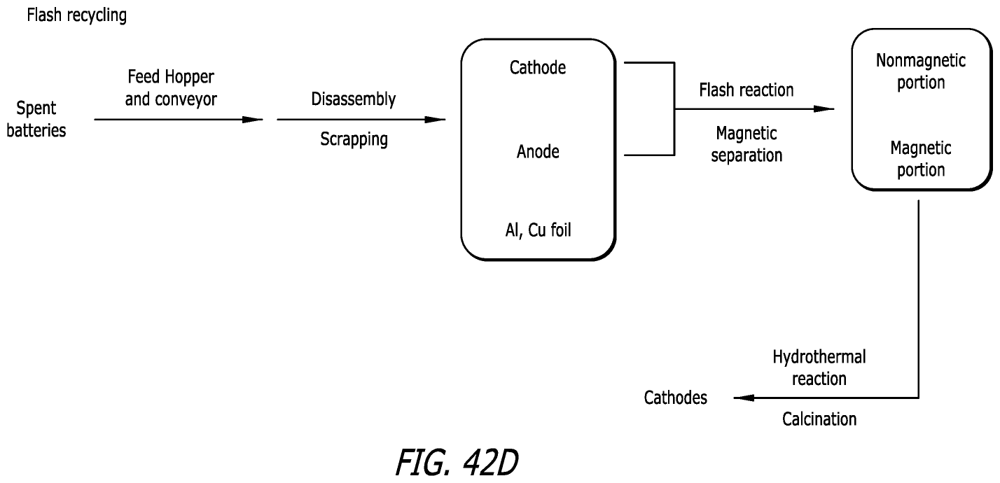

Using the EverBatt 2020 software package developed by Argonne National Laboratory for determining the closed-loop life cycle analysis of LIBs [Everbatt 2020], the flash method was compared with different types of recycling processes and their efficiencies. FIGS. 41A-41F and 42A-42D.

The scheme of the closed-loop life cycle analysis of LIBs illustrates the various phases in the recycling processes. FIG. 42A. Direct recycling processes, such as refurbishment and repurpose, are easily operating, but generally result in downcycled and downregulated cathode materials. On the contrary, current recycling processes, such as pyrometallurgical or hydrometallurgical methods, involve complex steps to recover the valuable metals with the form of elements and compounds. However, these methods irreversibly destroy structures of the high-performance cathode and bring in extra resynthesis steps before they can go back to the use phase. The FJH method achieves a high recovery yield without the loss of cathode layered-structure and reduces the operation phases.

The flash recycling does not destroy the cathode layered structure while facilitating reuse in well-performing batteries. FIG. 13J. By using the LCO-type cathode as the model, flash recycling reduces the recycling cost by ˜45%, reduces recycling energy by ˜70%, and reduces GHG emissions by ˜70%, while increasing the profitability of recycling by ˜$25 per kg-cathode and ˜$18 per kg-cathode compared with pyrometallurgical or hydrometallurgical methods, respectively. See FIGS. 41B-41E. With increased interest in cathode materials possessing lower Co content, such as NMC622, NMC811 and NCA, and non-Co-based systems such as LiFePO₄ and LiNiO₂, more efficient recycling with increased profit margins might be attainable by flash recycling using these other ferromagnetic metals. FIG. 41F.

It should be noted that there is a revenue difference between pyrometallurgical and the others due to the burning for energy rather than the sale. This utilization of the feed materials in the different recycle methods is shown in TABLE IV.

TABLE IV
The fate of feed materials in different recycle methods

| | | | Flash |
|---|---|---|---|
| Materials | Pyrometallurgical | Hydrometallurgical | recycling |
| Cathode materials | Recycle | Recycle | Recycle |
| Graphite | Burn for energy | Recycle | Recycle |
| Cu | Recycle | Recycle | Recycle |
| Al | Intermediate, | Recycle | Recycle |
| Fe | Recycle | Recycle | Recycle |
| Plastic | Burn for energy | Burn for energy | Recycle^{a} |
| Electrolyte | Burn for energy | Burn for energy | Recycle |
| Carbon black | Burn for energy | Burn for energy | Recycle |
| PVDF | Burn for energy | Burn for energy | Intermediate |

Note:
^{a}Plastic can be flash Joule heated to form the flash graphene. [Algozeeb 2020].

Accordingly, flash recycling of LIBs is an environmentally cleaner method to reclaim the metals in secondary batteries. The method preserves the 3D layered structure of the cathode and provides an efficient reuse of the elemental inventory. The fast process also produces a convenient carbon coating on the recycled cathode particles that permits Li-ion transport while stabilizing the overall structure of the cathode, thereby affording superior performance to the recycled batteries over new batteries. Since the FJH process is being industrially scaled to the multi-ton scale per facility [Universal Matter 2021], manufacturability is attainable while minimizing dependence on freshly mined metal ores for the production of LIBs.

### Flash Recycling Process for Anode Materials

High temperature calcinations (1200˜3000 K) are still the mainstream process to regenerate the graphite, which is time- and energy-consuming, accounting for more than 50% of the recycling cost. The use of strong caustic acids, such as HCl and H₂SO₄, poses the serious concerns about the secondary waste as well. Besides, calcinations incur the formation of the toxic and corrosive exhausted gases, such as HF, making these methods less promising for dealing with pristine anode waste (AW) that is directly recovered from lithium-ion batteries LIBs.

A solvent and water-free flash recycling method has been discovered that rejuvenates the AW directly collected from spent LIBs, which is done within seconds and retains the graphite particle morphology. The estimated energy cost is only ˜$67 to flash recycle 1-ton pristine AW. After the flash recycling process, the mosaic-like SEI can be decomposed and graphene shell forms on the surface of graphite microparticles. The formation of the SEI-derived graphitic layer embedded with inorganic salts, such as LiF, Li₂CO₃ and Co₃O₄ can be observed. These inorganic salts can be easily recollected by a post-treatment with 0.1 M HCl solution from graphite. The flash anode products show the recovered specific capacity (358.9 mAh g⁻¹ at 0.2 C), compared with pristine AW and commercial graphite materials. Life-cycle-analysis (LCA) and comparison to the current calcination method indicates that flash recycling method can significantly reduce the total energy and water consumptions, and greenhouse gas (GHG) emissions, which shows the environmental and economic potential of flash recycling method.

In embodiments, ultrafast solvent-free flash Joule heating (FJH) methods regenerate battery graphite anodes in bulk dry powder form from battery anode waste. Characterization of flash recycling products show the intact 3D-layered graphite core structure coated with a solid electrolyte interphase (SEI)-derived graphene shell. The valuable metals, lithium, cobalt, nickel, and manganese can be easily recovered from the flash anode products by a dilute acid post-treatment. The flash anode materials show recovered electrochemical performance when compared to anode waste and new commercial graphite. Life-cycle-analysis relative to current calcination methods highlight that flash recycling can significantly reduce the total energy and greenhouse gas emissions while turning anode recycling into an economically advantageous process.

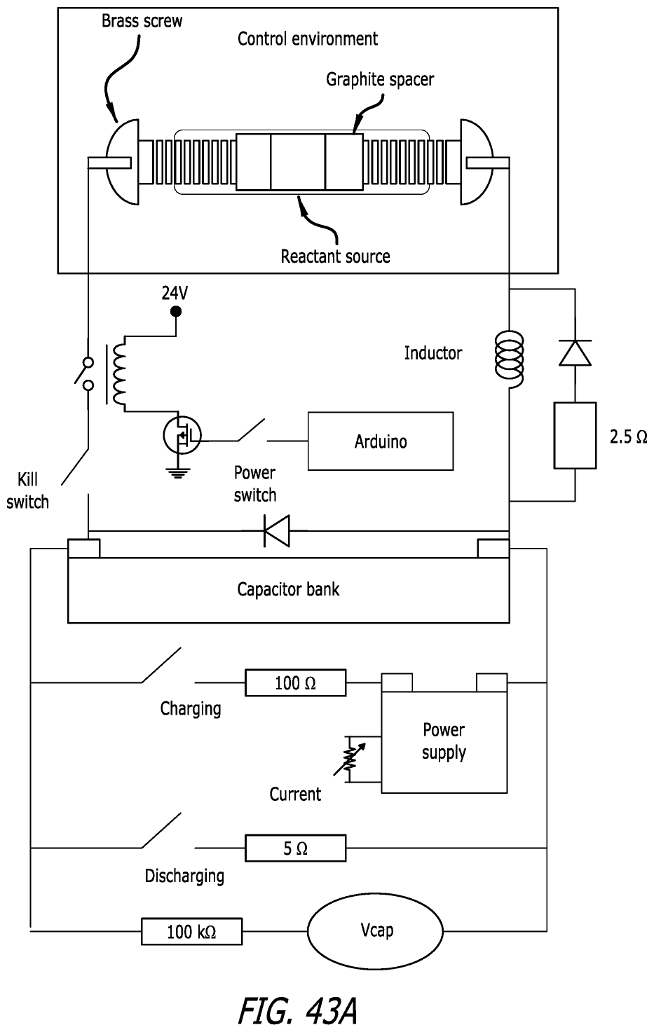

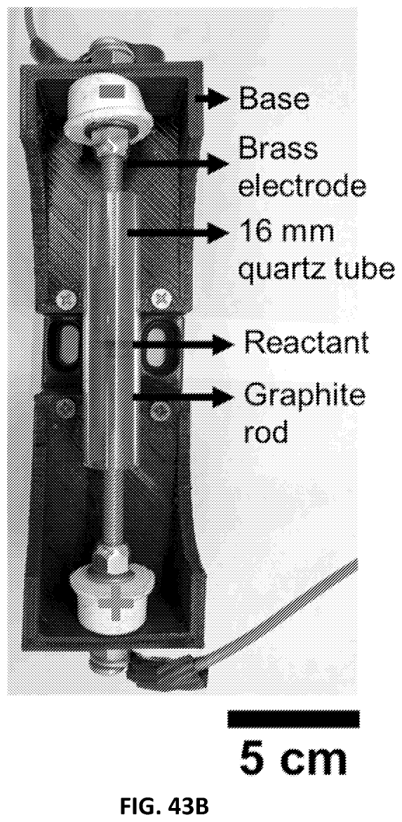

The FJH system is similar to that previously described above. [See also Luong 2020; Chen 2021]. The circuit diagram of a FTH setup and a photo of a FJH reaction box are shown in FIGS. 43A-43B. In an exemplary embodiment, Ar gas (˜1 atm) was used as an inert atmosphere to avoid sample oxidation during the FJH reaction. The reactant was the graphite anode waste collected from the anode side in spent Li-ion batteries. The reactant powder was ground and mixed homogeneously by a mortar and pestle before being loaded into the reaction tube with an inner diameter of 8 or 16 mm. The reaction tube can be a quartz or a ceramic tube, or concrete, or other non-conductive material. The mass loadings in the 8-mm and 16-mm tube were 200 mg and 1 g, respectively. Graphite rods were used as electrodes in this reaction. The compressing force was controlled by a small vise connected to a rotary knob as shown in FIG. 43B, to tune the sample resistance to ˜2Ω. The Arduino controller with a programmable millisecond-level delay time was used to control the discharge time and the electric energy was provided by a capacitor bank with a total capacitance of 60 to 222 mF. The capacitor bank was charged by a DC power supply capable of reaching 400 V. The FJH reaction was carried out with voltage 120 V and optimized duration of 1000 ms for an 8-mm tube reaction. (More details are shown in TABLE V) After the FJH reaction, the apparatus was allowed to cool and vent for 3 min. The product is called flash anode waste (fAW) in this context.

TABLE V
Flash parameter for different systems

| | Small batch | | Large batch | |
|---|---|---|---|---|
| Reactant | Graphite anode waste | | Graphite anode waste | |
| Sample mass | 200 | mg | 1 | g |
| Sample resistance | ~1.3 | Ω | ~1.0 | Ω |
| Discharge voltage | 120 | V | 164 | V |
| Flash duration | 1000 | ms | 1000 | ms |
| Total capacitance | 168 | mF | 222 | mF |

| | | |
|---|---|---|
| Number of times flash | 2 | 3 |
| was applied | | |
| Chamber pressure | Ar (~1 atm) | Ar (~1 atm) |

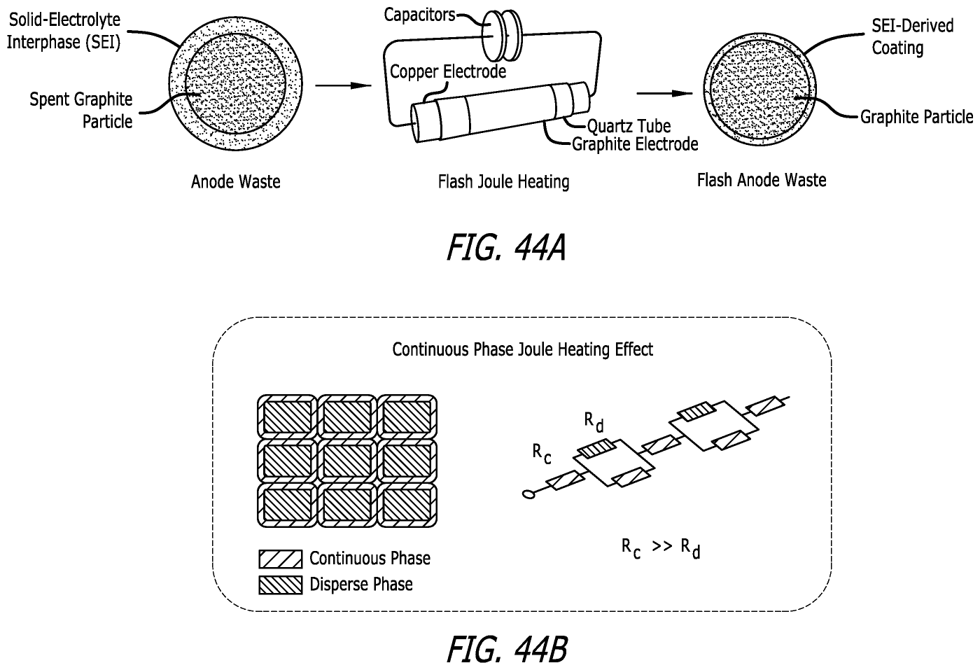

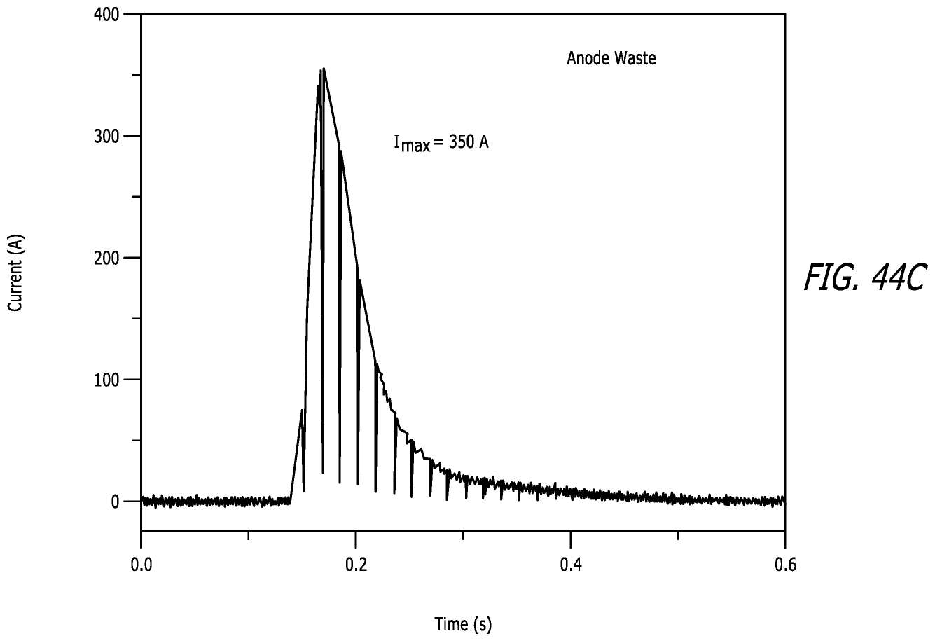

In a typical flash recycling process, the AW collected from spent lithium-ion batteries (LIBs) is directly used as the reactant without further treatment. The AW, in the powder form, is slight compressed inside a quartz tube between two graphite electrodes (FIGS. 43A-43B). The capacitor banks in the circuit are used to provide electrothermal energy to the AW reactants for ˜1000 ms (FIGS. 44A-44B). During the typical flash recycling process with a voltage of 120 V and a resistance of ˜1.3Ω, the current passing through the sample reaches ˜350 A in ˜1000 ms discharge time (FIG. 44C). The total amount of electrical energy is 1210 J g⁻¹, the majority (>80%) of which is targeted to heat and decompose the SEI (continuous phase), while the graphite microparticles (disperse phase) only receive <20% of the electrical energy according to the Joule heating distribution rule (FIG. 44C). This continuous phase Joule heating effect reflects the selective reaction of interfacial resistive layer (continuous phase), in our case, the graphitization of the SEI.

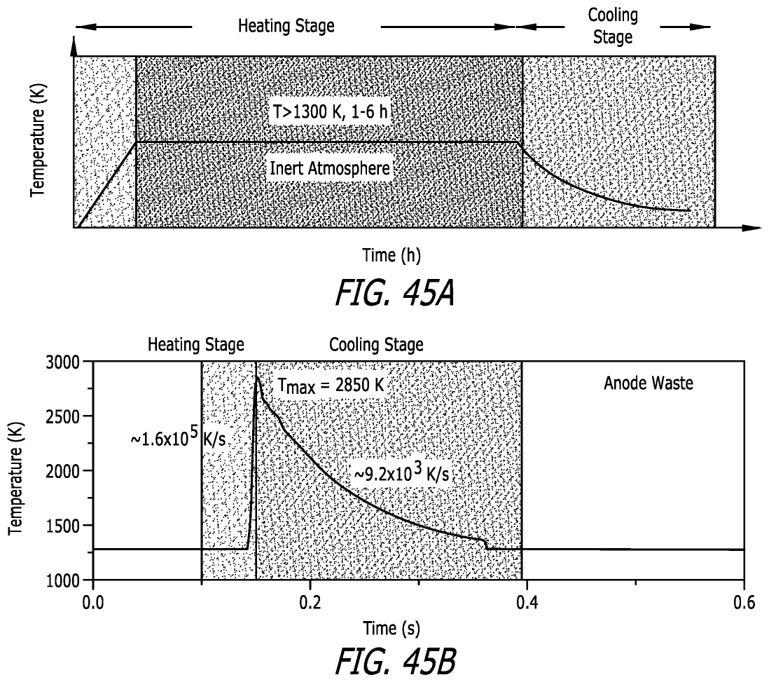

In traditional calcination processes (FIG. 45A-45B), the entire system, including environment and anode waste, is subjected to high temperature (>1300 K) for several hours under inert atmosphere protection, which demands high energy consumption, generate more GHG and further generation of secondary waste. [Yu 2021]. Flash recycling process achieves the momentary and local heating of the AW with desired selectivity and the environment facilitates the subsequent rapid heating transfer from the reactant to avoid thermal expansion and defects formation. The temperature is measured through a high-temperature infrared thermometer with the maximum temperature ˜2850 K. There are ultrafast heating rate ˜1.6×10⁵ K s⁻¹ and cooling rate ˜9.2×10³ K s⁻¹ during the flash process (FIG. 45A-45B).

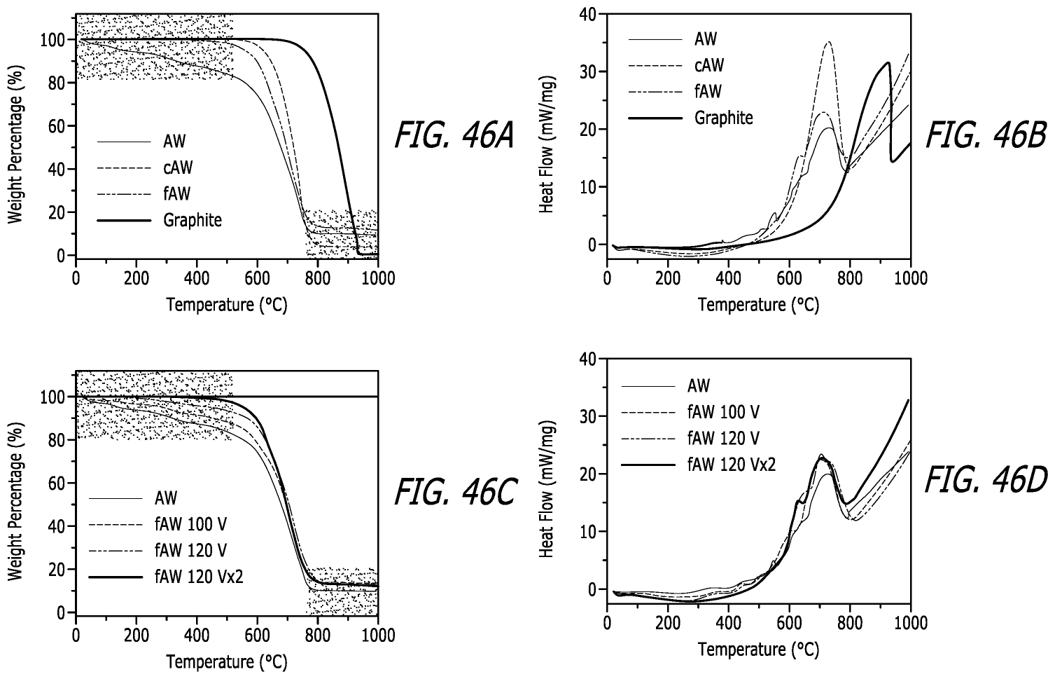

To confirm the decomposition of SEI structure and evaluate the removal of “dead mass” in the flash recycling process, thermogravimetric analysis (TGA) is used since the thermal stabilities of the SEI, binder, and other components, such as graphite or inorganic salts are distinct (FIGS. 46A-46D). [Beyer 2013; Advincula 2021].

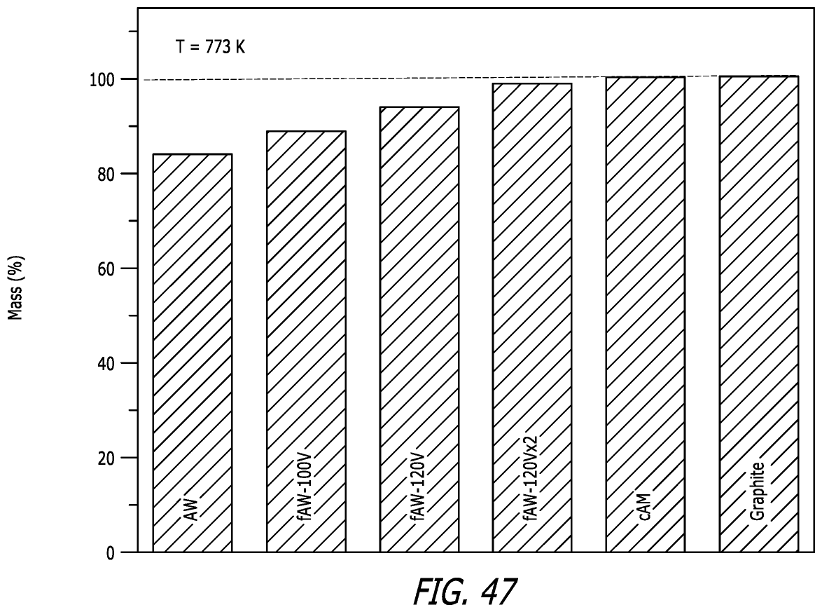

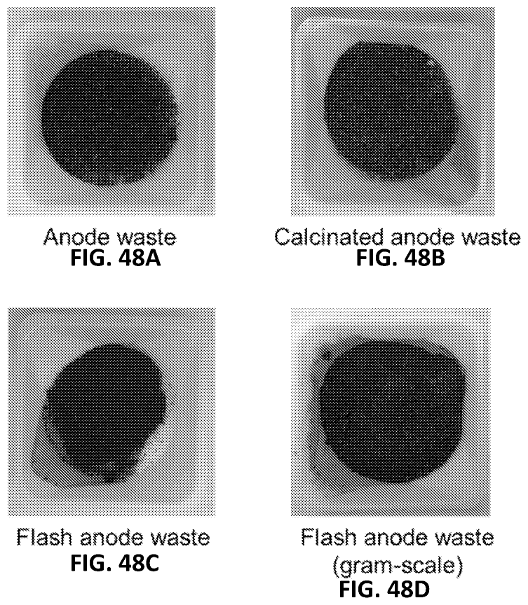

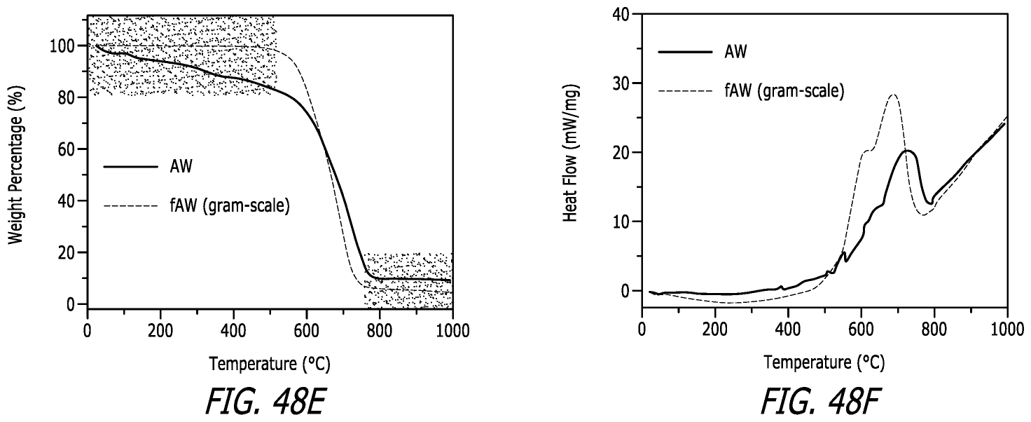

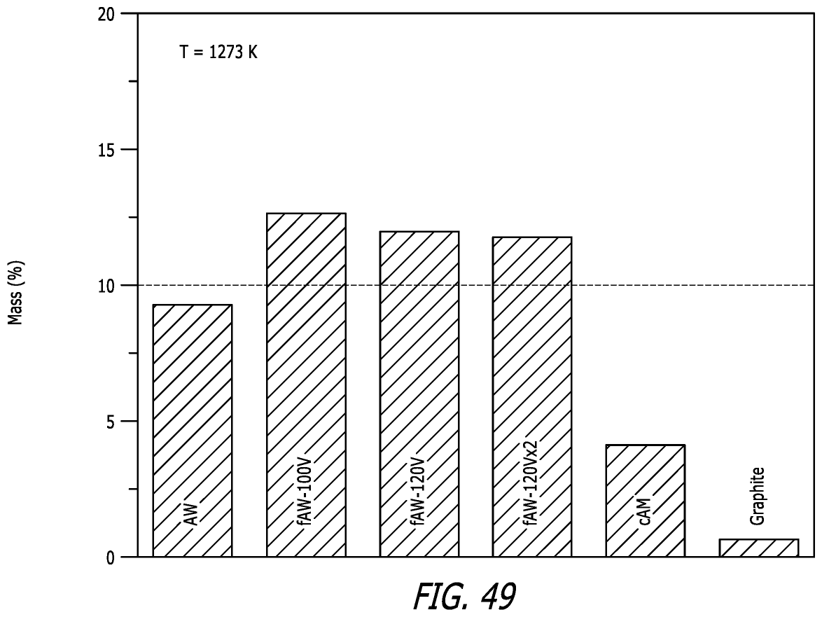

For pristine AW, there is ˜16.3% mass loss at 773 K (FIG. 47), while after flash reaction, the mass loss decreases dramatically. After flashing at 120 V for two cycles, the mass loss becomes negligible (˜1.2%), which can be caused by the decomposition of lithium salt, such as LiOH [Beyer 2013], as shown in differential scanning calorimetry (DSC) results (FIG. 46B). The similar result is observed for calcinated AW (cAW), which is prepared by calcination at 1323 K for 1 h under argon protection, with minimal mass loss at 773 K. The pronounced decrease of mass loss can also be found after scaling the system up to gram-level and the optical images of various anode materials can be seen in FIGS. 48A-48F. Therefore, the flash process can effectively decompose the SEI and remove of the “dead mass” accumulated in the pristine AW. Notably, at 1273 K, remained solid accounts for ˜12.1% of flash products, while it is <4.0% for cAW. (FIG. 49) The difference of remained weight indicates flash recycling method preserves the inorganic salts and facilitates the subsequent metals collection.

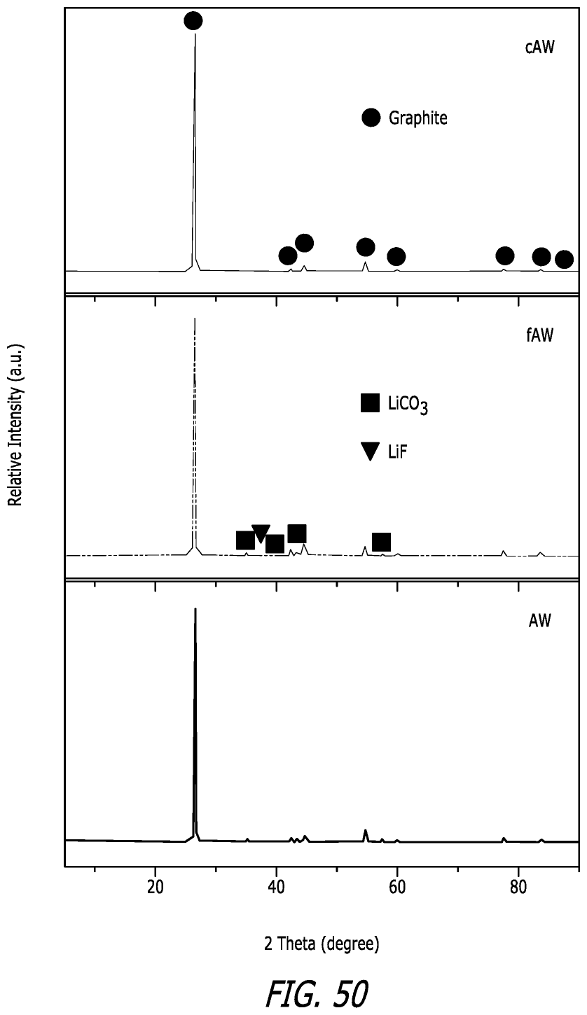

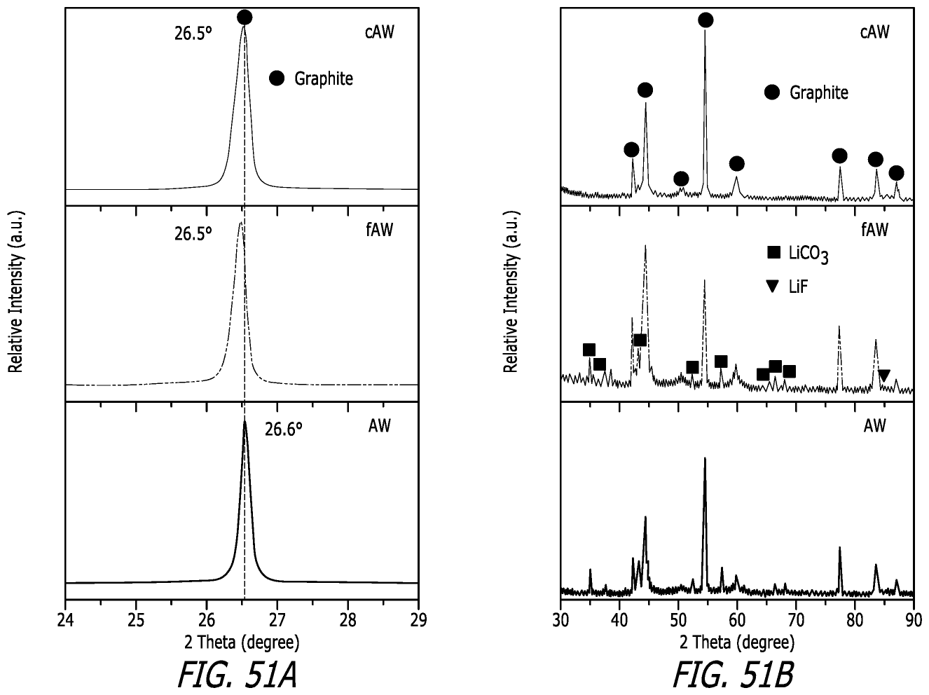

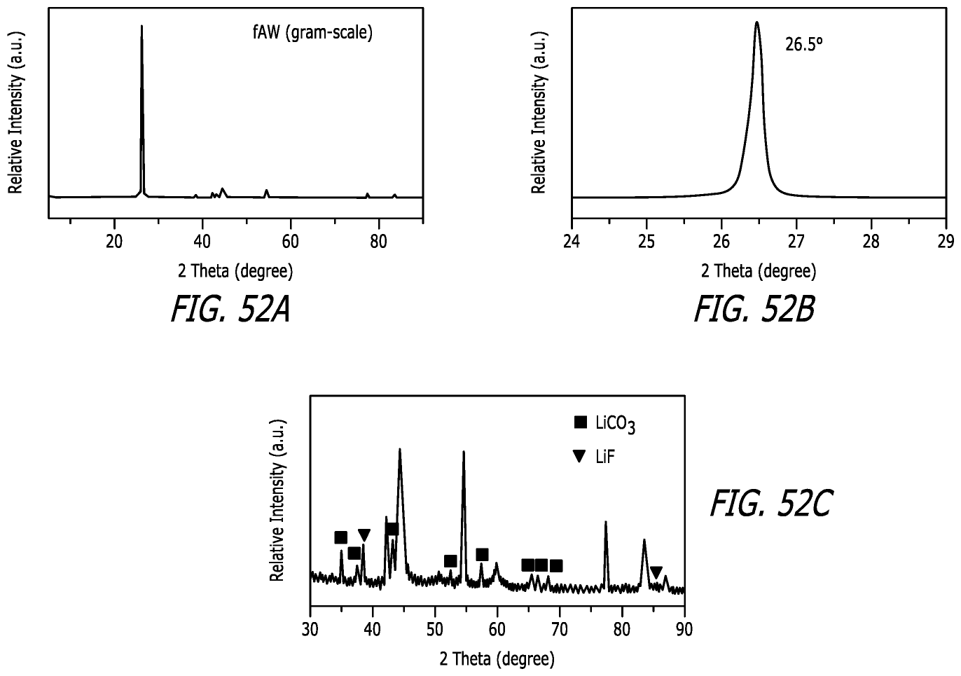

To explore the changes after flash process, the bulk crystal structures and surface/subsurface regions of the flash products are analyzed by X-ray diffraction (XRD) and X-ray photoelectron spectroscopy (XPS), respectively. The crystal structures of the flash AW (fAW) and cAW are compared with pristine AW in FIGS. 50 and 51A-51B. High temperature calcination removes most of the organic and inorganic impurities left on the pristine AW and only the diffraction peaks of graphite can be distinguished. [Advincula 2021]. The flash recycling process can decompose the SEI structure with the conversion to other species, such as LiF, which is absent in pristine AW. The (002) diffraction peaks of both cAW and fAW are centered at ˜26.5°, which indicates the interlayer distance is ˜3.36 Å and matches with the layered structure of graphite. The existence of LiF and Li₂CO₃, and the layered structure of graphite with similar interlayer distance (˜3.36 Å) are also observed for fAW synthesized from large batch (FIGS. 52A-52C).

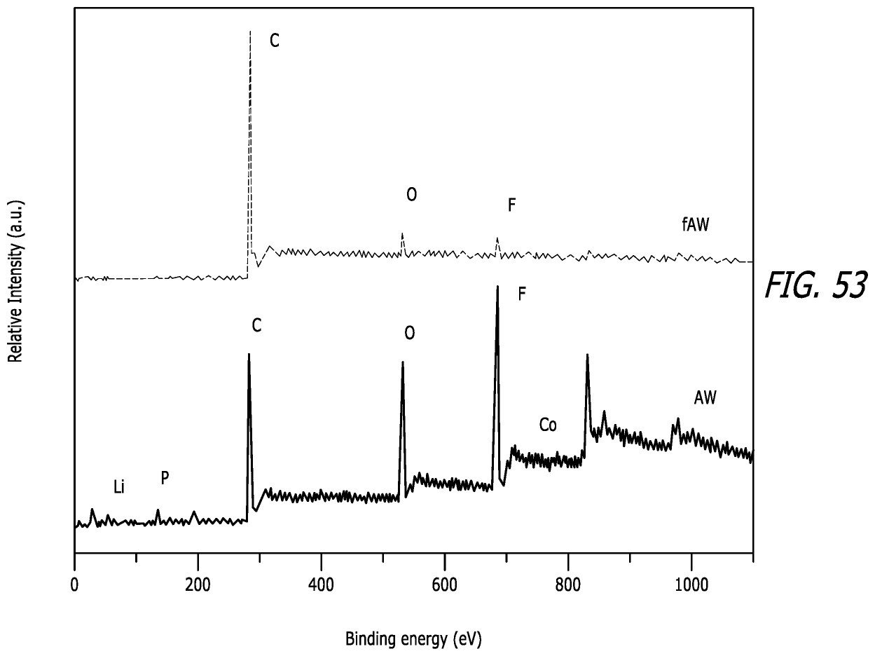

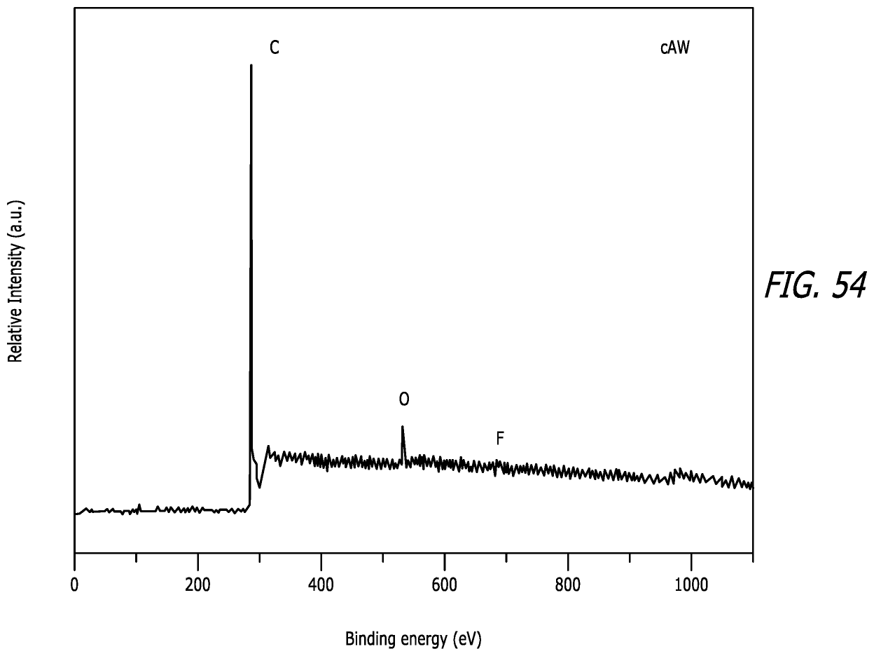

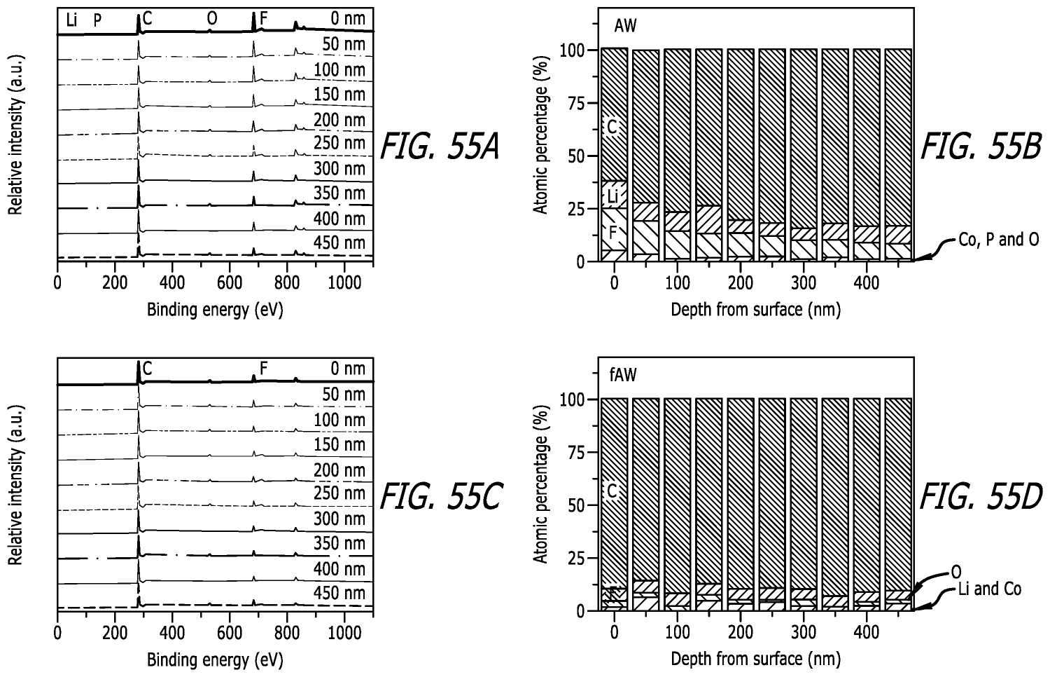

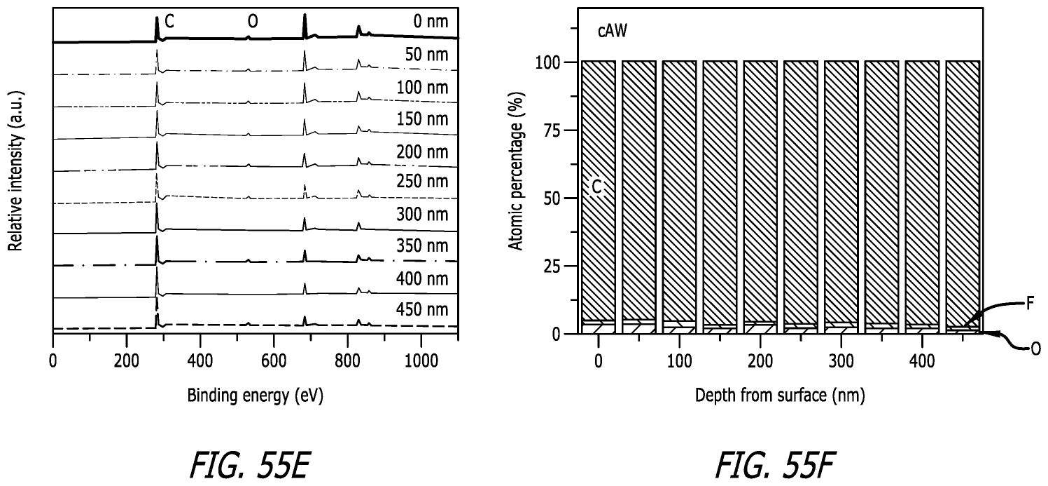

Compared to AW, which is rich in F (23.8%), O (14.4%) and P (1.9%) on the surface, fAW shows a relatively higher content of C (89.6%) and decrease of the other nonmetal elements, such as F (5.7%), O (2.9%) and P (<0.1%) (FIG. 53 and TABLE V). cAW also has a high content of C (92.8%) and reduced content of other elements, such as F (1.1%) and O (6.1%) at the surface (FIG. 54). The depth analysis of pristine AW shows the obvious ratio changes of various elements, such as Li and F from 0 to 200 nm and becomes relatively constant below 200 nm (FIGS. 55A-55F), which reflects the elemental composition and SEI atop the graphite microparticle.

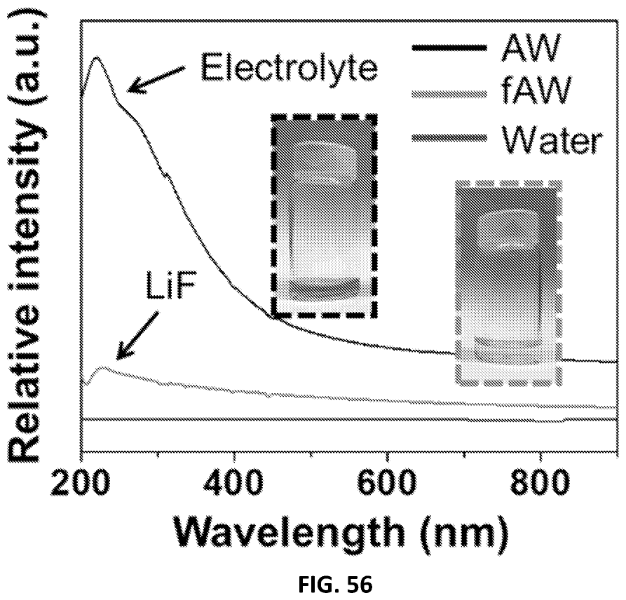

While the flash recycling process can decompose the SEI structure and modify the subsurface region, at least 500 nm of depth, reducing the content of nonmetals, including O, F and P at the surface (FIGS. 55A-55F). The reduction of nonmetal contents observed in the fAW is comparable to the results with cAW, prepared by high temperature calcination. The removal of the original organic SEI and electrolyte residue on pristine AW can be further confirmed by UV-vis spectra. After dispersing the pristine AW within deionized water, the supernatant shows yellowish color and has a broad peak centered at ˜220 nm, which could result from the oxidized carbonate electrolyte and organic SEI. [Bouteau 2019]. In comparison, fAW dispersed in water at the same concentration (˜5 mg mL⁻¹) produces a clear solution. A small transition peak located at ˜230 nm is observed from fAW, which results from the presence of LiF salt (FIG. 56). [Baldacchini 2004].

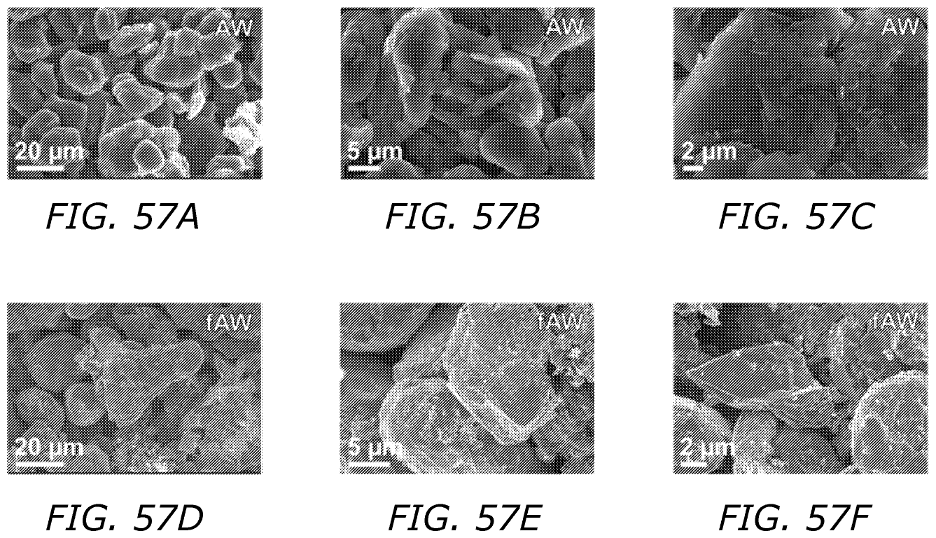

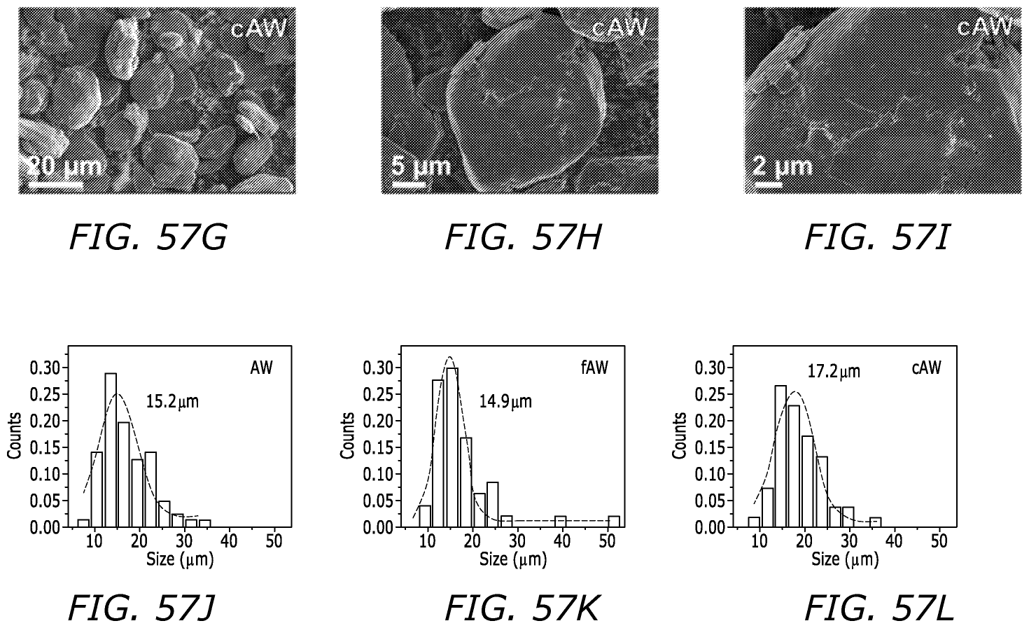

The bulk structures of the graphite microparticles are preserved and the average sizes (˜15 μm) are similar after flash recycling process as shown in scanning electron microscopy (SEM) and corresponding size distribution (FIGS. 57A-57L).

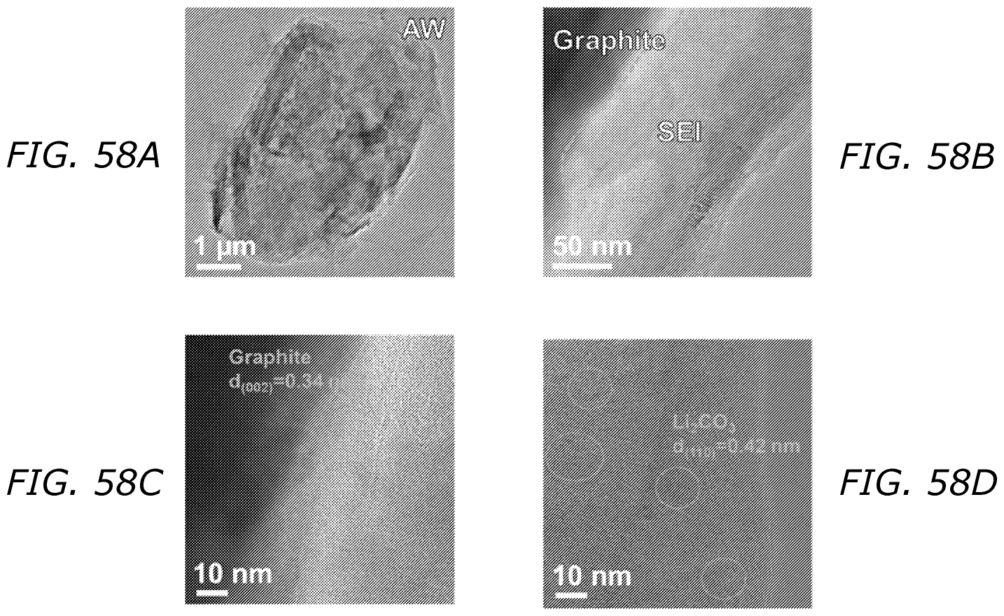

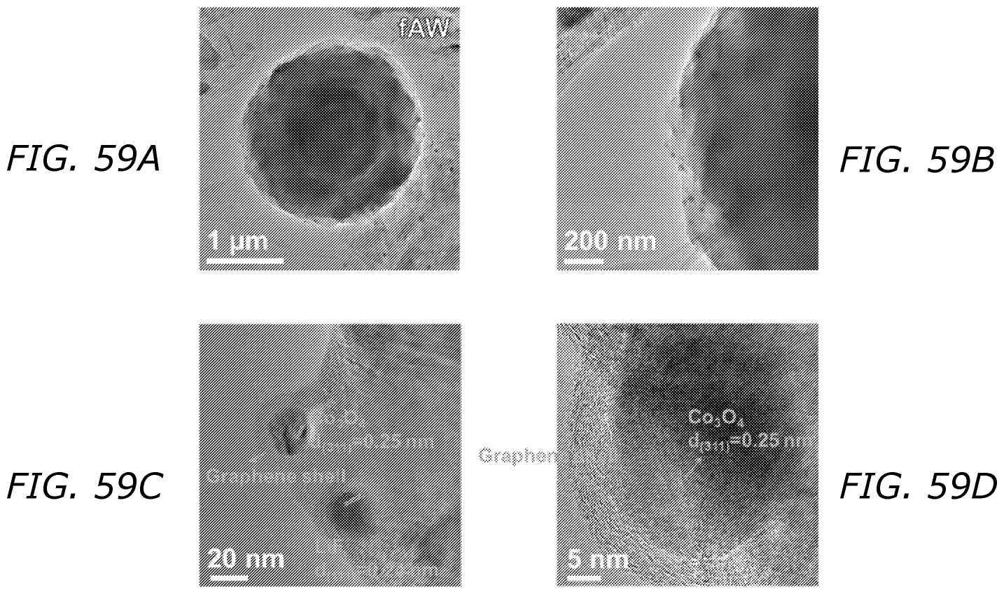

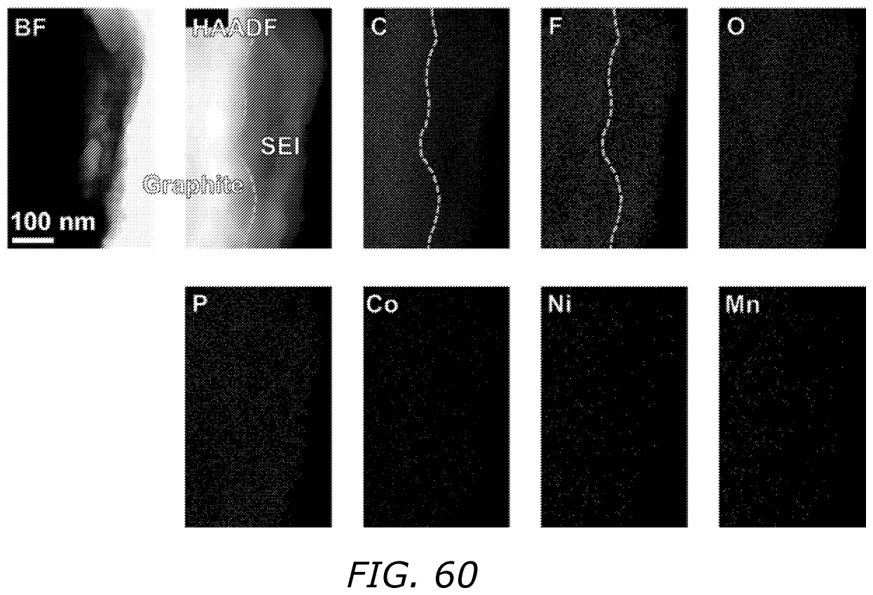

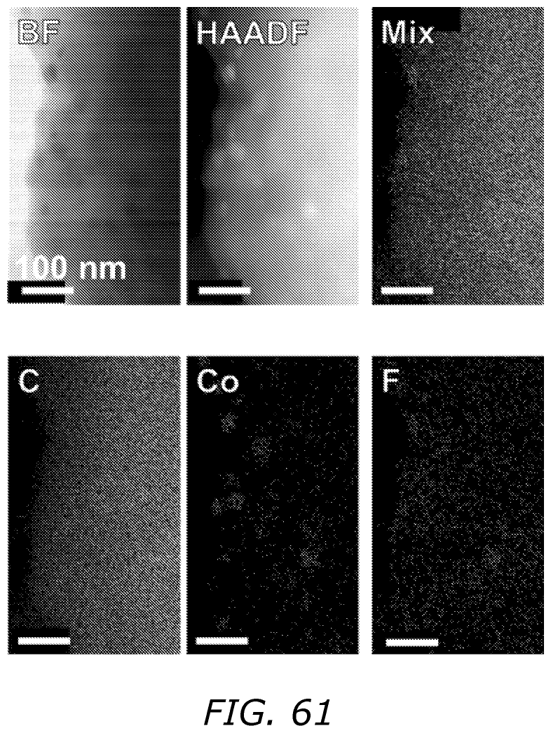

To pinpoint the change of surface structures, high resolution transmission electron microscopy (HR-TEM) is conducted as shown in FIGS. 58A-58D and 59A-59D. For AW (FIGS. 58A-58D), there is an amorphous layer outside of the graphite microparticles and the average thickness of the layer reaches ˜145 nm. The lattice fringes of graphite can be distinguished below this layer. Within the amorphous layer, there are several embedded small Li₂CO₃ crystal, which matches with the mosaic model of the SEI structure.

After the flash reaction (FIGS. 59A-59D), the SEI layer is thermally decomposed, the carbon portion is graphitized, and the average thickness shrinks to ˜65 nm. The graphene shell can be seen at the outermost region with embedded nanoparticles, such as Co₃O₄ and LiF, formed from the elements in the pristine AW SEI layer. This can be inferred by the scanning TEM (STEM) and corresponding elemental distributions result (FIGS. 60-61).

Metal Recovery

Although these metal nanoparticles and salts seem trapped by the reformed graphene layer, they can be removed by rinsing the material with diluted acid. Therefore, the valuable metals, such as Co and Li, can be recovered from fAW by simple acid post-treatment. The presence of Co within the SEI at anode side is not unexpected. Cobalt dissolution from lithiated metal oxide cathodes have been observed in cells at the end of their lifespan. [Li 2020]. As SEI traps electrolyte it would also host a concentration of dissolved Co ions, which are converted to metal oxide nanoparticles upon flash recycling.

To recover the valuable metal ions from flash products, HCl solutions with different concentrations are used for comparison. Two factors, recovery efficiency (α) and excess yield Y/Y₀ are defined to evaluate the recovery results. α is the recovery of one species (a metal from AW, fAW, or cAW) relative to the recovery done by the concentrated acid and Y/Y₀ is the yield obtained from various treated anode materials (fAW or cAW) relative to the yield obtained from pristine AW using the same recovery procedure.

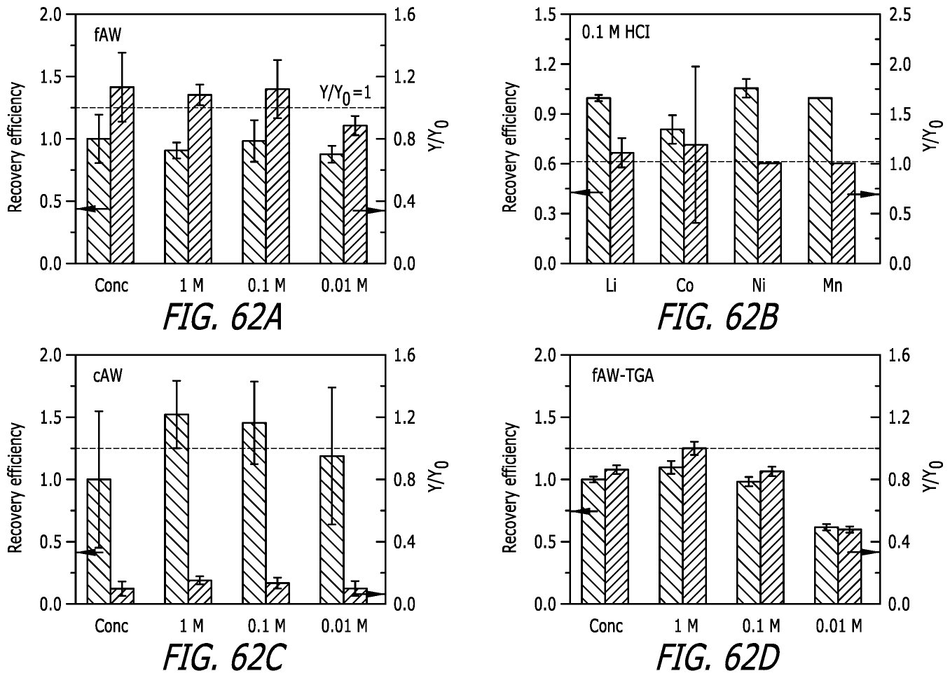

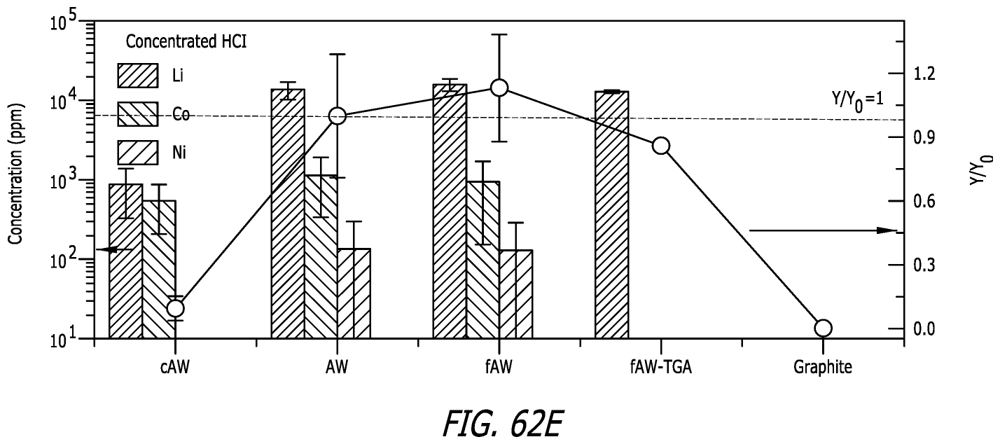

Compared with concentrated HCl (10 to 11 M) used presently in the battery recycle industry, diluted HCl (0.01˜1 M) can also effectively recollect the metal ions from the flash products and the average recovery efficiency reaches ˜97.5% by using 0.1 M HCl (FIG. 62A). The total amounts of metal ions recovered from fAW was also higher than the recovery from pristine AW, and the average excess yield was 1.12 by using 0.1 M HCl, which indicated 12% more metal ions can be collected from flash products. This result is supported by the STEM images and elemental mapping, which shows the formation of the metal oxides nanoparticles and polar salts, such as Co₃O₄ and LiF after flash reaction.

Compared with organic salts formed within the SEI, these inorganic metal oxides and polar salts can be completely dissolved in the more diluted acid solution. Therefore, the average recovery efficiencies for respective metal ions, such as Li (99.4%) and Co (80.1%) are high (FIG. 62B) even treated with 0.1 M HCl solution. The average excess yields for Li and Co were 1.10 and 1.19, which reflected that 10% more Li, and 19% more Co can be recollected from flash product than pristine AW.

By comparison, direct high temperature calcination causes the evaporation of these metal sources, which condense downstream and might be corrosive to the devices, such as metal chamber and glass pipeline. Thus, only <15% of total metal ions can be collected at different HCl solutions (FIG. 62C). TGA results show the weight percent was 10-15 wt % for pristine AW and fAW after heating under air to 1273 K, the remained solids are the main sources for different metal ions (FIG. 62D).

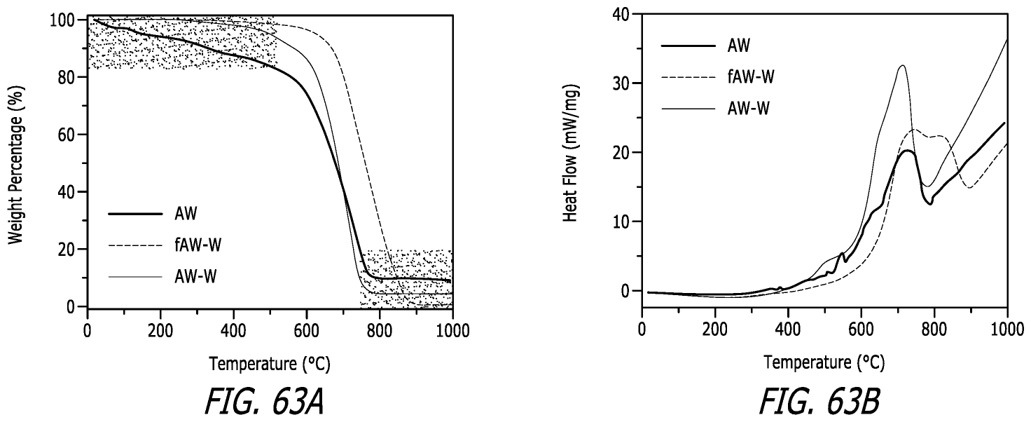

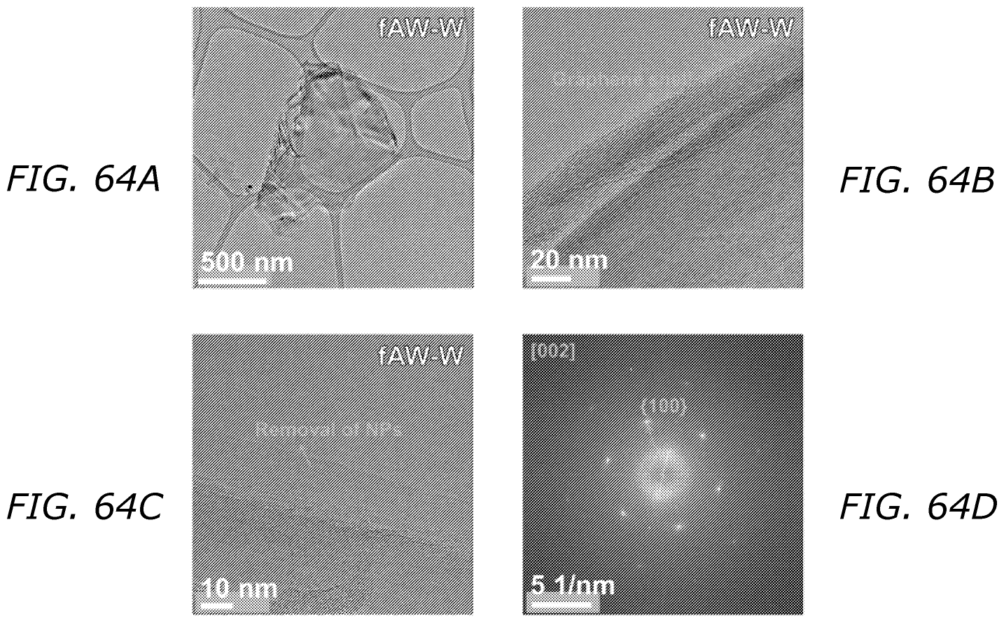

FIG. 62E shows the absolute quantities of different metal ions within the materials and compares the degrees of recovery and excess yields obtained from different recycling conditions and materials. The total concentrations of Li, Co and Ni reach 15314, 898 and 124 ppm in fAW, which are more concentrated than natural sources, such as ores and brines (100˜1000 ppm for Li) or seawater (<0.21 ppm for Li). Besides, these metal species can be easily recollected by diluted acid solution and there are little interfering ions, such as Na⁺ (˜13000 ppm for seawater), Ca²⁺, Mg²⁺ and K⁺ within the fAW. After rinsing fAW with 0.1 M HCl solution, there is little mass remained after heating under air to 1273 K and only diffraction peaks of graphite can be distinguished, which indicates effective recovery of various valuable metal ions from fAW relative to pristine AW (FIGS. 63A-63B). The HR-TEM and corresponding fast Fourier transform (FFT) results of rinsed fAW samples (fAW-W) shows the disappearance of these nanoparticles and a set of 6-fold diffraction patterns along the [002] zone axis, which confirms the recollection of various valuable metal ions and preservation of well-graphitized anode particles (FIGS. 64A-64D). Since the usage of diluted HCl solution greatly alleviates the possible corrosion to the equipment and mitigates the potential danger to operators and environment, the flash recycling method has the potential to be applied for anode regeneration and metal sources recovery.

Effectiveness

To evaluate the effectiveness of flash recycling method, the electrochemical properties of various anode materials, including bulk resistivity, rate performance and electrochemical stability, were tested. Polarization build-up during the charge and discharge process, caused by the accumulation of the SEI and surface amorphization, is one of the major reasons for anode failure. As listed in TABLE VI, the pronounced decrease (˜63%) of the bulk resistivity from AW to fAW indicates the decomposition of the resistive SEI and owing to the surface coating of fluorinated layer derived from flash process, the resistance of fAW is still larger than intrinsic graphite materials. This fluorinated layer can act as the artificial SEI layer to improve the reversibility in the first cycle, which is associated with the formation of new SEI and is a factor for electrochemical stability in the subsequent charging and discharging process.

TABLE VI
Bulk resistivity of various anode materials

| Materials | Resistivity (ohm m) |
|---|---|
| Commercial graphite | 1.2 × 10⁻⁴ |
| AW | 5.7 × 10⁻³ |
| fAW-120 V | 4.3 × 10⁻³ |
| fAW-120 V × 2 (fAW) | 2.1 × 10⁻³ |
| fAW-W | 1.1 × 10⁻³ |
| cAW | 6.3 × 10⁻⁴ |

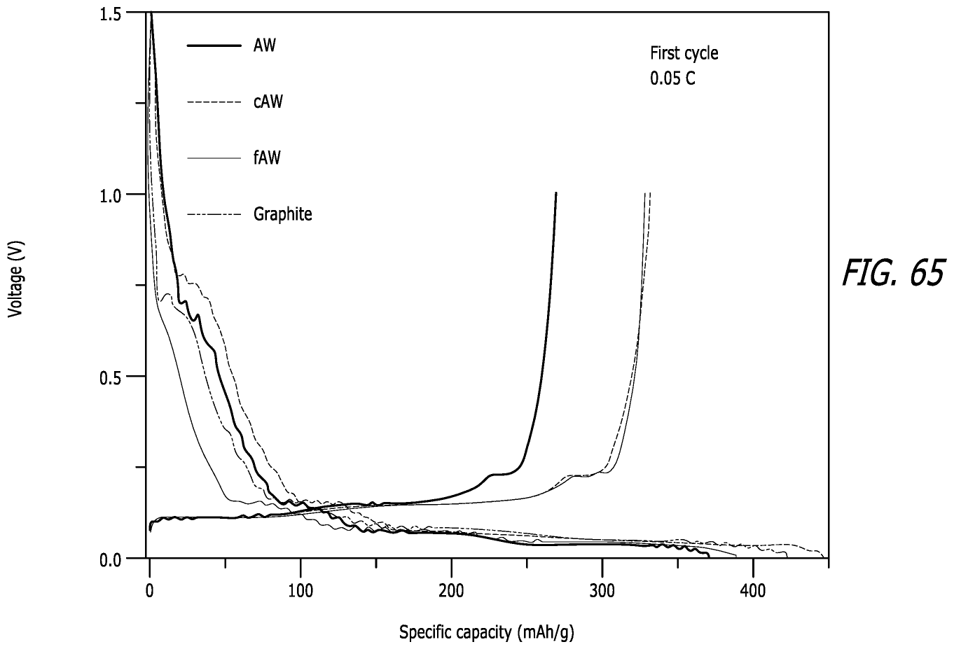

The skeletal density of the anode materials is ˜2.2 g cm⁻³. As shown in FIG. 65, the Coulombic efficiency (CE) of fAW, cAW and graphite at their first cycle are 84.4%, 74.3% and 80.3%, respectively. The areal capacities of the tested anodes are ˜3.0 mAh cm⁻². This result indicates fAW has smaller irreversible loss of electrochemically active Li species relative to cAW and commercial graphite.

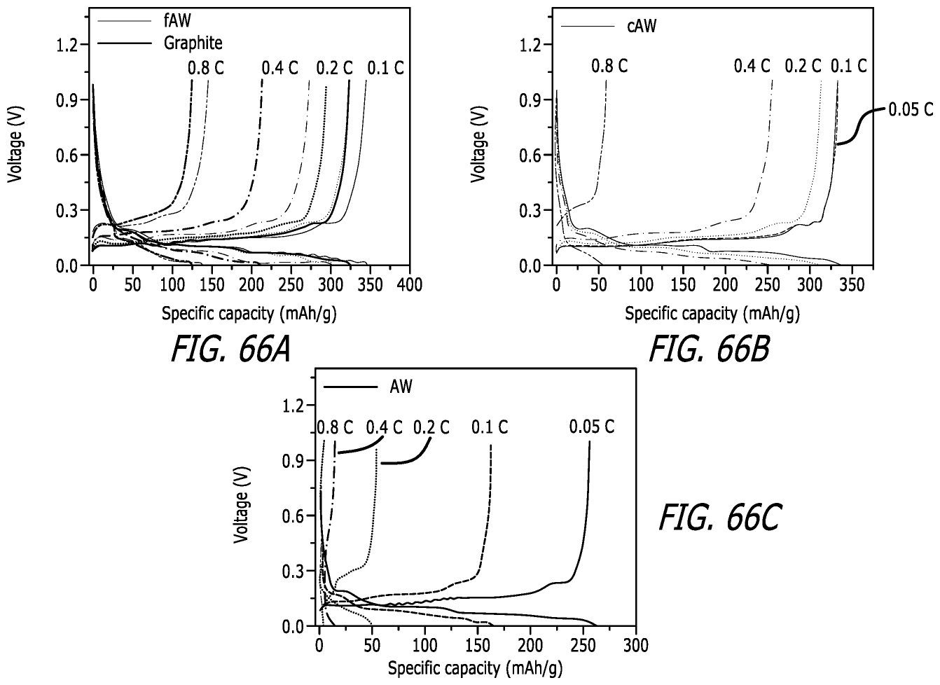

Since the reduction of solution components, including solvent and salt anions, and the simultaneous growth of SEI occurs at 0.5-1.5 V (vs. Li/Li⁺), there is the smallest irreversible capacity loss (˜20 mAh g⁻¹) for fAW, relative to AW (˜46 mAh g⁻¹) and commercial graphite (˜37 mAh g⁻¹). cAW (˜55 mAh g⁻¹) has the largest irreversible capacity loss, which is associated with CE at the first cycle. The formation of favorable SEI for fAW alleviates the cycling polarization and lowers the overpotential, especially at a larger rate (>0.5 C) compared to graphite, pristine AW and cAW (FIGS. 66A-66C).

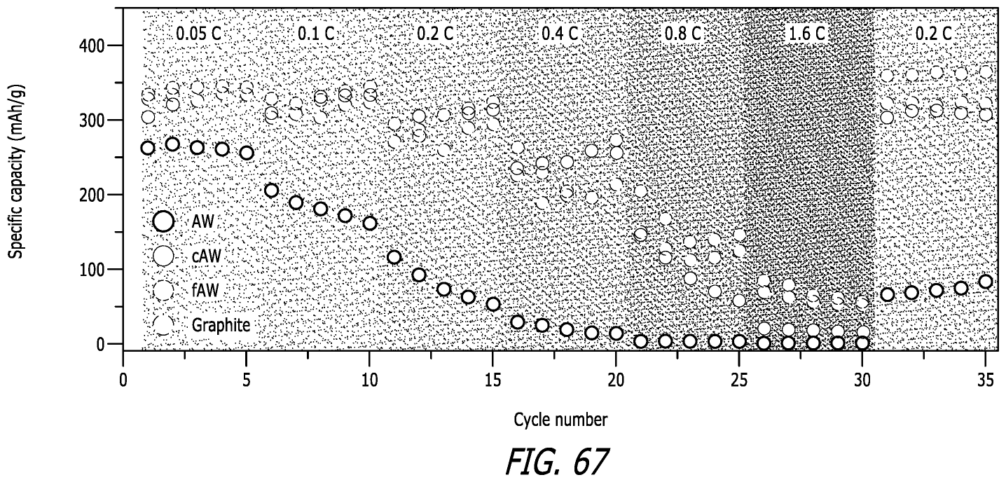

The average specific capacity of fAW is 341.5, 331.9, 233.1 and 154.1 mAh g⁻¹ at rates of 0.05 C, 0.1 C, 0.4 C and 0.8 C, respectively (FIG. 67). This result indicates the enhanced rate performance relative to pristine AW and is comparable to new graphite or cAW, owing to the removal of resistive SEI by flash procedure. Once the rate is back to 0.2 C, the fAW has a capacity of 358.9 mAh g⁻¹.

Economic and Environmental Impact

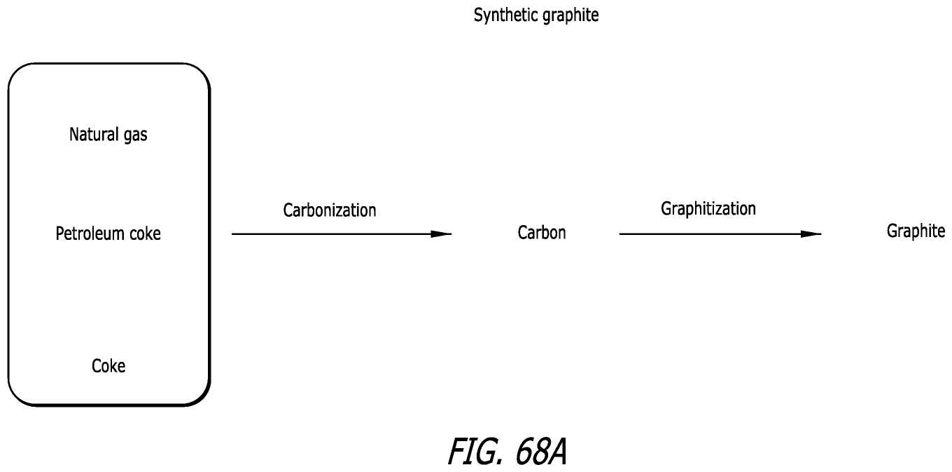

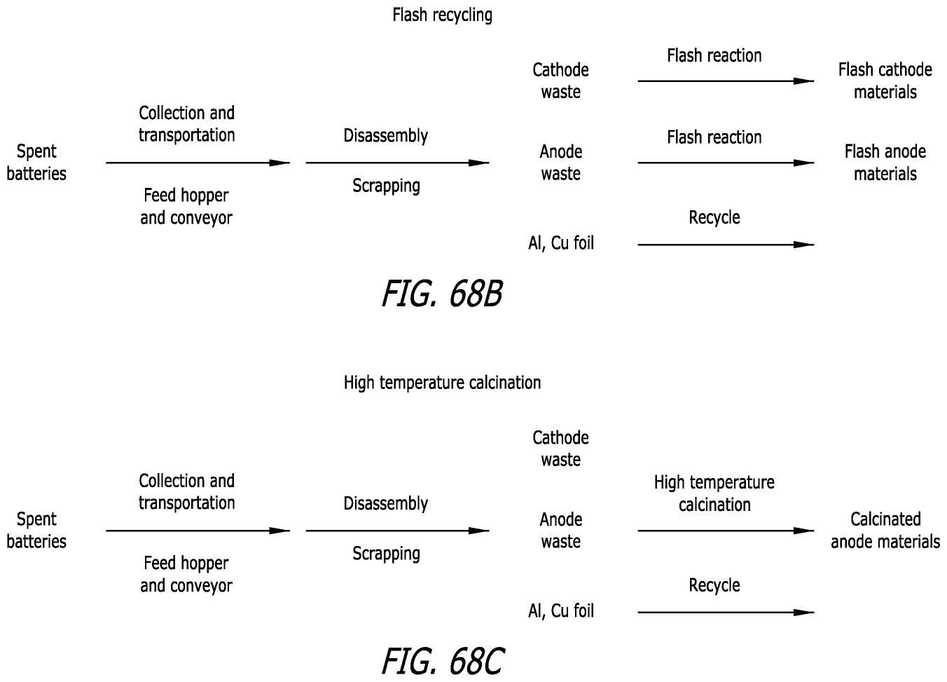

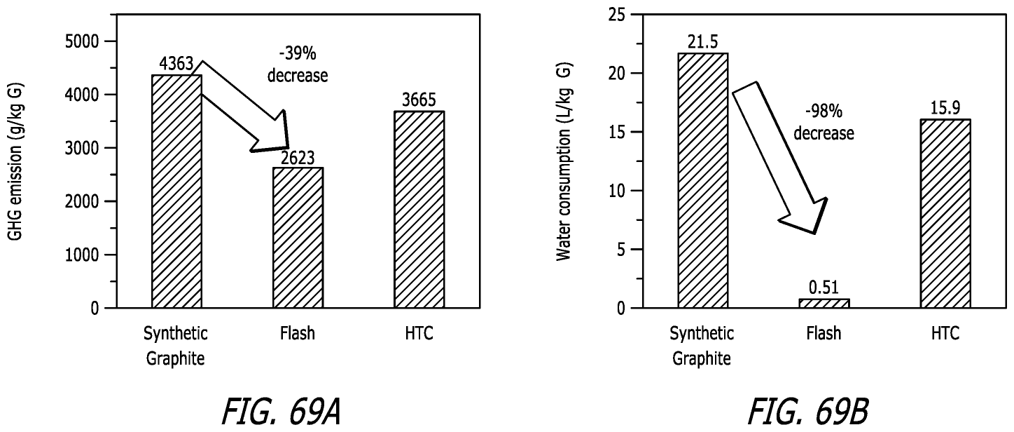

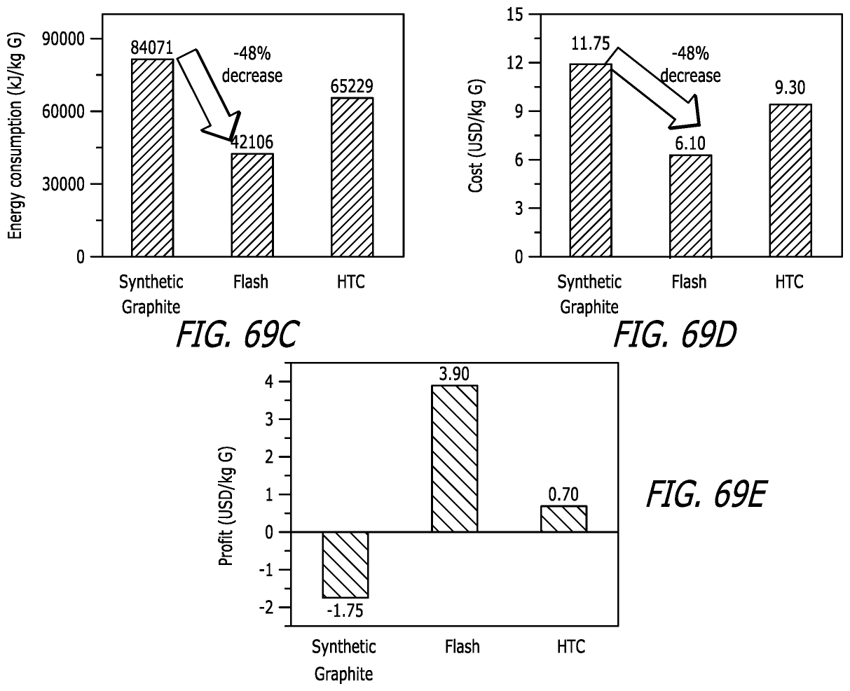

GREET 2020 and Everbatt 2020 developed by Argonne National Laboratory are used to compare the economic and environmental impacts to prepare synthetic graphite, cAW and fAW. The flow charts are shown in FIGS. 68A-68C. By providing local and momentary heating to the pristine AW, the SEI can be effectively decomposed within seconds in flash the recycling method. There is no need to carbonize or graphitize the carbonaceous materials as shown in preparing synthetic graphite, or to heat the environment for several hours by high temperature calcination methods. Therefore, the flash recycling method reduces the recycling cost by ˜48%, the GHG emissions by ˜39% the water by ˜98%, and the energy by ˜48% (FIGS. 69A-69E).

Since the average price for natural graphite material (battery grade) is ˜10 USD per kg [Advincula 2021], there is a negative profit (−1.75 USD per kg) for synthetic graphite. Therefore, the price of synthetic graphite is higher in the current market (˜20 USD per kg) and it is less competitive. By comparison, the high temperature calcination method shows a slightly positive profit (0.70 USD per kg) and flash recycling method has the highest positive profit (3.90 USD per kg), which also reflects the potential for the present methods to increase the profit margin from battery recycling.

Utilization

Spent graphite anodes can be regenerated by the ultrafast and solvent-free flash recycling methods disclosed and taught herein.

The obtained flash anode materials show intact 3D layered graphite core structure coated with solid-electrolyte interphase (SEI)-derived layer. The valuable metals, lithium, cobalt, nickel, and manganese can be easily recovered from the flash anode products by a dilute acid post-treatment. The flash anode materials show the recovered electrochemical performance, compared with anode waste and new commercial graphite.

Life-cycle analysis against current calcination method highlights that flash recycling method can significantly reduce the total energy and greenhouse gas emissions while turning it into an economically advantageous process.

The formation of coating structure around graphite microparticles shows the feasibility about preparing the core-shell or other hierarchical topological structure by a solvent-free flash method within seconds.

In embodiments, the electrolyte can be removed from the anode material as well as the separator and current collector. In other embodiments one or more of the electrolyte, separator, and current collector can be retained and flashed with the anode materials in the mixture.

### Destroying 3D Morphology of The Cathode

In some embodiments as discussed and described above, the 3D structure of the cathode can be maintained during the flash Joule heating. However, in some circumstances, there is no care to retain the 3D structure of the cathode, such as because the former 3D structure is no longer compatible with the newer battery technologies. This can be especially the circumstance because battery designs tend to be upgraded every two to three years. In such circumstances (when there is no need to retain the 3D morphology), the only desire would be to easily obtain the metals, Li, Co, plus Mn, Ni, and Cu, as well as other metals as applicable.

It has been discovered that by using a flash Joule heating pulse that is higher in current than previously used and described, this will form easily dissolved metal oxides, while decomposing the 3D cathode morphology. The reuse of valuable metals such as Li, Co, Mn and Ni, reduces the need for mining from ores, and protects the environment. Moreover, acid concentration is far less than required by typical hydrometallurgical recycling, and the energy requirements are far less than those needed for pyrometallurgical recycling. Still further, such higher current FJH method can obtain the lithium salts, unlike the pyrometallurgical methods (described hereinabove) afford. Formerly, when retaining the 3D structure of the cathode, 120 V and 30 A for 150 milliseconds to 300 milliseconds was utilized, and this used 10 wt % conductive carbon additive. Using the same flash vessel size, to destroy the 3D cathode structure, leaving the more easily dissolved metals in the flash vessel, substantially as metal oxides and metal(0), was performed by increasing the conditions to 120 V and 90 A to 100 A for 500 milliseconds while using 33.3 wt % conductive carbon additive. Using the same vessel size, volatilizing out the metals from the flash container and into a trap can be obtained by utilizing 120 V at approximately 200 A to 300 A for 500 ms to 1 second, using 33.3 wt % carbon additive.

Such high current FJH method can decompose the cathode materials into simple metal oxides and even metal(0), which are easy to dissolve in dilute acids such as 0.1 M HCl and even 0.01 M HCl. This acid is far less corrosive than the reagents used in current hydrometallurgical methods, such as 12 M HCl and peroxides and NaOH rinses.

By way of comparison, FJH was performed under conditions (A) to retain the 3D structure and (B) destroy the 3D structure. For the former (flash conditions to retain the 3D structure), the conditions were 10 wt % conductive carbon added, 120 V, 30 Amps, 300 ms flash time for LCO and 150 ms for NMC, and magnetic extraction of the desired contents. For the latter (flash condition to destroy the 3D structure), the conditions were 33 wt % conductive carbon added, 120 V, 100 Amps, 500 ms flash time for both LCO and NMC, no magnetic extraction, instead the contents are rinsed with dilute acid to obtain the desired metal oxides.

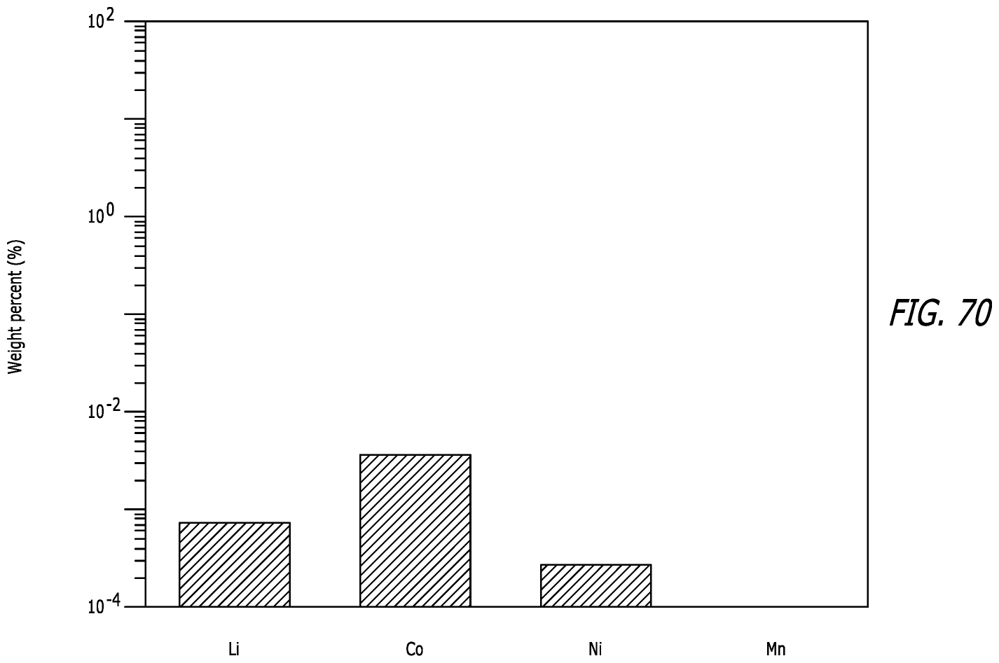

The FJH method provided rapid electrical energy within 500 ms thereby avoiding the weight loss of metals with a low boiling point, such as Li. The metal contents in the flash Joule heating reactor remained in the reactor when the graphite electrode spacers were snuggly fitting. Loss of the metals by sublimation was not a problem as seen in FIG. 70.

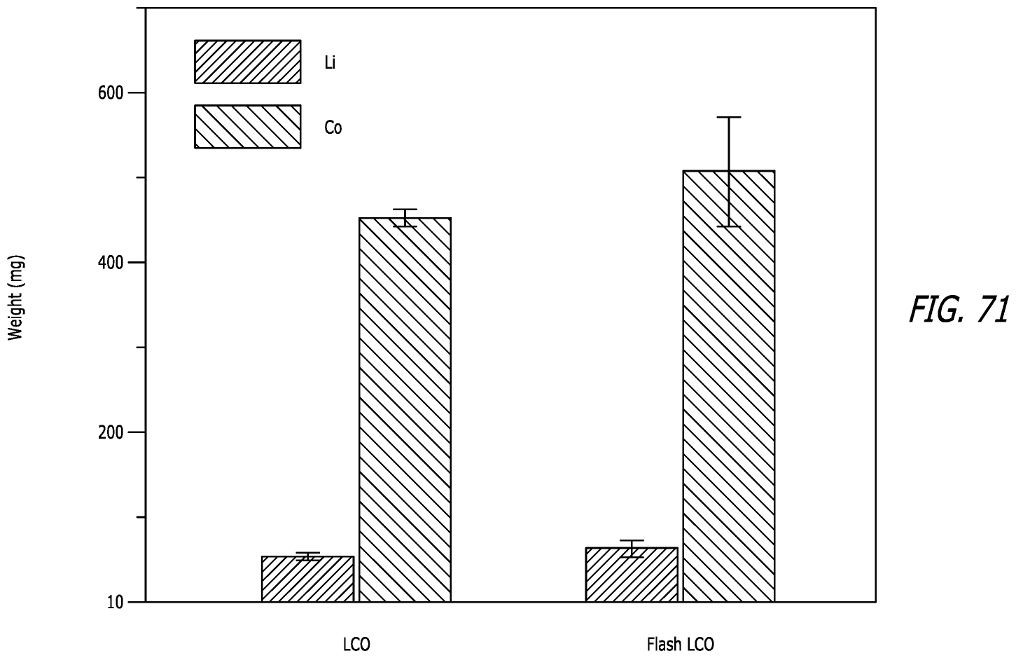

The total amounts of Li and Co from LCO and flash LCO were measured by leaching with concentrated HCl solutions. After flash treatment, the Li and Co recovery ratio were ˜100% as shown in FIG. 71, which indicated there was no obvious metal loss by FJH treatment.

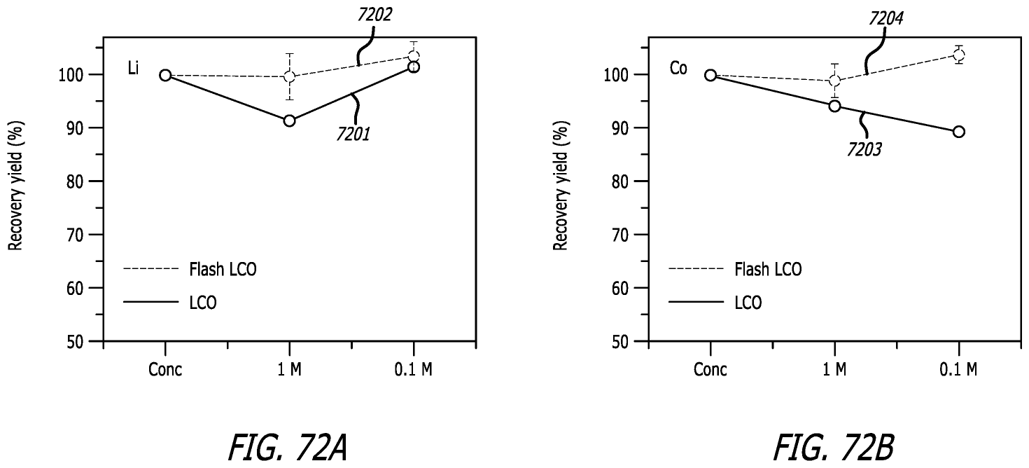

Different concentrations of HCl were used to leach the metal salts, and the recovery efficiencies are compared in FIGS. 72A-72B. As shown in FIG. 72A, for Li, by changing the concentration, Li can be effectively recovered from LCO and flash LCO (curves 7201-7202, respectively) with an efficiency >90%, and a slightly higher efficiency can be seen from flash LCO. As shown in FIG. 72B, for Co, as the concentration of the acid decreases, the recovery efficiency decreases in LCO (curves 7203-7204, for LCO and flash LCO, respectively).

However, the efficiency of Co does not decrease for flash LCO.

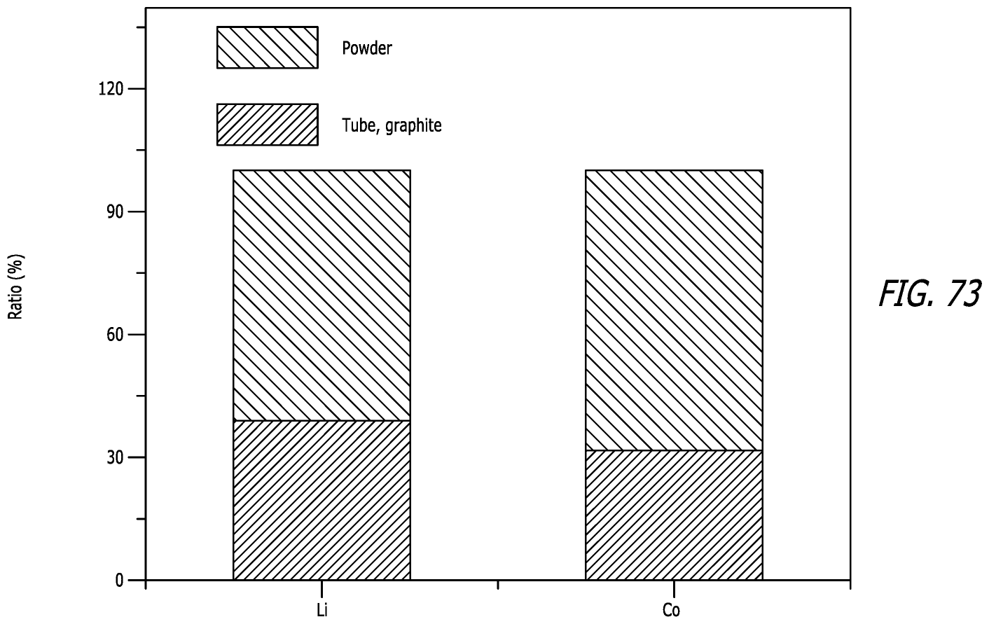

The distribution of the metal after FJH was also analyzed separately from the powdered FJH product in the chamber, the quartz tube cell, and the graphite electrodes. See FIG. 73. ˜30% of the metal ions adhered to the quartz tube and graphite and the remaining 70% was within the powdered product.

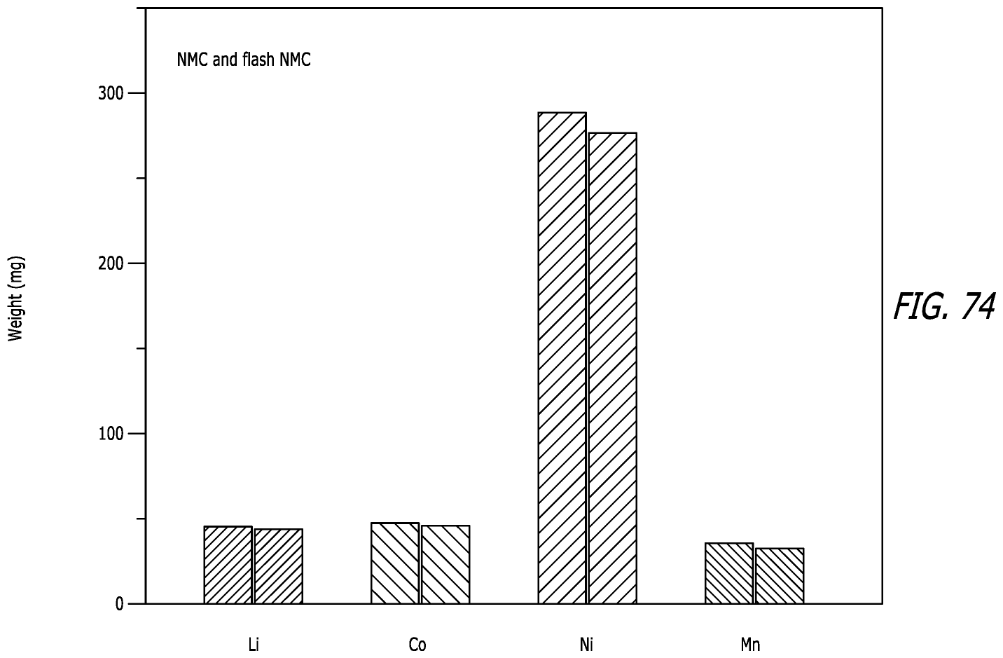

The total amounts of Li, Co, Ni and Mn from NMC and flash NMC were also measured by leaching with concentrated HCl solutions. After flash treatment, the Li, Co, Ni and Mn recovery ratio could be ˜100%, as shown in FIG. 74, which indicated there was no obvious metal loss by FJH treatment. Note that a quartz tube is only used here as a convenient transparent vessel for the research scale. Upon scaling, quartz tubes would typically not be used due to their cost and fragility. Other reactor cells would be used, such as ceramic, concrete, and high temperature concrete. Teflon and polyphenenylene sulfide tubes, which are high-temperature-stable plastics, can even be used since the electrical current does not pass through these insulating materials so that their temperature increase is little.

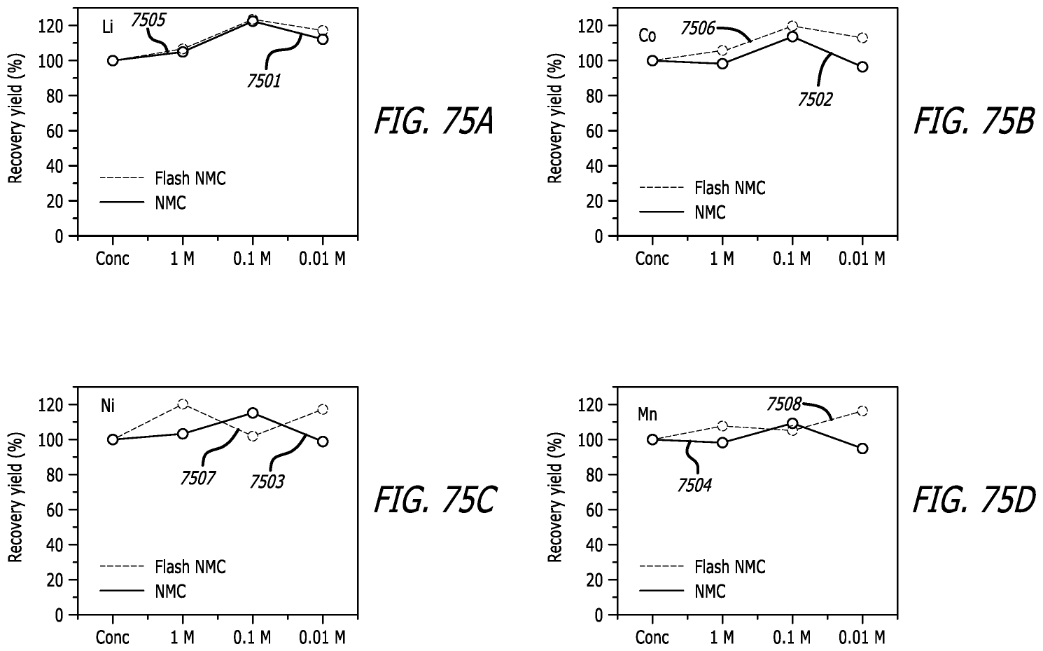

In FIGS. 75A-75D, curves 7501-7504 show, respectively, the recovery yield of Li, Co, Ni and Mn from NMC in HCl solutions with different concentrations, and curves 7505-7508 show, respectively, the recovery yield of Li, Co, Ni and Mn from flash NMC in HCl solutions with different concentrations. These curves reveal that 0.1 M HCl was sufficient to remove the metal salts from the flashed cathodes.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1 of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### Abbreviations

Abbreviations used throughout this application are further provided below.
AW: Anode Waste
cAW: Calcinated AW
CB: Carbon black
CEI: Cathode electrolyte interphase
CW: Cathode waste
fAW: Flash AW
fCW: Flash CW
fLCO: Flash LCO
fNMC: Flash NMC
FJH: Flash Joule heating
GHG: Greenhouse gas
Hydro: Hydrometallurgical
LCA: Life cycle analysis
LCO: Lithium cobalt oxide (LiCoO₂)
LIB: Li-ion battery
NMC: Lithium nickel-manganese-cobalt oxide (LiNiₓMn_{y}Co_{z}O₂, normally referred as NMCxyz, such as NMC811)
R-CW: Resynthesized cathode material
Pyro: Pyrometallurgical
SEI: solid electrolyte interphase

It should be noted that the nomenclature for the terms “LCO” and “NMC” utilized herein is consistent with the terminology used in the art. For cathodes of lithium cobalt oxide, the term LCO includes lithium within the acronym. However, for cathodes of lithium nickel-manganese-cobalt oxide, the term NMC does not include lithium within the acronym. To avoid any confusion, as used herein, the term “NMC” is synonymous with the terms “Li-NMC” and “LNMC,” which are examples of alternative terms used in the art for lithium nickel-manganese-cobalt oxide (used in cathodes). In the battery fully charged state, much of the lithium resides in the anode. In the battery discharged state, much of the lithium resides in the cathode and little in the anode. So the quantity of lithium in the cathode depends on the state of the charge. In general, batteries would be discharged before recycling. This would drive most of the lithium ions into the cathode. Hence, in the case of NMC cathodes, it would contain much lithium upon battery discharge and could be described well as lithium nickel manganese cobalt. In the case of LCO, a portion of the lithium migrates from the cathode to the anode. But even in the battery fully charged state, there is always some lithium residing with the cathode, and this is especially true in LCO structures.

### REFERENCES

Advincula, P. A., et al., “Flash Graphene from Rubber Waste,” Carbon, 2021, 178, 649-656 (“Advincula 2021”).
Algozeeb, W. A., et al., “Flash Graphene From Plastic Waste,” ACS Nano, 2020, 14, 15595-15604 (“Algozeeb 2020”).
Andre, D., et al. “Future Generations Of Cathode Materials: An Automotive Industry Perspective,” J. Mater. Chem. A, 2015, 3, 6709-6732 (“Andre 2015”).
Apátiga, L. M., et al., “Magnetic Behavior Of Cobalt Oxide Films Prepared By Pulsed Liquid Injection Chemical Vapor Deposition From A Metal-Organic Precursor,” Thin Solid Films, 2006, 496, 576-579 (“Apátiga 2006”).
Assefi, M., et al., “Pyrometallurgical Recycling Of Li-Ion, Ni—Cd And Ni-MH Batteries: A Minireview,” Curr. Opin. Green Sustain. Chem., 2020, 24, 26-31 (“Assefi 2020”).
Baldacchini, G., et al., “Point defects in lithium fluoride by EUV and soft X-rays exposure for X-ray microscopy and optical applications,” IEEE J. Sel. Top. Quantum Electron, 2004, 10, 1435 (“Baldacchini 2004”).
Beyer, H., et al., “Thermal And Electrochemical Decomposition Of Lithium Peroxide In Non-Catalyzed Carbon Cathodes For Li-Air Batteries,” Phys. Chem. Chem. Phys., 2015, 15, 11025-11037 (“Beyer 2013”).
Bouteau, G., et al., “Effect of standard light illumination on electrolyte's stability of lithium-ion batteries based on ethylene and di-methyl carbonates,” Sci. Rep. 2019, 9, 135 (“Bouteau 2019”).
Chagnes, A., et al., “A Brief Review On Hydrometallurgical Technologies For Recycling Spent Lithium-Ion Batteries,” J. Chem. Technol. Biotechnol., 2013, 88, 1191-1199 (“Chagnes 2013”).
Chen, X., et al., “Sustainable Recovery Of Metals From Spent Lithium-Ion Batteries: A Green Process,” ACS Sustain. Chem. Eng., 2015, 3, 3104-3113 (“Chen 2015”).
Chen, W., et al., “Millisecond Conversion Of Metastable 2D Materials By Flash Joule Heating,” ACS Nano, 2021, 15, 1282-1290 (“Chen 2021”).
Chen, W., et al., “Laser-Induced Silicon Oxide For Anode-Free Lithium Metal Batteries,” Adv. Mater., 2020, 32, 2002850 (“Chen 2020”).
Dai, T., et al., “Synergy Of Lithium, Cobalt, And Oxygen Vacancies In Lithium Cobalt Oxide For Airborne Benzene Oxidation: A Concept Of Reusing Electronic Wastes For Air Pollutant Removal,” ACS Sustain. Chem. Eng., 2019, 7, 5072-5081 (“Dai 2019”).
Everbatt 2020: Dai, Q., et al., “A Closed-Loop Battery Recycling Cost And Environmental Impacts Model,” Argonnee National Laboratories, Energy Division, 2019, ANL-19/16 (“Everbatt 2020”).
Furushima, Y., et al., “Thermal Stability And Kinetics Of Delithiated LiCoO₂,” J. Power Sources, 2011, 196, 2260-2263 (“Furushima 2011”)).
GREET 2020: Wang, M., et al., “Summary of Expansions and Updates in GREET 2020,” Argonnee National Laboratories, Energy Systems Division, 2020, ANL/ESD-20/9 (“GREET 2020”).
He, L.-P., et al., “Recovery Of Lithium, Nickel, Cobalt, And Manganese From Spent Lithium-Ion Batteries Using L-Tartaric Acid As A Leachant,” ACS Sustain. Chem. Eng., 2016, 5, 714-721 (“He 2016”).
Hu, X., et al., “Recovery Of Co, Ni, Mn, And Li From Li-Ion Batteries By Smelting Reduction—Part J: A Laboratory-Scale Study,” J. Power Sources, 2021, 483, 228936 (“Hu 2021”).
Jacoby, M, “It's Time To Get Serious About Recycling Lithium-Ion Batteries,” Chem. Eng. News, 2020, 97 (“Jacoby 2020”).
Kabir, M., et al., “Degradation Mechanisms In Li-Ion Batteries: A State-Of-The-Art Review,” Int. J. Energy Res., 2017, 41, 1963-1986 (“Kabir 2017”).
Lee, C. K., et al., “Preparation Of LiCoO₂ From Spent Lithium-Ion Batteries,” J. Power Sources, 2002, 109, 17-21 (“Lee 2002”).
Li, J., et al., “Environmentally-Friendly Oxygen-Free Roasting/Wet Magnetic Separation Technology For In Situ Recycling Cobalt, Lithium Carbonate And Graphite From Spent LiCoO₂/Graphite Lithium Batteries,” J. Hazard. Mater., 2016, 302, 97-104 (“Li 2016”).
Li, L., et al., “Sustainable Recovery Of Cathode Materials From Spent Lithium-Ion Batteries Using Lactic Acid Leaching System,” ACS Sustain. Chem. Eng., 2017, 5, 5224-5233 (“Li 2017”).
Li, S., et al., “Structural Distortion-Induced Charge Gradient Distribution Of Co Ions In Delithiated Licoo₂ Cathode,” J. Phys. Chem. Lett., 2019, 10, 7537-7546 (“Li 2019”).
Li, W., “Review—An Unpredictable Hazard in Lithium-ion Batteries from Transition Metal Ions: Dissolution from Cathodes, Deposition on Anodes and Elimination Strategies,” J. Electrochem. Soc., 2020, 167, 090514 (“Li 2020”).
Luong, D. X., et al., “Gram-scale Bottom-Up Flash Graphene Synthesis,” Nature, 2020, 577, 647-651 (“Luong 2020”).
Lv, W., et al., “A Critical Review And Analysis On The Recycling Of Spent Lithium-Ion Batteries,” ACS Sustain. Chem. Eng., 2018, 6, 1504-1521 (“Lv 2018”).
Moro, F., et al., “Magnetic properties of cobalt oxide nanoparticles synthesised by a continuous hydrothermal method. J Magn. Magn, 2013, 348, 1-7 (“Moro 2013”).
Natarajan, S., et al., “Recycling Strategies For Spent Li-Ion Battery Mixed Cathodes,” ACS Energy Lett., 2018, 3, 2101-2103 (“Natarajan 2018”).
Nie, H., et al., “LiCoO₂: Recycling From Spent Batteries And Regeneration With Solid State Synthesis,” Green Chem., 2015, 17, 1276-1280 (“Nie 2015”).
Pinna, E. G., et al., “Cathodes Of Spent Li-Ion Batteries: Dissolution With Phosphoric Acid And Recovery Of Lithium And Cobalt From Leach Liquors,” Hydrometallurgy, 2017, 167, 66-71 (“Pinna 2017”).
“Recycle Spent Batteries,” Nat. Energy, 2019, 4, 253-253 (“Recycle 2019”).
Salvatierra, R. V., et al., “What Can Be Expected From ‘Anode-Free’ Lithium Metal Batteries?” Adv. Energy Sustain. Res., 2021, 2, 202000110 (“Salvatierra 2021”).
Sharifi-Asl, S., et al., “Facet-Dependent Thermal Instability In LiCoO₂,” Nano Lett, 2015, 17, 2165-2171 (“Sharifi-Asl 2017”).
Swain, B., et al., “Hydrometallurgical Process For Recovery Of Cobalt From Waste Cathodic Active Material Generated During Manufacturing Of Lithium Ion Batteries,” J. Power Sources, 2007, 167, 536-544 (“Swain 2007”).
Tran, M. K., et al., “Deep Eutectic Solvents For Cathode Recycling Of Li-Ion Batteries,” Nat. Energy, 2019, 4, 339-345 (“Tran 2019”).
Universal Matter, “Scaleup Of FJH For Graphene Synthesis,” from domain name www.universalmatter.com, 2021 (“Universal Matter 2021”).
Velázquez, M., et al., “A Critical Review Of Lithium-Ion Battery Recycling Processes From A Circular Economy Perspective,” Batteries, 2019, 5, 68 (“Velázquez 2019”).
Wang, D., et al., “Separation Of Li And Co From The Active Mass Of Spent Li-Ion Batteries By Selective Sulfating Roasting With Sodium Bisulfate And Water Leaching,” Miner. Eng., 2018, 126, 28-35 (“Wang 2018”).
Xiao, J., et al., “Recycling Metals From Lithium Ion Battery By Mechanical Separation And Vacuum Metallurgy,” J. Hazard. Mater., 2017, 338, 124-131 (“Xiao 12017”).
Xiao, J., et al., “Novel Approach For In Situ Recovery Of Lithium Carbonate From Spent Lithium Ion Batteries Using Vacuum Metallurgy,” Environ. Sci. Technol., 2017, 51, 11960-11966 (“Xiao II 2017”).
Xu, P., et al., “Efficient Direct Recycling Of Lithium-Ion Battery Cathodes By Targeted Healing,” Joule, 2020, 4, 2609-2626 (“Xu 2020”).
Yu, H., et al., “Mechanistic insights into the lattice reconfiguration of the anode graphite recycled from spent high-power lithium-ion batteries,” J. Power Sources, 2021, 481, 229159 (“Yu 2021”).
Zhang, C., et al., “Closed-Edged Graphene Nanoribbons From Large-Diameter Collapsed Nanotubes,” ACS Nano, 2012, 6, 6023-6032 (“Zhang 2012”).
Zhang, D., et al., “Controllable Fabrication And Magnetic Properties Of Double-Shell Cobalt Oxides Hollow Particles,” Sci. Rep., 2015, 5, 8737 (“Zhang 2015”).
Zhang, P., et al., “Hydrometallurgical Process For Recovery Of Metal Values From Spent Lithium-Ion Secondary Batteries,” Hydrometallurgy, 1998, 47, 259-271 (“Zhang 1998”).
Zhang, Z., et al., “Recovery Of Lithium Cobalt Oxide Material From The Cathode Of Spent Lithium-Ion Batteries,” ECS Electrochem. Lett., 2014, 3, A58-A61 (“Zhang 2014”).
Zhao, Y., et al., “Regeneration And Reutilization Of Cathode Materials From Spent Lithium-Ion Batteries,” Chem. Eng. J., 2020, 383, 123089 (“Zhao 2020”).
Zou, H., et al., “A Novel Method To Recycle Mixed Cathode Materials For Lithium Ion Batteries,” Green Chem., 2013, 15, 1183 (“Zou 2013”).

1. A method of recovering metal, wherein the method comprises:
(a) forming a mixture comprising a cathode material, wherein the cathode material is prepared from one or more batteries;
(b) applying a voltage across the mixture to obtain metals and cathode waste from the cathode material, wherein
(i) the voltage is applied in one or more voltage pulses, and
(ii) duration of each of the one or more voltage pulses is for a duration period; and
(c) magnetically separating the metal and the cathode waste.

2. The method of claim 1, wherein the metal comprises cathode metal selected from the group consisting of lithium, cobalt, nickel, manganese, iron, and combinations thereof.

3. The method of claim 1, wherein the metal comprises cathode metal selected from the group consisting of be metal oxides, metal salts, metal carbonates, metal phosphates, and combinations thereof.

4. The method of claim 3, wherein the cathode metal comprises metal oxide.

5. The method of claim 4, wherein the metal oxide comprises cobalt oxide.

6. The method of claim 3, wherein the cathode metal comprises metal carbonate.

7. The method of claim 6, wherein the metal carbonate comprises lithium carbonate.

8. The method of claim 3, wherein the cathode metal comprises metal phosphate.

9. The method of claim 8, wherein the metal phosphate comprises iron phosphate.

10. (canceled)

11. The method of claim 1, wherein the one or more batteries comprise one or more lithium-ion batteries.

12. The method of claim 11, wherein the one or more lithium-ion batteries comprise lithium-ion batteries each having a lithium cobalt oxide (LCO) cathode or a lithium nickel-manganese-cobalt oxide (NMC) cathode.

13. The method of claim 12, wherein each of the one or more lithium-ion batteries each comprise an LCO cathode.

14. The method of claim 12, wherein each the one or more lithium-ion batteries each comprise an NMC cathode.

15-18. (canceled)

19. The method of claim 1, wherein the mixture further comprises a conductive additive.

20-56.

57. The method of claim 1, wherein the method preserves the 3D layer structure of the cathodes in the cathode material.

58. The method of claim 1, wherein the method preserves the 3D morphology of the cathodes in the cathode material.

59. The method of claim 1, wherein the method destroys the 3D morphology of the cathodes in the cathode material.

60. The method of claim 1 further comprising a cooling step, wherein the cooling step cools the metals and the cathode waste before the step of magnetically separating the metals and the cathode waste.

61-62. (canceled)

63. The method of claim 1, wherein the method further comprises, after the step of mechanical separating, applying a second voltage across the cathode waste, wherein
(a) the second voltage is applied in one or more second voltage pulses; and
(b) duration of each of the one or more second voltage pulses is for a second duration period.

64. (canceled)

65. The method of claim 63, wherein
(a) the applying of the second voltage across the cathode waste obtains further metals and a reduced portion of the cathode waste, and
(b) the method further comprises magnetically separating the additional metals and the reduced portion of the cathode waste.

66. The method of claim 65, wherein the further metals and reduced portion of the cathode waste are at a weight ratio of at least 1:1.

67-85. (canceled)

86. A system for performing the method of recovering metal utilizing the method of claim 1, wherein the system comprises:
(a) a source of the mixture comprising the cathode material;
(b) a cell operably connected to the source such that the mixture can be flowed into the cell and held under compression;
(c) electrodes operatively connected to the cell;
(d) a flash power supply for applying a voltage across the mixture to obtain metals and cathode waste from the cathode material;
(e) a magnet in operable contact with the metals and cathode waste, wherein the magnet is operable for magnetically separating the metals and the cathode waste.

87. The system of claim 86, wherein the mixture further comprises a conductive additive.

88-97. (canceled)

98. A method of recovering metal, wherein the method comprises:
(a) forming a mixture comprising a cathode material, wherein the cathode material is prepared from one or more batteries comprising cathodes;
(b) applying a voltage across the mixture to obtain metals and cathode waste from the cathode material, wherein
(i) the voltage is applied in one or more voltage pulses,
(ii) duration of each of the one or more voltage pulses is for a duration period,
(iii) the method destroys 3D morphology of the cathodes in the cathode material; and
(c) extracting the metal from the cathode waste using an aqueous solution.

99. The method of claim 98, wherein the metals are selected from the group consisting of lithium, cobalt, nickel, manganese, copper, and iron.

100. The method of claim 99, where the metals are in the form of one or more metal salts.

101. The method of claim 100, wherein the one or more metal salts are in the form one or more oxides.

102. The method of claim 98, wherein the aqueous solution comprises an acid.

103-107. (canceled)

108. The method of claim 98, wherein the one or more batteries comprising cathodes comprises cathodes selected from the group consisting of LCO lithium cobalt oxide (LCO) cathodes and NMC lithium nickel-manganese-cobalt oxide (NMC) cathodes.

109-145. (canceled)
